(19) United States
(12) Patent Application Publication
(10) Pub. No.: US 2008/0215474 A1
(43) Pub. Date: Sep. 4, 2008

(54) Systems and methods for management of intangible assets

(75) Inventor: John Douglas Graham, New York, NY (US)

Correspondence Address: KALOW & SPRINGUT LLP, 488 MADISON AVENUE, 19TH FLOOR, NEW YORK, NY, 10022, US

(73) Assignee: Innovation International Americas, Inc., New York, NY (US)

(21) Appl. No.: 11/821,383

(22) Filed: Jun. 22, 2007

Related U.S. Application Data
(63) Continuation-in-part of application No. 09/766,067, filed on Jan. 19, 2001.
(60) Provisional application No. 60/815,791, filed on Jun. 22, 2006.
(60) Provisional application No. 60/831,763, filed on Jul. 19, 2006.
(60) Provisional application No. 60/176,860, filed on Jan. 19, 2000.

(51) Int. Cl. G06F 3/048; G06F 17/30; G06Q 40/00

(52) U.S. Cl. 705/37; 715/764; 707/100; 707/E17.009

(57) ABSTRACT

Systems and methods for management of intangible assets are provided that allow effective management of intangible assets. The intangible asset management system and method include a computer based intangible asset management system for storing, managing, disseminating and sharing intangible asset information of an entity among users, the system comprising: a user interface that displays options for a user to enter, view, and edit some or all of the intangible asset information from one or more modules; a database coupled to the user interface for storing the intangible asset information and a processor coupled to the user interface and the database, the processor to: receive intangible asset information from the user; process and organize the intangible asset information into at least one module; store the intangible asset information in the database by module; update the database with any new intangible asset information received from the user; and provide the updated intangible asset information in response to an inquiry from a second user.

This application is a continuation-in-part application of U.S. application Ser. No. 09/766,067, entitled “System And Method For Managing Intellectual Property Assets”, filed Jan. 19, 2001, which claims the benefit of U.S. Provisional Patent Application No. 60/176,860, filed Jan. 19, 2000. This application also claims the benefit of Provisional Application Ser. No. 60/831,763, filed Jul. 19, 2006, entitled “Intangible Asset Manager” and Provisional Application Ser. No. 60/815,791, filed Jun. 22, 2006, entitled “Ideation Innovation Management System: The Life Cycle Of Ideas”, and all these entire disclosure are hereby incorporated by reference into the present disclosure.

### BACKGROUND OF THE INVENTION

Intangible assets are essential for business success. Maintaining a strong intangible asset portfolio (e.g., patents, trademarks, copyrights, trade secrets, good will, etc.) is critical to the successful growth of any business. In fact, many experts estimate that intangible assets make up close to 80% of a company's value.

Recent changes in the accounting and tax laws emphasize how important intangible assets are to a company. These new laws impose an affirmative duty on the company to identify and value their intangible assets for the benefit of the shareholders.

To keep a strong intangible asset portfolio, businesses should continuously develop new intangible assets and evaluate those intangible assets lying dormant, with the primary goal of maximizing those assets for commercial benefit. Typically, companies build up their intangible asset portfolio by not only protecting their intangible assets, e.g., applying for patent, trademark and copyright protection, but also by licensing and cross-licensing the technology related to that intangible asset.

Despite widespread acceptance of intangible assets as critical to the future of a company's business and the changes to laws surrounding them, many businesses put intangible assets in the “too difficult box” in terms of managing and communicating their value. Many experts maintain that intangible assets are great importance at creating shareholder wealth, yet they remain an under utilized part of many businesses. In fact, many businesses barely keep inventory of their intangible assets, much less aggressively try to maximize their value over their lifecycle.

Many CEOs, general or intellectual property counsels would love to have at their fingertips updated information about their company's intangible assets including currently developing or licensed intangible assets, problems that still need to be solved and/or intangible assets that are lying dormant. They would use this information in the company's business strategy to protect or improve current or future product or service positions and provide competitive advantage. All information adding further value to the company and potentially more profit.

Electronic laboratory notebooks have been utilized by some companies as first attempts to capture their inventions. These electronic notebooks allow the user to enter, search, store and report data. They also have the capabilities of having the notebook electronically witnessed. Electronic notebooks, however, fall short of providing a practical solution to managing intangible assets and maximizing their profitability.

Based on the critical role that intangible assets play in a company's business, there is a need for new systems and methods for managing intangible assets to maximize their value in the market place. There is also a need for systems and methods that provide updated intangible asset information and track and encourage innovation within the company and to build a more liquid market for intangible assets (e.g., patents, trademarks, copyrights, trade secrets, trade dress, etc.).

### SUMMARY OF THE INVENTION

In various embodiments, the system and methods provided encourage a collaborative and innovative culture that every CEO strives to encourage. In various embodiments, the system and methods provided facilitate this process through facilitating versioning and collaboration and keeping an audit trail so that appropriate kudos, incentive compensation, royalties, etc. find their way to those who contribute. The methods and systems described herein break down the silos and “not invented here” problems that plague virtually every organization. In addition, in various embodiments, the systems and methods provide an infrastructure that facilitates innovation and increase the liquidity and usage of intellectual property between businesses.

In various embodiments, new systems and methods for managing intangible assets to maximize their value are provided. The systems and methods provide updated intangible asset information that allows efficient ways to manage intangible assets (particularly intellectual property) to maximize their value in the market place and during the lifecycle of the intangible asset. In various embodiments, the systems and methods allow the user to merge intangible assets to create a new intangible asset. In various embodiments, the systems and methods provided allow the intangible asset to be valued, so that the company can determine in real time the net worth of the asset. In various embodiments, the systems and methods provided allow the intangible asset to be securitized and traded among buyers to realize maximum profit for the company.

In various embodiments, a computer based intangible asset management system for storing, managing, disseminating and sharing intangible asset information of an entity among users is provided, the system comprising: a user interface that displays options for a user to enter, view, and edit some or all of the intangible asset information from one or more modules; a database coupled to the user interface for storing the intangible asset information and a processor coupled to the user interface and the database, the processor to: receive intangible asset information from the user; process and organize the intangible asset information into at least one custody module, protect module, value module, develop module, securitize module, analyze module, and/or license module; store the intangible asset information in the database by module; update the database with any new intangible asset information received from the user; and provide the updated intangible asset information in response to an inquiry from a user.

In various embodiments, a network based intangible asset management system for storing, managing, disseminating and sharing intangible asset information of an entity among users is provided, the system comprising: a user system having an interface that displays options for a user to enter, view, and edit some or all of the intangible asset information from one or more modules; a centralized database for storing the intangible asset information; a server system configured to be coupled to the user system and the centralized database, the server system further configured to: receive intangible asset information from the user; process and organize the intangible asset information into at least one custody module, protect module, value module, develop module, securitize module, license module and/or analyze module; store the intangible asset information in the centralized database by module; update the centralized database with any new intangible asset information received from the user system; and provide the updated intangible asset information in response to an inquiry from a second user.

In various embodiments, a method is provided for facilitating automated exchange of one or more intangible assets online between buyer and seller, the method comprising the steps: registering electronically buyer information for the one or more intangible assets with a trusted third party; registering electronically seller information for the one or more intangible assets with the trusted third party; offering the intangible asset for sale; negotiating terms for the sale of the one or more intangible assets; having the trusted third party calculate electronically the buyer's trust score and seller's trust score which is dependent upon the seller's trading history and the seller's financial standing for the purchase of the one or more intangible assets; contracting for a sale of the specified one or more intangible assets, which includes monies, amount of credit, amount of escrow and amount of bond to be deposited with the trusted third party that is dependent upon the buyer's trust and seller's trust score; transferring buyer and/or seller funds and/or escrow and/or bond to the trusted third party; delivering the one or more intangible assets to the buyer; and having the trusted third party pay the seller the contractually agreed upon amount if the buyer determines that the delivered one or more intangible assets comply with the contract.

In various embodiments, a method is provided for trading one or more intangible assets over a network, comprising: receiving seller information from a first user over the network, the seller information relating to the one or more intangible assets offered for sale on behalf of the seller, at least some of the seller information comprising due diligence information, the due diligence information fulfilling at least a portion of a request for due diligence on the one or more intangible assets; storing the seller information about the one or more intangible assets in a centralized database; making the due diligence information available over the network to a second user on behalf of a potential buyer of the one or more intangible assets; storing in the centralized database data of whether a potential buyer has obtained the due diligence information; and storing in the centralized database a bid for the one or more intangible assets from the second user only if the second user has obtained the due diligence information, wherein the bid is data comprising at least an amount offered to purchase the one or more intangible assets.

In various embodiments, a computer readable storage medium is provided for storing instructions that, when executed by a computer, cause the computer to display options for a user to enter, view, and edit some or all of intangible asset information and manage, disseminate and share intangible asset information of an entity among users by accessing a database coupled to a user interface, the database for storing the intangible asset information and a processor coupled to the user interface and the database, the processor to: receive intangible asset information from the user; process and organize the intangible asset information into at least one custody module, protect module, value module, develop module, securitize module, and/or analyze module; store the intangible asset information in the database by module; update the database with any new intangible asset information received from the user; and provide the updated intangible asset information in response to an inquiry from a user.

Additional features and advantages of various embodiments will be set forth in part in the description that follows, and in part will be apparent from the description, or may be learned by practice of various embodiments. The objectives and other advantages of various embodiments will be realized and attained by means of the elements and combinations particularly pointed out in the description and appended claims.

### BRIEF DESCRIPTION OF THE FIGURES

FIG. 1 illustrates database modules including the custody, protect, value, develop, analyze, and securitize modules for the intangible asset management system. This Figure is a simplified data model that is based on the one to many relationships between intangibles, licenses, organizations and individuals.

FIG. 2 illustrates system architecture in accordance with one embodiment, where the intangible asset management system is a stand alone computer system having user interface, which allows a user to at least enter, view, store and edit some or all of the intangible asset information in one or more modules of the database.

FIG. 3 illustrates system architecture in accordance with one embodiment, where the intangible asset management system is a network based system having a database for the one or more modules, a network based server and two or more user interface computers, which allows each user to at least enter, view, edit, and/or print some or all of the intangible asset information from one or more modules of the database which is then stored in the database or in the user's computer.

FIG. 4 illustrates system architecture in accordance with one embodiment, where the intangible asset management system comprises a network-based system having a server which allows multiple users to access the database and enter, view, edit, save and/or store some or all of the intangible asset information from one or more modules of the database.

FIG. 5 is an embodiment of a typical user interface welcome screen of the intangible asset management system, which includes selections where the user can enter information about a new intangible asset, open, view and edit an existing intangible asset, and register a new intangible asset or attempt to outsource a needed innovation. The user also has an option to link an intangible with another intangible or document, use the glossary for unfamiliar terms or launch other modules of the intangible asset managements system (e.g., solutions needed, reports, etc.)

FIG. 6 is an embodiment of the user interface for the custody module of the intangible asset management system, which includes fields and selections to enter the title of the asset, non-confidential (marketing oriented abstract) and proprietary content about the intangible asset as well as tool bars to attach documents including the intangible asset. The user interface also has fields to add and edit authors related to the intangible asset and to enter data as to how the intangible asset was created and when it was updated. The system will automatically or the user can manually issue a Global Standard Intangible Asset Number (GSIN) and/or Custom identifier to register the new entry in the database, the user will then be directed to another screen in the custody module shown in FIG. 7.

FIG. 7 is an embodiment of the user interface of the custody module after one or more intangible assets are registered and manually or automatically issued a GSIN. Certain users are allowed to view the intangible asset and allocate the percent contribution by author/inventor to the asset and/or combine it with another intangible asset to create a new intangible asset. When there are two or more inventors/authors, the system allows the user to create a license between inventor/author. The user can save the entry and return to the prior screen or proceed to the protect module shown in FIG. 8.

FIG. 8 is an embodiment of the user interface for the protect module of the intangible asset management system, which allows the user to select confidentiality levels associated with the intangible asset, mark an entry as confidential, less confidential or privileged information, select the type of intangible asset protection recommended to be pursued (e.g., patent, trademark, copyright, etc.), and set deadlines for the intangible asset (e.g., publication, disclosure, expiry, etc.). The user can save the entry and can be referred to the next page depending on the type of protection sought.

FIG. 9 is an embodiment of the user interface for the protect module of the intangible asset management system, which allows the user, in this example, to apply for copyright protection if desired in the selected country. The user also has the option to return to the protect module home screen.

FIG. 10 is an embodiment of the user interface for the protect module of the intangible asset management system, which in this example allows the user to enter, edit and view data to generate a completed invention disclosure form.

FIG. 11 is an embodiment of the user interface for the protect module of the intangible asset management system, which allows a user, in this example, to view patent or copyright records or works in progress for the intangible asset.

FIG. 12 is an embodiment of the user interface for the protect module of the intangible asset management system, which allows a user, in this example, to submit the requested intangible asset information for approval by the general counsel, external intellectual property counsel, or submit it to the USPTO, or save the intangible asset on the database as a work in progress.

FIG. 13 is an embodiment of the user interface for the protect module of the intangible asset management system, which allows a user, in this example, to view trademark or copyright records or work in progress records for the intangible asset and return to the protect module home screen.

FIG. 14 is an embodiment of the user interface for the protect module of the intangible asset management system. When the user selects trade secret protection, the user will see the company's trade secret guidelines to be followed. In addition the system will enforce these rules automatically by restricting access according to the guidelines and maintaining an audit of all access to the trade secret and enabling reporting of this access. The user also has the option to return to the protect module home screen.

FIG. 15 is an embodiment of the user interface for the value module of the intangible asset management system, which has fields for a user, in this example, to select a particular field for calculation of value for the intangible asset, and pick manage valuation benchmark for the intangible assets to make a comparison on value performance as a benchmark. The user also has fields to look at the value and licensing history for the intangible asset and request valuation of the intangible asset from a third party. All of this data can be analyzed after being filtered by industry or geography. Once value information is automatically or manually entered into the system, the user will be directed to the value calculator screen shown in FIG. 16. Additional metrics are available to the user that value intangibles based on activity within the intangible manager system and external activity such as patent citations and citations in scientific literature and on search engines. In addition data can be entered that will impact the future valuation of the intangible allowing a “Dynamic Value” that automatically changes as various parameters change.

FIG. 16 is an embodiment of the user interface for the value module of the intangible asset management system, which has fields for a user, in this example, to input data related to license or product sale revenues fields for valuation of the intangible asset and set benchmarks for the value as well as save the valuation.

FIG. 17 is an embodiment of the user interface for the develop module of the intangible asset management system, which has fields for a user, in this example, to create a new version of an existing intangible asset, annotate an existing intangible and improve the component intangible assets, witness the entry or combine intangible assets to create a brand new intangible asset and register that asset as a new compound asset. The system is configured to automatically know whether to present the versioning or annotation functionality based on the identity of the user.

FIG. 18 is an embodiment of the user interface for the analyze module of the intangible asset management system, which has fields for a user, in this example, to select a particular field to enter a rating for marketability, protectability, of the intangible asset. In addition the system automatically enters the activity and viability scores. The analyze module also has expansion bars and fields for the system to recommend, and the user to accept or change the system recommendation as to whether the intangible asset should be developed, donated, published or the subject of a joint venture and tracks the progress for the intangible asset. The system also will track the future progress of the intangible whichever “disposition” is chosen—such as “staging” if the intangible is to be developed in house. The analyze module also gives the user the option to print reports related to the intangible asset.

FIG. 19 is an embodiment of the user interface for the securitize module of the intangible asset management system, which has fields for a user, in this example, to request a the non-confidential abstract associated with the intangible asset to be made available to a broader market or request that the trustee add it to its portfolio and actively market licensing opportunities for the intangible asset. Access to proprietary content concerning the asset will be granted based on an algorithm that determines if the second should be entitled to access. The user will also be able to select a collaterization option or securitization option for the intangible asset that initiates the process of allowing the user to monetize their intangible asset by either using it as collateral for a loan or by securitizing it.

FIG. 20 is an embodiment of the user interface for the license module of the intangible asset management system, which has fields for a user, in this example, to view or post licensor and license information for the intangible asset including revenues as well as entities that are excluded from the license (e.g. because of industry conflicts, competitors, etc.).

FIG. 21 is an embodiment of the user interface for the license module of the intangible asset management system, which has fields for a user, in this example, to populate and/or track information about the license including, for example, the type of license, revenue associated with the license, the particular geography for the license, and the particular industry for the license. There is also a field for selecting various security levels or layered security, which grant certain users access to this information and there is a reports generator that allows various reports to be generated concerning the license including template licensing or collaboration agreements. The user may also have access to solutions needed or other modules of the database.

FIG. 22 is an embodiment of the user interface for the solutions needed module of the intangible asset management system. The module has fields for a user, in this example, to post the problem that the business needs solved and associated confidential and non-confidential information concerning the problem to be solved and allows the user the option to attach a copy of any related document. The user also has an option to post an award for such intangible asset that solves the problem. This can be a simple flat fee for a solution meeting the required specification or could be a sophisticated license arrangement. Anonymity of the entity with the problem can be set and the user can set the level of visibility of the solutions needed. The solutions needed module fosters collaboration and allows a second user the ability to create an intangible asset, where none existed that solves the problem of another user. After entries are made, certain visibility selections will direct the user to FIG. 23.

FIG. 23 is an embodiment of the user interface for the solutions needed module of the intangible asset management system, after a user populates the solutions needed entries, the user may be directed to fields, in this example, to allot different internal and external trust settings to the standard solution identification number.

FIG. 24 is an embodiment of the user interface for the search module of the intangible asset management system to search various fields of the database to retrieve selected intangible or license related information based on various search parameters.

FIG. 25 is an embodiment of the user interface for the search module, which displays typical results for selected search fields of the intangible asset manager. The search field also allows a user to add the results to develop a new intangible asset or link it to an existing intangible asset to further populate the database and create either an immediate vehicle for a joint venture or a portfolio of intangibles to be managed, licensed or securitized.

FIG. 26 is an embodiment of the user interface for the search module, which displays typical results for selected search fields of the intangible asset manager. The user can organize the results according whether the intangible assets are simple or more compound and the user interface gives the option for the user to search or link the results to other areas of the database.

FIG. 27 is an embodiment of the user interface for the reports module, which allows a user to select types of reports or prepare preformatted reports based on the business unit or division selected.

FIG. 28 is an embodiment of a typical flow chart report generated by the system, which describes the percentage licensing/sales licenses associated with a particular intangible asset or component intangible.

FIG. 29 is an embodiment of a typical CEO report generated for the company by the reports module. Shown graphically in a dashboard are economic flows for the intangibles, e.g., what proportion of the value or revenue is from the intangible asset, who are the most important contributors and what are the most important ideas contributed to the company. The reports generator also allows innovative and collaborative indexes to be generated by the system and can identify the top innovator and top collaborator in the organization or any subset of the organization or in any geography or industry.

FIG. 30 is an embodiment of a typical exit report generated for the general counsel of the company by the reports module. Shown are exit reports that the intangible asset manager can generate for the employee leaving the company. The report shows what intangibles were created by the employee, while the employee was at the company. The employee can sign to confirm that these were created while an employee of the company and that the intangibles are owned as documented. In addition, the Exit Report shows which trade secrets the employee accessed and provides a title, date and signature line for the employee to sign and acknowledge confidentiality of these intangibles during the exit interview.

FIG. 31 is an embodiment of the user interface in the search module of the intangible asset manager where a user can open an intangible asset based on the title and/or an international standard intangible asset number (GSIN). If null searches are collected, the user can use this information to potentially create an intangible asset portfolio in the area where there are no intangible assets (often called “white space”).

FIG. 32 is an embodiment of the user interface in the search module of the intangible asset manager where a user can open a license or search the database by licensor/license or title and open the license or even search for expertise inside or outside the organization through parsing the text in each authors intangibles while maintaining full confidentiality of the intangibles themselves.

FIG. 33 is a flow diagram of the creation of a global standard intangible number (GSIN) or custom identifier, which will be associated with the particular intangible asset or the component intangible asset. The custody module has a routine to determine if the number or custom identifier is in use already or is on the customer-reserved list.

FIG. 34 is a flow diagram illustrating the pathway for the creation of a message digest for the intangible, user's database and the trusted third party's database. The message digest can be calibrated to the atomic clock to ensure that the intangible asset, component intangible or asset portfolio has not been altered.

FIG. 35 illustrates a flow diagram illustrating how a new user (new client) establishes an account to access the intangible asset management system, which is controlled by a trusted third party (GTC).

FIG. 36 illustrates the flow of the intangible exchange, where a trusted third party Global Trust Company (GTC) maintains the intangible asset exchange.

FIG. 37 is an embodiment illustrating the intangible asset value fund, where intangible assets or portfolio of intangible assets can be used to exchange value when a certain composite ratio is reached. This allows profiles for investors to invest in the company based on the company's intangible asset portfolio.

FIG. 38 is an embodiment illustrating the intangible asset fund, where intangible assets or portfolio of intangible assets can be used for investors to trade, invest, sell and/or hold in trust for particular buyers (e.g., industrial buyers).

FIG. 39 is an embodiment illustrating how the intangible asset management system can be used to create a freedom to operate (FTO) fund, where various industries can participate in the fund by allowing their respective intangible assets to be sold or licensed to non-participants or other participants. A trusted third party (GTC) may also manage the FTO fund.

FIG. 40 is a block diagram that illustrates an embodiment of the solutions needed module, where an intangible asset exchange is created for new intangible assets.

FIG. 41 is a block diagram illustrating the information flow in the database to create a new intangible asset from two intangible assets or component intangible assets.

FIG. 42 illustrates an embodiments of the data metrics that the intangible asset systems utilizes to value one or more intangible assets.

FIG. 43 illustrates certain value consideration that the system utilizes to value one or more intangible assets.

FIGS. 44-47 are block diagrams illustrating how the system and methods have a layered security to allow selective users access to selective intangible asset information.

FIG. 48 illustrates the intangible asset exchange facilitated by the intangible asset management systems and methods. The major sources of intangible assets (e.g., government, academia, corporations, individuals) are registered in the database controlled by the trusted third party and the intangible asset exchange begins.

FIG. 49 illustrates an embodiment of a trust database, where a community of trust is established in the database.

FIG. 50 illustrates one embodiment of the trust database being used for individual transactions (e.g., bonding) using a highly secure access system (e.g., PKI).

FIG. 51 illustrates one embodiment, where a sublicense (e.g., a component intangible or whole intangible) can be combined with another sublicense (e.g., a component intangible or whole intangible) and combine it to form a new intangible or compound intangible (e.g., a master license).

FIG. 52 illustrates one embodiment of the solutions needed and/or solutions offered module. Solutions needed and solutions offered provide licensors and licensees to an exchange for intangible assets stored in the database.

FIG. 53 illustrates one embodiment in table format of the options the database can provide in the license module for intangible assets.

FIG. 54 illustrates one embodiment of the intangible asset management system and the information flow of the asset(s) in the custody, protect, value, develop, analyze and monetize modules.

FIG. 55 illustrates one embodiment of the intangible asset management system where the database controlled by a trusted third party is used for global collaboration and information exchange of intangible assets between agencies, research counsels, universities, companies, and individuals.

It is to be understood that the figures are not drawn to scale. Further, the relation between objects in a figure may not be to scale, and may in fact have a reverse relationship as to size. The figures are intended to bring understanding and clarity to the structure of each object shown, and thus, some features may be exaggerated in order to illustrate a specific feature of a structure.

### DETAILED DESCRIPTION OF THE INVENTION

Reference will now be made in detail to certain embodiments of the invention, examples of which are illustrated in the accompanying drawings. While the invention will be described in conjunction with the illustrated embodiments, it will be understood that they are not intended to limit the invention to those embodiments. On the contrary, the invention is intended to cover all alternatives, modifications, and equivalents, which may be included within the invention as defined by the appended claims.

It is noted that, as used in this specification and the appended claims, the singular forms “a,” “an,” and “the,” include plural referents unless expressly and unequivocally limited to one referent. Thus, for example, reference to “a leaflet” includes one, two, three or more leaflets.

The headings below are not meant to limit the disclosure in any way; embodiments under any one heading may be used in conjunction with embodiments under any other heading.

New systems and methods for managing intangible assets to maximize their value are provided. The systems and methods provide real time intangible asset information that allows efficient ways to manage intangible assets (particularly intellectual property) to maximize their value in the market place and during the lifecycle of the intangible asset. In various embodiments, the systems and methods provided allow a company's intangible asset or intangible asset portfolio to be securitized or retained in the custody of a trusted third party and traded among buyers to realize maximum profit for the company. In various embodiments, the systems and methods allow users to seek intangible assets that can solve a problem for the user or seek users that need solutions to which their intangible asset addresses.

### Intangible Assets

An intangible asset includes any asset that is neither physical nor financial. Intangible asset, as used herein includes, but is not limited to, goodwill, an idea, invention disclosure or other intellectual property disclosure, patent, patent application, trademark, trademark application, service mark, service mark application, trade secret, trade dress, copyright application, copyright (e.g. songs, music, writing, etc.), assignment, license or other agreements (e.g., NDA, CDA, MTA, or collaboration agreement, etc.) or the like. A portfolio or pool of intangible assets includes more than one intangible asset belonging to one or more of the same or different individuals or entities.

The intangible asset management system and methods allows management of any intangible asset (e.g., a documented idea, invention disclosure or other intellectual property or potential intellectual property including: an invention disclosure, patent, patent application, trademark, trademark application, service mark, service mark application, trade secret, trade dress, copyright application, copyright, assignment, license or other agreements (e.g., NDA, CDA, MTA, or collaboration agreement, etc.) or the like.

In various embodiments, the systems and methods allow the user to merge or combine intangible assets or intangible asset portfolios or component intangibles to create a new intangible asset. For example, a new intangible asset is created by an inventor. This new intangible asset may be a simple improvement to an existing product, or may be a revolutionary, complex system. Irrespective of how the intangible asset is expressed (e.g., as a data file, document, audio file, video file, image file, etc.), it may be stored and/or registered (e.g., GSIN number) in the database, where the inventor or another user can merge the intangible asset with a new or old intangible asset/component intangible or intangible asset information to create a new intangible asset. The new intangible asset can be registered, stored, tracked and/or linked to other intangible assets, intangible asset information or component intangible assets. For example, one user/inventor can view an existing patent (e.g., way to run monorails) and combine it with a new patent (e.g., internet protocols to send and receive messages) to create a new intangible asset (e.g., automatic switching of monorails utilizing internet protocol based technology to direct the monorail). This new intangible asset can be stored and registered in the database.

Another example is when the database has stored and/or registered two separate intangibles, one for a protective vehicle (which may already be patented) and another for a machine gun (which may also be patented). A user (the user can be the same or different inventor(s) of the two intangibles with the required security level and access to the two intangibles) views the two intangibles or information associated with the two intangibles and discovers that if the machine gun was placed on top of the protective vehicle, a tank can be created which is an improvement. Using the user interface with the database, the user selects the combine feature which automatically pre-populates data for the new “tank” intangible (e.g., log, elements, dates of invention, inventors from the current entry and the essential meta data, etc.) from the prior two intangibles, the user may populate the database manually as well. The user edits the data to record the new “tank” invention and registers it in the database. In this way, intangible assets or component intangible assets or information associated with the intangible is combined to form a new intangible asset that is then registered in the database.

In various embodiments, unlike conventional electronic laboratory notebooks, the intangible asset management system allows the intangible asset and/or component intangible (an idea, invention disclosure or other intellectual property disclosure, patent, patent application, trademark, trademark application, service mark, service mark application, trade secret, trade dress, copyright application, copyright (e.g. songs, music, writing, etc.), assignment, license or other agreements (e.g., NDA, CDA, MTA, or collaboration agreement, etc.) to be combined and form a new intangible (an idea, invention disclosure or other intellectual property disclosure, patent, patent application, trademark, trademark application, service mark, service mark application, trade secret, trade dress, copyright application, copyright (e.g. songs, music, writing, etc.), assignment, license or other agreements (e.g., NDA, CDA, MTA, or collaboration agreement, etc.), before it is sent, if needed, to the attorney for filing or registering with the Patent and Trademark Office or other disposition. The new intangible asset is also registered in the database and the associated metadata and message digest is associated with the new intangible before it is sent, if needed, to the attorney for filing or registering with the Patent and Trademark Office or other disposition.

In various embodiments, the database is configured to allow the user to search the database to insure that the intangible does not already exist. In this way, creation of duplicate intangibles is avoided.

A component intangible asset or component intangible includes not the complete intangible asset, but part of the whole intangible asset that has recognized value by its creator,. Component intangible assets include, for example, part of: an idea, invention disclosure or other intellectual property disclosure, patent, patent application, trademark, trademark application, service mark, service mark application, trade secret, trade dress, copyright, assignment, license or other agreements (e.g., NDA, CDA, MTA, or collaboration agreement, etc.) or the like.

Intangible asset information includes any communication associated with the particular intangible asset, component intangible and/or the intangible asset itself. In one embodiment, intangible asset information is created and maintained in the central database to facilitate performance of various aspects of the invention. Intangible asset information includes, but is not limited to, component intangible assets, electronic versions of the intangible assets themselves, and data associated with the intangible asset (e.g., log elements, essential metadata, and, message digest, user records, other data, etc.). Essential metadata, in various embodiments, includes critical data that associates the data with the intangible asset. For example, essential metadata can be data concerning the intangible that is critical throughout the full lifecycle of the intangible. This is the data that is captured in the Custody Module and which has a strong attestation trail due to the hashing algorithm that is run through it. This data, in various embodiments, includes the unique Global Standard Intangible Number, the author/s as well as any administrative assistant or researcher who may have entered the information on behalf of the author, and it may also contain information on how the intangible was acquired (e.g., internally developed or by acquisition—which impacts future accounting treatment), the location where the innovation occurred (because IP law varies with jurisdiction), the context (e.g., was it part of a research grant), the exact time and date of registration in the database as well as time of creation. Essential metadata may also include, in the event of an organization registering an intangible they had created some time in the past, data as to where the intangible was stored (e.g., database in London, or research database). Each of these types of information may be stored in any suitable data structure, such as a data set, record, an array, a linked list, etc.

Metadata may include information about a particular intangible data set, which describe, for example, how, when, and by whom it was received, created, formatted, accessed, and/or modified. An audit trail is maintained of all accesses to any intangible. Metadata elements may be used to store metadata relating to an intangible asset or component intangible asset and may include, indicators of the author/inventor, the owner, values, the meaning, and dates of use, sale, and public disclosure of the intangible asset or component intangible. Metadata elements may also contain a link to one or more log elements.

Log elements may be used to record changes to any intangible asset information. For example, when a change is made to metadata relating to a component intangible asset or intangible asset, a log element may be created that indicates the date, time, author and change to the component intangible or intangible asset. Intangible asset information includes, for example, name of the asset, date created, author/inventor, title, application no., issue date, registration number, filing date, summary of the asset, and the like.

In various embodiments, the database includes at least one custody module, protect module, value module, develop module, analyze module, and securitize module, license module and/or other module. These modules are designed to at least track documents, foster collaboration and innovation. The individual module may control processing of the individual searching and/or organizing operations described in (or apparent from) the instant disclosure. Each module may be one or more processors or processor-based systems executing one or more executable programs (locally or remotely) stored in a memory component (or other article of manufacture).

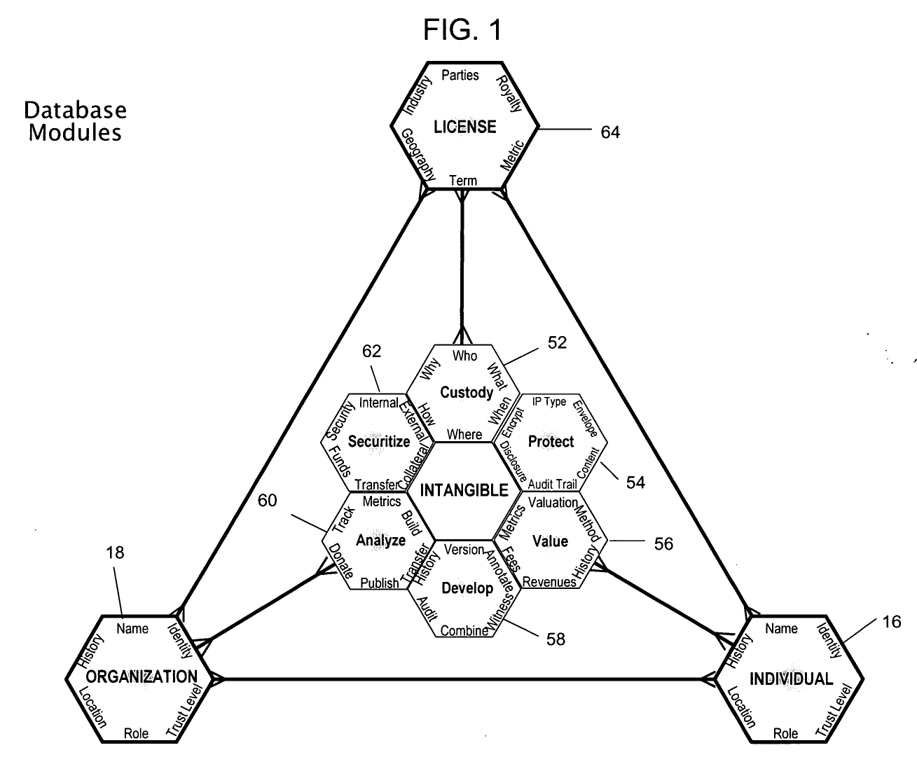

Referring to FIG. 1, it illustrates database modules including the custody 52, protect 54, value 56, develop 58, analyze 60, and securitize 62 modules for the intangible asset management system. Intangible asset information is stored in at least one of these modules. The modules described herein, particularly those illustrated or inherent in the instant disclosure, may be one or more hardware, software, or hybrid components residing in (or distributed among) one or more local or remote computer systems. Although the modules may be shown or described herein as physically separated components (e.g., custody module 52, protect module 54, analyze module 60, etc.), it should be readily apparent that the modules as described herein may be merely logical constructs or routines that are implemented as physical components combined or further separated into a variety of different components, sharing different resources (including processing units, memory, clock devices, software routines, logic commands, etc.) as required for the particular implementation of the embodiments disclosed. Indeed, even a single general-purpose computer (or other processor-controlled device) executing a program stored on an article of manufacture (e.g., recording medium or other memory units) to produce the functionality referred to herein may be utilized to implement the illustrated embodiments.

The database comprising at least one module is accessible by one or more user interfaces 16 (individual user) and/or 18 (organizational user). The user will have access to the database or to other users utilizing a network, and have ability to license out or license in intangible assets 64 to or from other users based on, for example, their history of dealings (e.g., collaborator or competitor) with the database and other users of the database, their individual trust ratings, their geographic or industrial location for that technology area. FIG. 1 is a simplified illustration of an embodiment of the intangible asset management system that describes the underlying data model with a ‘many to many’ relationships between the four major entities within the entity relationship diagram (developed into a data model) the organization, the individual, the intangible and the license. It is understood that each organization may have many employees, intangibles and licenses. Each individual may be employed at several organizations, author many intangibles and license these intangibles. Each intangible may be licensed and in turn license in other intangibles as component intangibles. Licenses themselves are special instances of intangibles.

It should be readily apparent that a “user” of the various aspects of the inventive systems or methods disclosed herein may be any creator or recipient of information. For example, a user may be one or more of the same or different individuals (e.g., CEO, GC, VP of IP, technology transfer group, inventors, managers, client, business developers, economists, researchers, etc.), or a combination of the same or different individuals, entities, including trustees, a trust company, organization, business, government agency, corporation, devices, without departing from the scope of the invention.

Users may also include one or more of the same or different custodians or administrators. A custodian may be a party who is responsible for verifying the integrity of the information contained in the system (e.g., GTC). An administrator may be a party with the ability to oversee the work and access to the system by other users of the system.

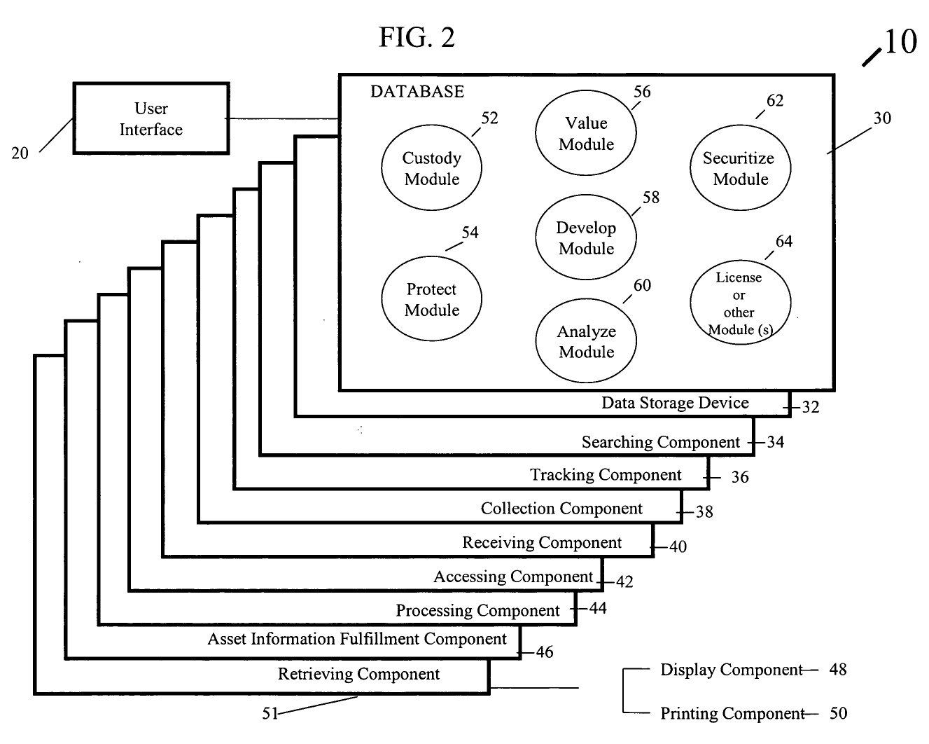

An exemplary embodiment of the computer system architecture is illustrated in FIG. 2. The exemplary system architecture may be used to effectuate any one or more aspects of the storing, managing, disseminating and sharing intangible asset information.

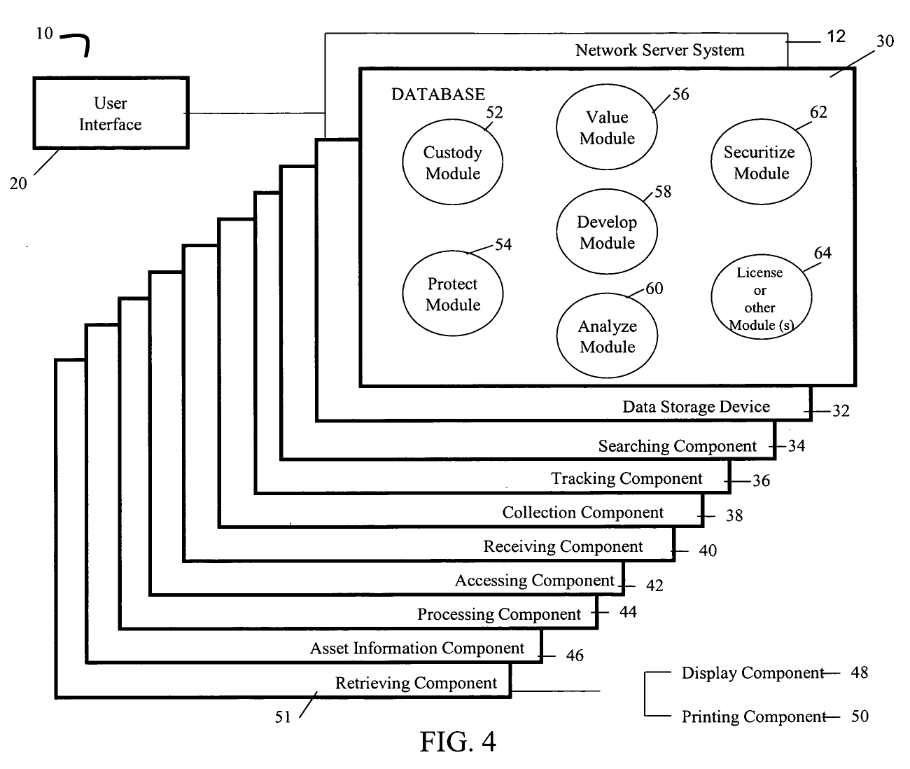

Some components in the intangible asset management system (10 in FIGS. 2 and 4) that are employed in the architecture include one or more databases (30), and one or more users interfaces (20). Database hardware and software have been developed for access by users through personal computers, mainframes, and other processor-based devices. Users may access and view intangible information stored locally on hard drives, CD-ROMs, stored on network storage devices through a local area network, or stored on remote database systems through one or more disparate network paths (e.g., the Internet). The database is configured to be protected from access by unauthorized users (e.g., hackers, viruses, worms, spy ware, etc.).

Now referring to FIGS. 2 and 4, user interface 20 may include one or more display devices (e.g., CRT, LCD, or other known displays) or other output devices (e.g., printer, etc.), and one or more input devices (e.g., keyboard, mouse, stylus, touch screen interface, or other known input mechanisms) for facilitating interaction of a user with the system via user interface 20. As illustrated, user interface 20 may be directly coupled to database 30, or directly coupled to a network server system (12 in FIG. 4).

In accordance with a preferred embodiment, one or more user interfaces are provided as part of (or in conjunction with) the illustrated systems to permit users to interact with the systems. The user interface device may be implemented as a graphical user interface (GUI) containing a display or the like, or may be a link to other user input/output devices known in the art. Individual ones of a plurality of devices (e.g., network/stand-alone computers, personal digital assistants (PDAs), WebTV (or other Internet-only) terminals, set-top boxes, cellular/phones, screenphones, pagers, blackberry, peer/non-peer technologies, kiosks, or other known (wired or wireless) communication devices, etc.) may similarly be used to execute one or more computer programs (e.g., universal Internet browser programs, dedicated interface programs, etc.) to allow users to interface with the systems in the manner described.

Database (30) may be any one or more of the known storage devices or systems (e.g., Random Access Memory (RAM), Read Only Memory (ROM), hard disk drive (HDD), floppy drive, zip drive, compact disk-ROM, DVD, bubble memory, redundant array of independent disks (RAID), network accessible storage (NAS) systems, storage area network (SAN) systems, etc.), CAS (content addressed storage) may also be one or more memory devices embedded within a CPU, or shared with one or more of the other components, and may be deployed locally or remotely relative to one or more components interacting with the memory or one or more modules.

In the stand-alone system shown in FIG. 2, database 30 may include data storage device 32, a collection component 38 for collecting information from users or other computers into centralized database 30, a tracking component 36 for tracking information received and entered, a searching component 34 to search information in the database or other databases, a receiving component 40 to receive a specific query from a user interface 20, and an accessing component 42 to access centralized database 30. Receiving component 40 is programmed for receiving a specific query from one of a plurality of users. Database 30 further includes a processing component 44 for searching and processing received queries against data storage device 32 containing a variety of information collected by collection component 38.

An intangible asset information fulfillment component 46, located in database downloads the requested information and sends it to the user or plurality of users in the order in which the requests were received by receiving component 40 or stores it in the data storage device 32. Intangible asset information fulfillment component 46 downloads the information after the information is retrieved from data storage device 32 by a retrieving component 51. Retrieving component 51 retrieves, downloads, and/or sends information to user interface 20 based on a query received from user interface 20.

Retrieving component 51 further includes a display component 48 configured to download information to be displayed on a user interface 20 and a printing component 50 configured to print information. Retrieving component 51 generates various reports requested by the user 20.

In various embodiments, to help users start the process of identifying intangibles, the management system comprises a routine that will search for their affiliated companies and intellectual holding companies and then search for all of these with the USPTO, foreign, international, or multi-national patent publications (e.g., issued patents or equivalents, published patent applications, statutory invention registrations, abstracts, etc.), including Japanese, Patent Cooperation Treaty (PCT), and European Convention patent publications, as well as other related information (e.g., technical publications, sequence listings, file histories, government records, public notices, etc.) that may be associated or otherwise pertinent to such intangible. This information will be used to further populate the database. The collected data can be collected utilizing the collection component and associating them with one or more entities and/or credit ratings.

In an exemplary embodiment, system 10 includes an administrative component (not shown) that allows the administrator to set security levels, provide user names and passwords, check custom identifiers, GSIN numbers, message digests, and facilitate other administrative functions. The system administrator may be responsible for access and security of the intangible asset management system.

In an exemplary embodiment, database 30 is divided into seven different modules including a custody module 52, protect module 54, value module 56, develop module 58, analyze module 60, securitize module 62, and/or license or other module 64. These modules within database 30 are interconnected to update and retrieve the information as required, to cater to the user, and/or administrator responsible for access and security of the intangible asset management system.

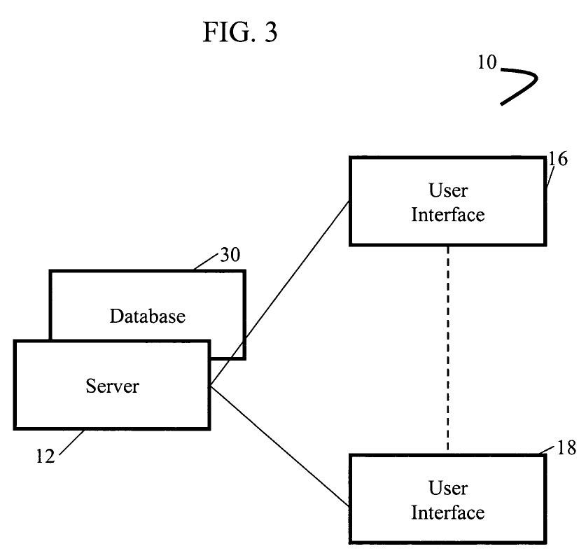

FIG. 3 is a simplified block diagram of the intangible asset management system 10, which in this figure, is a network based system having network server 12 coupled to database 30 and at least two user interfaces 16 and 18 coupled to the network server. The computer network may take any wired/wireless form of known connective technology (e.g., corporate or individual LAN, enterprise WAN, intranet, Internet, Virtual Private Network (VPN), combinations of network systems, etc.) to allow network server 12 provide local/remote information and control data to/from other locations (e.g., other remote database servers, remote databases, network servers/user interfaces, etc.). In accordance with a preferred embodiment, network server 12 may be serving one or more users over a collection of remote and disparate networks (e.g., Internet, intranet, VPN, etc.).

In one embodiment, the intangible asset management system 10 includes computers as the user interface 16 and 18, which have web browsers that are accessible to the users via the Internet. The network server 12 can be coupled to the Internet through many interfaces including a local area network (LAN) or a wider area network (WAN), dial-up connection, cable or DSL modems or special high-speed ISDN lines.

FIG. 3 shows a configuration of database 30 coupled to server system 12, which are then coupled to two separate user interfaces 16 and 18. In one embodiment, network server 12, database 30, and/or user interfaces 16 and 18 may include one or more central processing units used to provide processing of input/output data between server 12, and user interfaces 16 and 18. The server and/or user interfaces may utilize any known processor or processor-based system that typically executes one or more executable instructions or programs stored in the one or more (local or remote) memory devices (or other articles of manufacture).

In accordance with one embodiment, the intangible asset, component intangibles, and/or intangible asset information is stored in a central database and/or in one or more remote database systems. The different information may be stored as a continuous set of data, segmented to form a contiguous whole, or separated into different segments to reside in and among one or more server databases, as well as partitioned for storage and/or archiving in one or more files to achieve efficiencies in storage, access, and processing of data. The stored information may be stored in one or more database structures for use in their raw, natural, or unmodified data states (e.g., as delivered from the data source). Data may be stored in a variety of formats including document types such as PDF, RTF, TIF, HTML, Word, WordPerfect, Excel, WAV, MPEG etc.

In various embodiments, intangible assets, component intangible and/or intangible asset information, may include one or more specific references, data fields, licenses, or other indications of subsequent history of the item or document. The subsequent history information when used in connection with patent information, for example, may refer to the existence of pending or completed reexamination, reissue, opposition, arbitration, litigation, or other proceedings. Where documentation of the subsequent history (e.g., reexamination certificate, file history, complaint, notice, etc.) is available (e.g., from the database or a remote database, etc.), links or other identification of the resource location of the documentation may be included in the subsequent history information to allow the documentation to be easily accessed, retrieved, and/or output for use (e.g., viewing, printing, etc.) by one or more users.

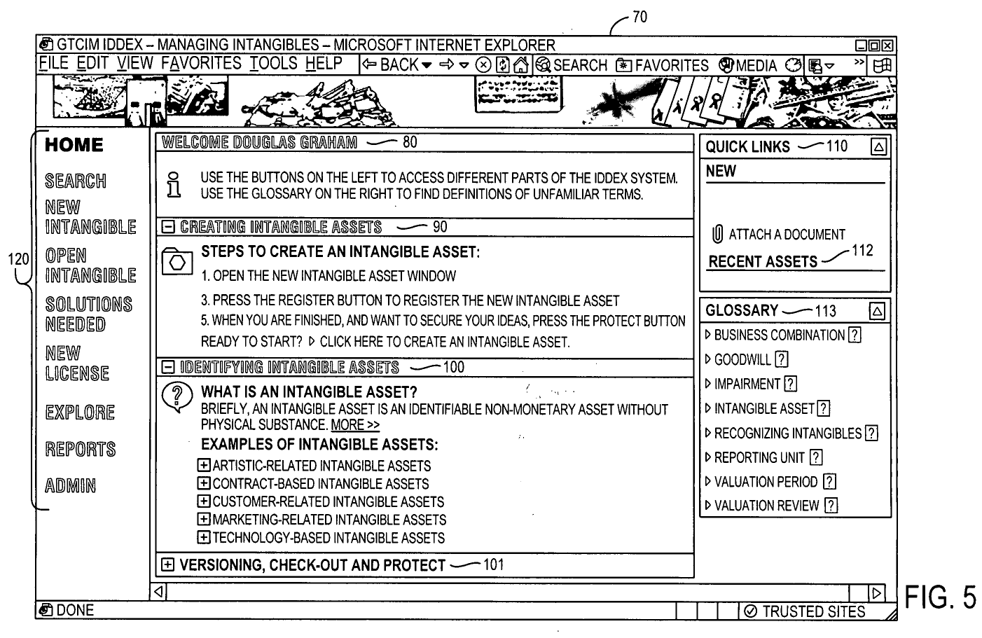

FIG. 5 is an embodiment of the typical user interface welcome page 80 of the intangible asset management system that may be displayed when a user logs on the system. The welcome page allows the user to access different parts of the system 120 (e.g., custody, protect, develop modules, etc.). The welcome page also has a glossary for different terms 113 and allows quick links to different intangible assets and documents 110. At the welcome page, the user has the option to create and register a new intangible asset 90, and/or protect the new intangible asset and/or enter a “Solution Needed”. To encourage innovation, the welcome page also allows a user to identify the various types of intangible assets 100 and select various expansion bars and links to view examples of intangible assets. In various embodiments, the Home Page displays the top innovator, top collaborator, and top idea for motivational purposes. At the welcome page, the user can view various versions of an intangible and its history as well as documents checked out by users 101. At 70 on the welcome page the user can have access to various tool bars and the Internet.

Custody Module

In various embodiments, the intangible asset management systems and methods comprise a custody module. The custody module, in general, keeps track of the intangible and any changes made to the intangible. The custody module allows the user to enter, view, and edit and save some or all of the intangible asset information in the database and insures security for the intangible asset, verifies ownership and conducts transactions for that particular intangible as instructed by the server or user and maintains an incontrovertible attestation trail as to the exact time of the innovation. In various embodiments, the custody module will also have a feature that allows users to create customized templates for recording any kind of innovation including scientific research such as a template for collecting research data in a long-term scientific study. This feature of the custody module ensures the integrity of the raw data and prevents researchers from being selective in the data they use that may bias the study (often a common problem). It also allows pharmaceutical companies to comply with regulations requiring an audit trail for their work (e.g., FDA compliance for new drug applications or abbreviated new drug applications).

The custody module keeps electronic records for every intangible asset, component intangible asset or intangible asset information populated in the database. In various embodiments, the database is kept in the custody of a trusted third party. A company's intangibles, in various embodiments, can be kept in a highly secure, central electronic repository for all of a company's intangible assets, where the intangible asset, component intangible asset or intangible asset information can be accessed, and documents can be submitted, for example, through an internet based ASP (Application Service Provider) service from any location. This allows a user to identify, inventory and store all pertinent information related to their intangible assets.

In various embodiments, the custody module allows many layers of protection for the intangible asset, component intangible and intangible asset information including a time stamped message digest of their documents that establishes an irrefutable record of what the user sent to the trusted third party for custody and when they sent it. In various embodiments, the time stamp uses a rack-mounted unit that is calibrated against the atomic clock and is designed to protect its integrity. If its integrity is ever breached it disables itself.

A message digest helps verify that data has not been altered because altering the data would change the digest. A message digest includes a fixed-length output from a hash function, (e.g. MDC, MD1, MD2, MD3, MD4, MD5, SH1 and SH2 algorithms). In various embodiments, the systems and methods have a routine to run a message digest for each intangible submitted by a particular user. A message digest is then created for all information submitted by the user, and an ultimate message digest is created that provides an attestation trail for the centralized database, which is then stored. The message digest for each asset, all intangible assets for a company, or an ultimate message digest for the entire database may be sent to a trusted third party, entity, and/or newspaper.

In various embodiments, the intangible asset information comprises initial, essential, and non-changing metadata for each intangible asset, which is processed with a message digest algorithm to provide an attestation trail for each intangible asset.

In various embodiments, the intangible asset management system processes a first message digest with a second message digest to produce a third message digest for the intangible asset. The system then aggregates the first, second and third message digests to form a ultimate message digest that provides an attestation trail for the centralized database. The ultimate message digest can be sent to the user, trusted third party, entity, and/or newspaper. Thus, a message digest can be created for an individual intangible asset, portfolio of intangible assets, component intangible or intangible asset information or for the whole database of the user or users. This process together with back up and restore procedures allows the attestation as to the integrity of the database, and thus the record, at any point in the past.

In various embodiments, the message digest is permanently stored in one or more databases and typically the user will store the intangible asset, component intangible or intangible asset information in a separate location or database. This greatly strengthens the integrity of the documents as a clear attestation trail can be provided particularly, for example, in an interference proceeding, where the date of invention is in question.

In addition the company may assert discretionary access controls that limits access to the intangible asset, component intangible and/or intangible asset information. The system also maintains an audit trail of every access to every document. Stored with each document is the essential metadata that is unchanging for every intangible asset. Metadata for an intangible may include any suitable information relating to the intangible. For example, metadata may include indicators of the author, the owner, values, the meaning, and dates of use, sale, and public disclosure of the intangible.

In various embodiments, the intangible asset, component intangible and/or intangible asset information itself and the associated metadata is time stamped and the message digest is associated with it. In various embodiments, the message digest is a small file that is enough to establish an incontrovertible evidence trail that the user had created a certain document at a certain time (and the ideas described within it), however, the original information can not be re-created. In this way, there is no risk of a security breach.

In various embodiments, the message digest remains on the database (and is replicated to another database (e.g., public database) as incontrovertible evidence of the time of invention and the inventor. Although this message digest can be used at any time to establish beyond reasonable doubt that the intangible asset, component intangible and/or intangible asset information the user holds in custody is the same as that being produced in evidence, it cannot be used to reconstruct the document itself and thus full security is maintained.

In various embodiments, for additional security, users can elect to encrypt some or all of their documents with keys being held at a secure offshore certificate server. In addition to providing protection from technology based attacks, it provides another layer of legal protection as any hostile party attempting to gain access to the documents through legal means (such as frivolous intellectual property litigation which is often started for discovery rather than an ultimate judgment) would have to deal with a much more privacy conscious offshore jurisdiction.

In various embodiments, for additional security, the user can elect not to put some or all of their intangible asset, component intangible and/or intangible asset information in the central database in the custody of a trusted third party, but instead, the user can run the message digest on their local system and only deposit the resulting message digest in the central database in the custody of the trusted third party.

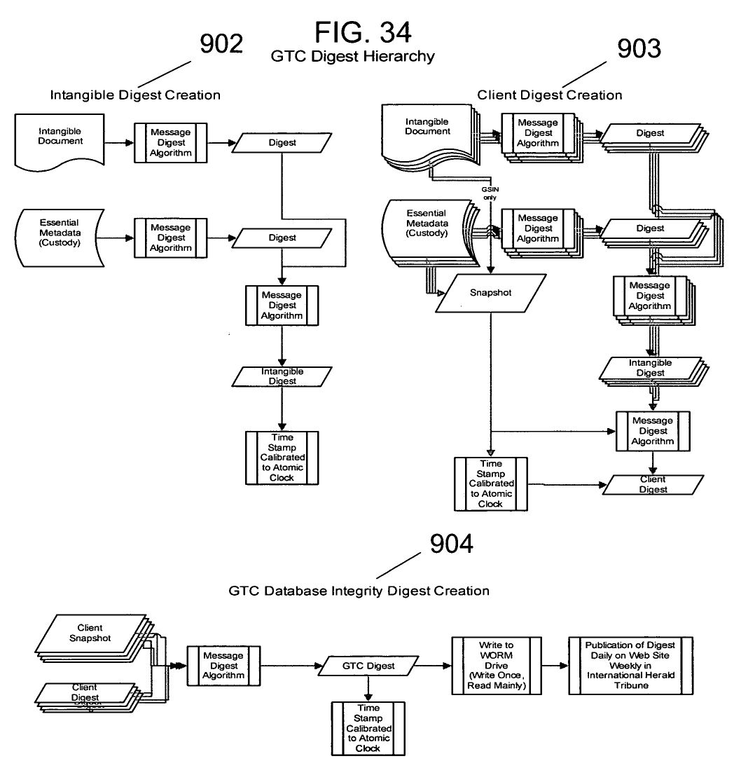

FIG. 34 is a flow diagram of the intangible digest creation, where a message digest is created for the intangible asset 902, the client 903 and/or for the database of the trusted third party (GTC) 904. A message digest is created for each intangible 902, component intangible and/or intangible asset information by a programmed algorithm (e.g., authentication protocol) executed by the computer that results in a digest (including non-essential and essential metadata) for the intangible. A separate digest is created for the essential metadata associated with the intangible and the two are combined to create a final message digest, which is then time stamped based on the atomic clock. For the client's database 903, a message digest is created for each intangible, component intangible and/or intangible asset information by a programmed algorithm (e.g., authentication protocol) executed by the computer that results in a digest (including non-essential and essential metadata, GSIN, etc.) for the intangible. A separate digest is created for the essential metadata, and GSIN associated with an intangible. The two are combined and a final message digest is created, which is then time stamped based on the atomic clock. This overall message digest provides a confirmation of the integrity of the entire database. A snapshot of the client's message digest is also created, which can also be time stamped based on the atomic clock.

The integrity of the trusted third party's database (GTC) is also assured by a separate digest ran for its database 904. All client snapshots and client digests received by GTC are stored in the GTC database and a programmed message digest algorithm is executed by the computer that results in a GTC digest created for one or more client(s) or the entire database, which is time stamped based on the atomic clock. In various embodiments, the digest is written on a WORM (write once read mainly) drive and the digest is sent for publication on a website (daily, weekly, monthly, yearly, etc.) and/or in a newspaper. In this way, the integrity of the client database, third party database is assured and the authenticity maintained.

In various embodiments, when an intangible is registered, the intangible is directed to another user who acts as one or more witnesses for the intangible and digitally signs the intangible record. Once an intangible is made final, the intangible, in various embodiments, cannot be subsequently altered. This provides an additional attestation trail that is valuable in the event of intellectual property litigation, where invention dates and inventors often come into question.

In various embodiments, the intangible may contain a unique identifier GSIN (e.g., a serial number, worldwide identification number) and/or custom identifier for that intangible. The unique identifier for the intangible may be a simple sequentially assigned serial number or may be any other desirable unique identifier. The user may assign the GSIN (as a Custom ID) or the system may do so automatically. By using a sequentially assigned serial number, a rough indicator of the sequence of creation of intangible can be determined from the order of the unique identifiers. In various embodiments, a value is associated with the intangible at the time of creation. This value may be adjusted at a later time. The time stamp may be used to determine the time of creation of an intangible. The time stamp may indicate date and time, date only, or any other suitable time indicator, and may use any desired level of precision (e.g., accurate to the second, minute, hour, day, month, and year) or calibrated to the atomic clock. Additional data associated with the intangible may be the creator/s of the intangible by name, a number (GSIN) to identify the intangible, a link to the user record of the creator, or any other suitable indicator of the creator.

In various embodiments, a custom identifier can also be provided for each intangible. A custom identifier is a particular word or number that a user would like to use to identify their intangible. For example, the trust company Global Trust Company could use the custom identifier to create or denote their intangible manager product. Once created the Custom ID is used in the same way as any other GSIN. When the GSIN is allocated first, the routine in the intangible asset management system will check to see if a Custom GSIN has already been allocated with the same name. The system may also charge a user to use particular custom identifiers. If the custom ID requested is a trademark the system will require that the owner of the intangible be the owner of the trademark. Thus, in various embodiments, owners of the custom ID must own or license the trademark. This avoids cyber-squatting or registering a name without rights to do so. For example, if the custom ID is GTC™, then the system will only allow a custom ID using GTC to be allotted to a GTC user. Thus, avoiding a non-GTC employee from using a GTC custom ID.

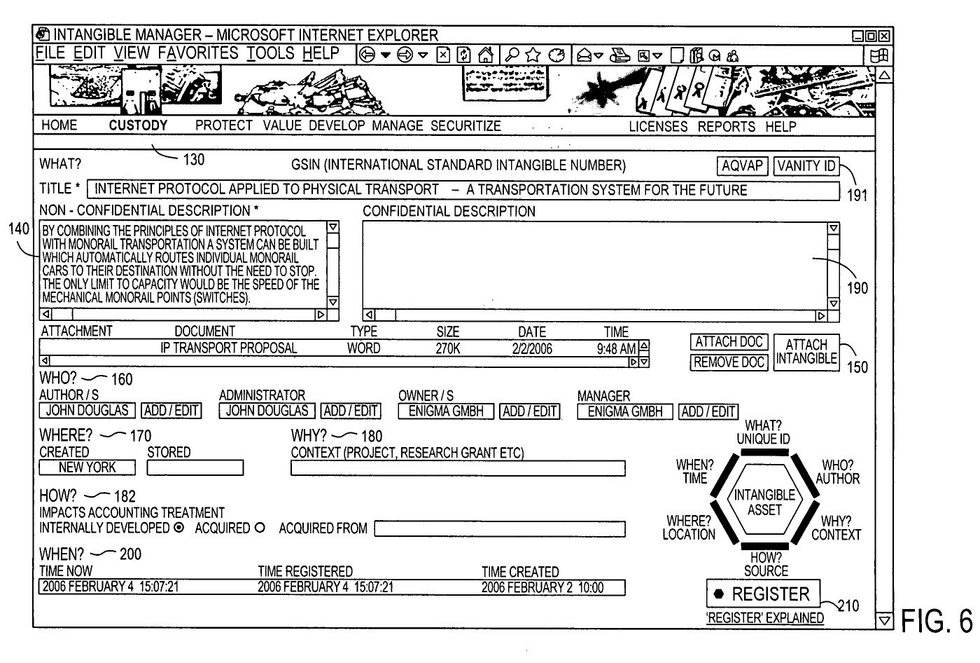

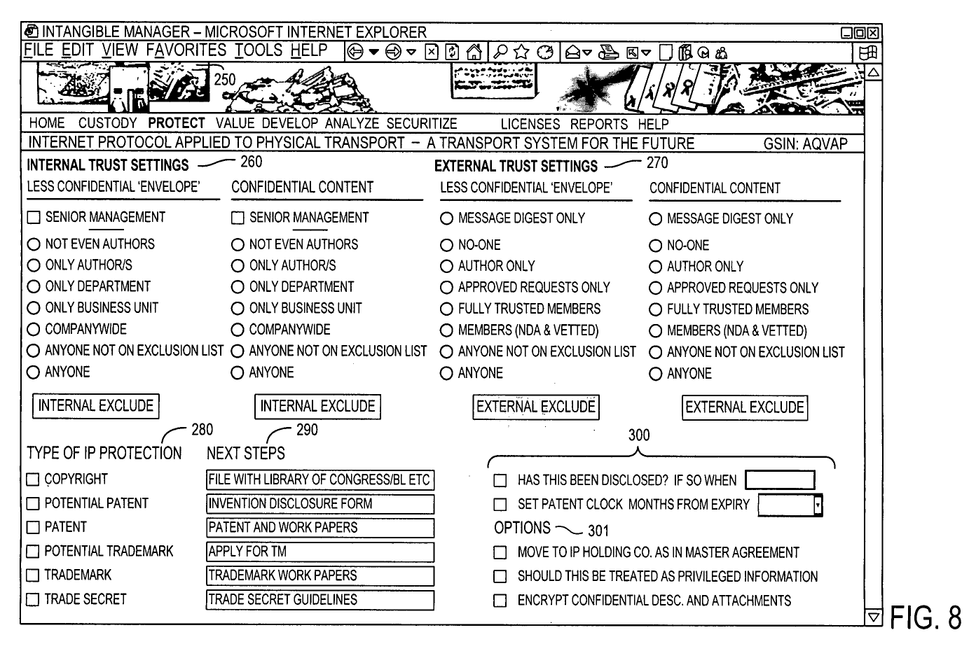

Now referring to FIG. 6, it shows one embodiment of a web page interface for the custody module. When the user opens an intangible asset on the welcome page shown in FIG. 5, the user will be directed to the custody module (tab highlighted 130). The custody module includes fields and selections to create a new intangible asset. The user can enter the title of the asset and include different levels of a marketing abstract or non-confidential description 140 and confidential description or proprietary content 190 about the intangible, which allows other users selected visibility to the marketing abstract or confidential description (envelope setting selected in the protect module FIGS. 8, 260 and 270) and/or proprietary content. The description settings will allow certain users access and exclude other. Documents related to the intangible description including other intangibles, component intangible and/or other intangible asset information can be attached and removed 150. The custody page allows fields for the user to enter 160 the authors of the intangible, administrators, owners, and/or managers, where the intangible asset was created 170 (because law may vary by jurisdiction), why the intangible was created 180, how the intangible asset was created (e.g., internally developed, acquired from or acquired) 182, and when the intangible was created 200 including time created, time now and the time the asset is registered 210 in the database.

In various embodiments, the intangible asset may be identified as “time is of the essence”. In this embodiment, when the intangible asset carries the “time is of the essence” identification, dissemination of information associated with that intangible, the intangible itself and/or the component intangible can be disseminated to selective users (e.g., users internal to the company or to users outside the company). In various embodiments, users can request access to intangibles identified as “time is of the essence”, and the trusted third party may allow access to the data regarding the “time is of the essence” identified intangible. The trusted third party may allow the user access to this information based on the user's trust rating or may require a user to post value (e.g., bond) to gain access to the intangible. In various embodiments, the trusted third party may notify various users that a new intangible has been posted in their particular area of interest (e.g. biotechnology, chemistry, etc.) or the trusted third party may notify a user anonymously or with the trusted third party known identity of the user. In various embodiments, the owner of the intangible or any of the users may be anonymously listed or may be identified, particularly in cases where the intangible is to be sold immediately. Certain fields related to the transfer of the intangible may be populated with data manually or automatically. In various embodiments, at the moment the intangible is registered, a message digest is created for the intangible and a time and date stamp is created for the intangible. In various embodiments, the system will automatically generate an international standard intangible number ISIN and issue a vanity identifier number that uniquely identifies the intangible.

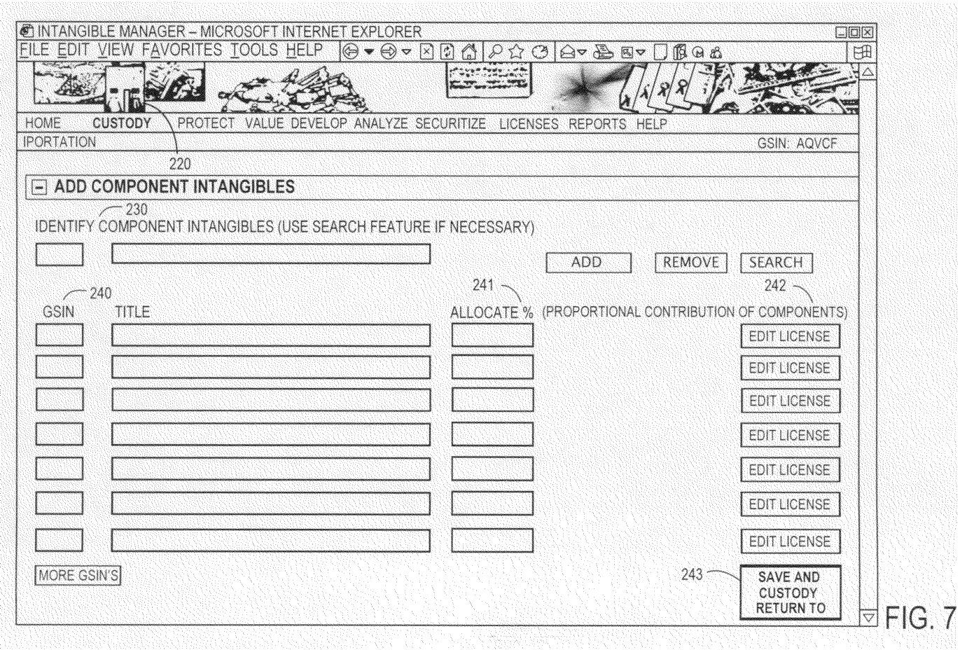

Once an intangible asset is registered, the user will be directed to the page displayed in FIG. 7, which illustrates one embodiment of the user interface of the custody module. The user can add, remove, or search the database for a component intangible 230. Certain users (e.g., manager, supervisor, GC, IP counsel, etc.) are allowed to view the intangible asset and allocate the percent contribution by author/inventor to the asset 241. The system allows users to enter into a license agreement between authors/inventors 242. This may potentially avoid disputes as to arguments of unauthorized use of an intangible. The user has the option of saving the entry prior to registering it and returning 243 to the custody screen later as shown in FIG. 6.

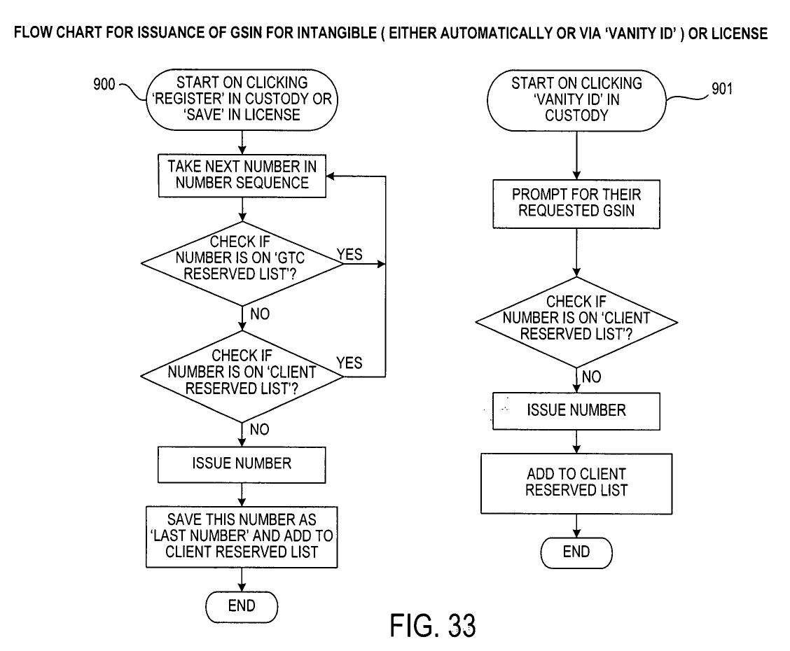

The GSIN and custom identifiers can be issued many ways. FIG. 33 illustrate a flow diagram of the creation of an international standard intangible asset number (GSIN) 900 or Custom ID 901 to associate the intangible asset or the component intangible asset with the particular number. In the custody module, the user enters the intangible, the system will automatically issue a globally unique GSIN. If the user wishes to customize their unique identifier the system will determine if the number is available and if so issue it. In this way, one unique GSIN is issued for the intangible.

Protect Module

The protect module, in general, facilitates the appropriate protection for the marketing abstract, proprietary content and metadata for each intangible asset, component intangible and/or intangible asset information. It allows a user to enter, view, edit, and seek the various types of intangible asset protection that are available (e.g., patent, trademark, service mark, trade secret, trade dress, copyright, etc.). The protect module not only allows a user to register the intangible asset, component intangible, and/or intangible asset information, but also allows authorized users to set security levels both internally for the marketing abstract, proprietary content and metadata (typically the marketing abstract has less stringent security than the proprietary content and/or metadata). The protect module will keep unauthorized users from gaining access to information they are not authorized to view. In this way, layered security is provided throughout the database, where users may be allowed access to various data provided the user has the required trust or security level. As the user's trust level increases, the user will be allowed access to more data.

In various embodiments, the protect module incorporates best practices on legal protection and leads users onto the first steps in securing legal protection for the intangible whether it be through copyright, trademark, service mark, patent, or trade secret. In addition, it provides for options related to the use of intellectual property holding companies, and allows the user to identify privileged information (any such records are clearly identified on displays and reports, or in communication related to a privileged intangible the user is restricted to sending to the general counsel). In various embodiments, the user has options of electing to encrypt an intangible record with an offshore server holding the key, which in addition to providing the additional technological protection also adds a level of additional legal protection of the confidentiality by bringing in a jurisdiction with very strict privacy laws.

In various embodiments, the protect module is configured to allow a user to encrypt data related to one or more intangible assets and store a digital certificate required to access the data on a server hosted in one or more of the same or different jurisdictions (using ‘split key’ technology where the key required for access is split across several jurisdictions. In various embodiments, the protect module is configured to copy all of the intangible asset information of the entity to keep a backup copy of all the intangibles stored in the database. In various embodiments, the protect module is configured to transfer ownership and other rights of an intangible asset to a second user which is an intellectual property holding company. The transfer can be as a result of an asset purchase, in which the seller of the intangible registered in the database, will give authorization, for example, to the trusted third party to transfer title to the buyer of the intangible. The transaction can be done on paper or electronically.

In various embodiments, the system allows the user to value the intangible asset by utilizing the value algorithm on the target intangible. In addition, the system allows the user to record influences on the innovation over existing prior art. This helps, for example, the GC, VP, and/or technology transfer unit to better manage the intangible because the prior art is characterized and the prior art is avoided or used to potentially license the technology in.

In various embodiments, the system allows various trust levels to be allotted to the user and/or intangible. The trust levels can be set, for example, by the manager, network administrator (e.g., trusted third party), or other authorized user. In various embodiments, the protect module is configured to calculate a trust score for the user and grant or deny access to various levels of the intangible asset information contained in the centralized database based on the user's trust score. For example, a user's trust score may be high enough based on the user's membership to a particular organization, in which case, the user will be allowed access to various modules, various confidential envelopes and/or various user levels of the database and various metadata. A competitor may be denied access to various modules (e.g. solutions needed module), various levels of the database, various confidential envelopes, or the entire database because the competitor competes with an already existing user.

In various embodiments, access rights may be defined at any level whether individual, departmental, business unit, organization, membership of a trusted community or the general public. In addition to a hierarchically defined level of access it may in addition be defined in terms of specific entities that are either included or excluded at any level of the organizational hierarchy. In this way business advisors or partners may be granted access and specific competitors can be specifically denied access (even to material otherwise considered public).

In various embodiments, the system will allow users to build their trust levels by joining a trust community, which allows users to build trust in their transactions with other users and know what level of trust they are dealing with and thus how much of their intellectual property they can safely reveal to other users. In various embodiments, a user can increase their trust level and thus access to intangible asset information, either as an individual or an organization, in several ways:
They can sign the a NDA/CDA;
They can sign an enhanced NDA at the request of a potential trading partner (typically as a schedule to the GTC Community of Trust standard NDA. The convenience of the standard NDA is that users already know the NDA and whether it meets their needs or what clauses need to be added if they have specific needs);
They can post a bond that we will make available through an arrangement with an insurance company partner;
They can post funds into escrow with a trusted third party;
They can build their trust level through a history of transactions conducted with integrity

In various embodiments, each user has their identity validated on joining the community of trust before they are issued their credentials. In the interim they have the rights of an introductory member to access those modules in the database that allow it.

In various embodiments, the intangible asset management system includes a security module that gradually establishes a community of trust in which the greater the trust the individual or organization has been able to establish the greater the access that user will enjoy. The security module removes the need for continual signing of CDA/NDA's between various users. Instead there is one CDA/NDA that is binding for the whole community and each member agrees to abide by a set of rules while at the same time the trusted third party provides an audit trail of all activity, viewing of intangible documents and conversations between members. This is particularly important for trade secrets but applies for all intellectual property types. Another advantage is that it provides one or both or many parties in a transaction the option of anonymity.

Referring to FIG. 8, after entering data into the custody module, the user can proceed to the protect module (an exemplary embodiment tab highlighted at 250 in FIG. 8). The protect module has fields for the user to select confidentiality levels associated with the intangible asset. For example, internal 260 and external trust settings 270 for various users can be set for the less confidential and confidential envelopes relating to an intangible.

Only selected users will have access to certain portions of the confidential or less confidential envelopes (e.g., senior management, selected authors, departments, business units, users not on the exclusion list, etc.) or the trust setting can be set so that any user registered in the database will have access. For external settings 270, the user may select that only the particular intangible asset element can be viewed by no one, authors only, approved request only, fully trusted users, users subject to a CDA/NDA, anyone not on the exclusion list. For example, if the proprietary content is selected and it includes anyone, then the proprietary content will be visible to any user (unless they are on the exclude list for that particular intangible. Likewise, if only the abstract is selected, then users will only be able to see the abstract. In the protect module, the user has the option of recommending what types of intellectual property protection to be selected 280, and select the future steps for the particular intangible asset 290 (e.g., whether filing it with the library of congress or filing out an invention disclosure form, file for a patent, trademark protection, or follow the trade secret guidelines). The user has the options to set the patent clock or patent alert 300 (which will notify the user whether or not a disclosure has been made or when some other deadline is approaching).

When alerts are employed, an alert generator can notify one or more users that a certain predetermined event is approaching for the particular intangible (e.g., deadline to file a patent, expiration of a patent, public disclosure, publication of a patent application, issuance of a patent, trademark or service mark, license exists or has expired, etc.). The alert generator may be used (alone or in conjunction with other modules) to access intangible information and notify one or more users of an approaching deadline (e.g., daily, weekly, monthly, etc.). In various embodiments, the alert generator can be programmed to notify selected users if an intangible is posted, or a solution needed is posted, or upon updated information concerning an intangible. The alert generator, for example, can be programmed to provide an alert to a user by sending an e-mail message, voice mail message, pager message, facsimile message, regular mail message, or other mechanism (or combination of such mechanisms) specified by the user.

In various embodiments, 301 the user can select various options to have the intangible asset moved to an intellectual property holding company, treat the information as privileged and confidential or encrypt the intangible asset description and attachments. Once the entries in the protect module are populated, depending which type of protection is selected in 280 and 290, the system will allow the user to take the next steps in applying for protection. In addition, at 301, the user can attach or scan and attach any NDA or CDA that refer to the intangible. In various embodiments, these can be attached for any individual or organization that has signed a non-specific NDA or CDA to become part of the community of trust.

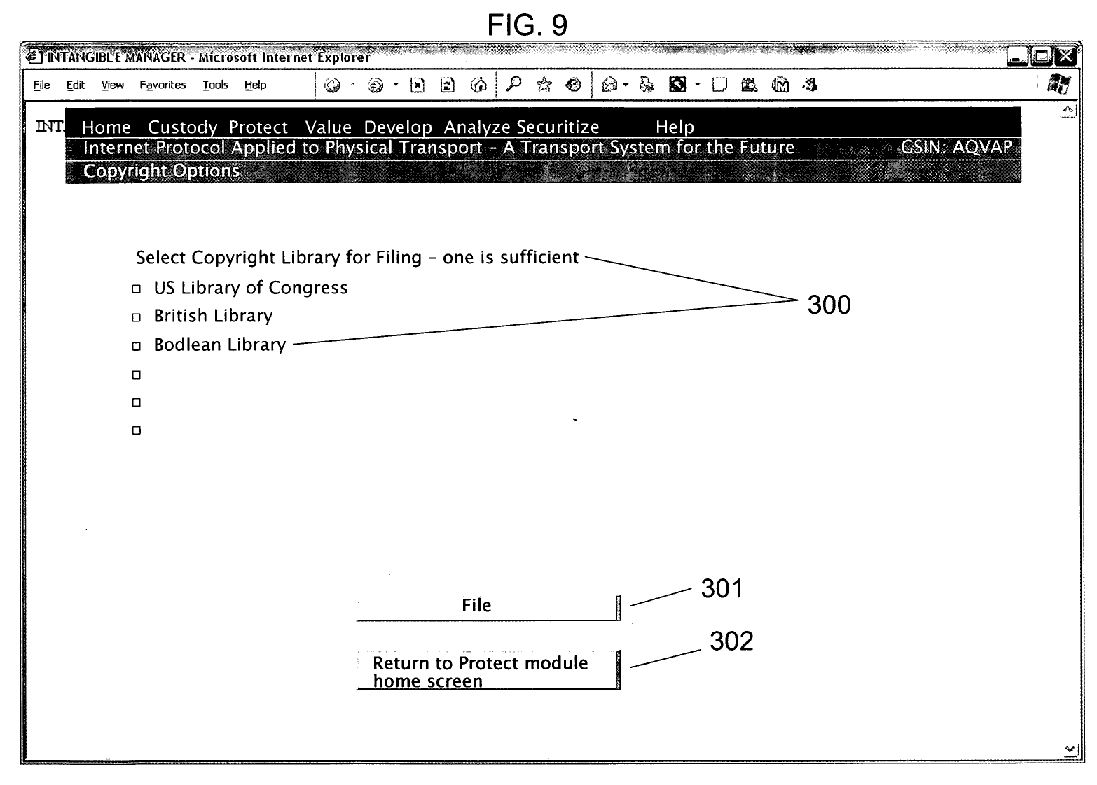

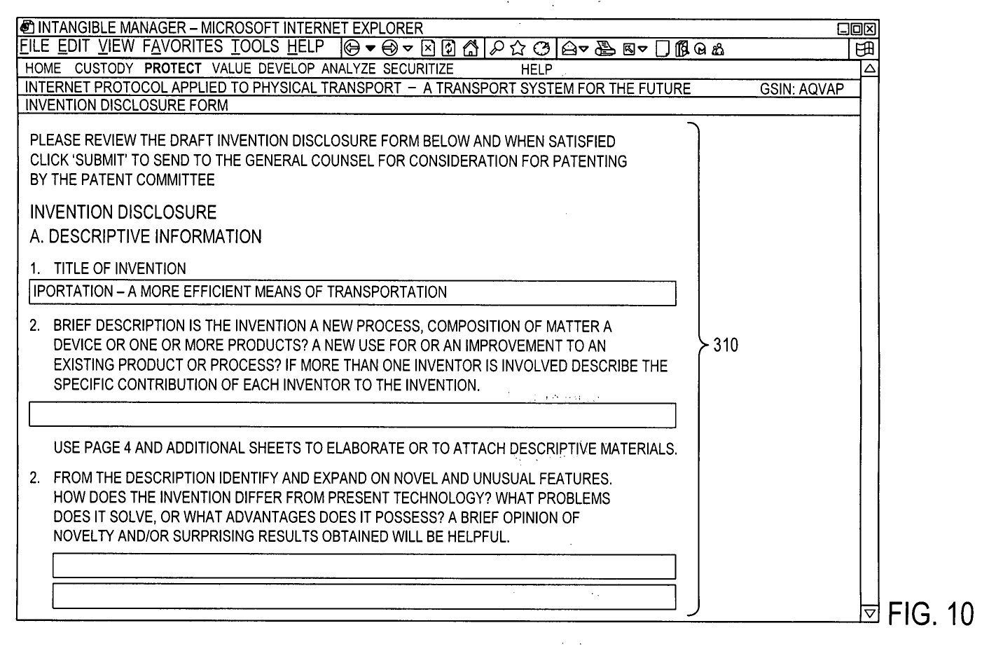

FIG. 9 is one embodiment of the user interface in the protect module of the intangible asset management system which allows the user to apply for copyright protection and select which countries to do so. The user will have the option of filing the documents electronically 301 or returning to the protect module home screen 302 shown in FIG. 8 to edit the entry. If the user selects the invention disclosure form toolbar shown in 290 of FIG. 8, the user will be directed to an invention disclosure form where the title of the invention brief description of the invention and further description of the invention shown in 310 of FIG. 10 and all other available information is automatically populated into the form and the user is prompted for any information not yet available in the intangible manager database.

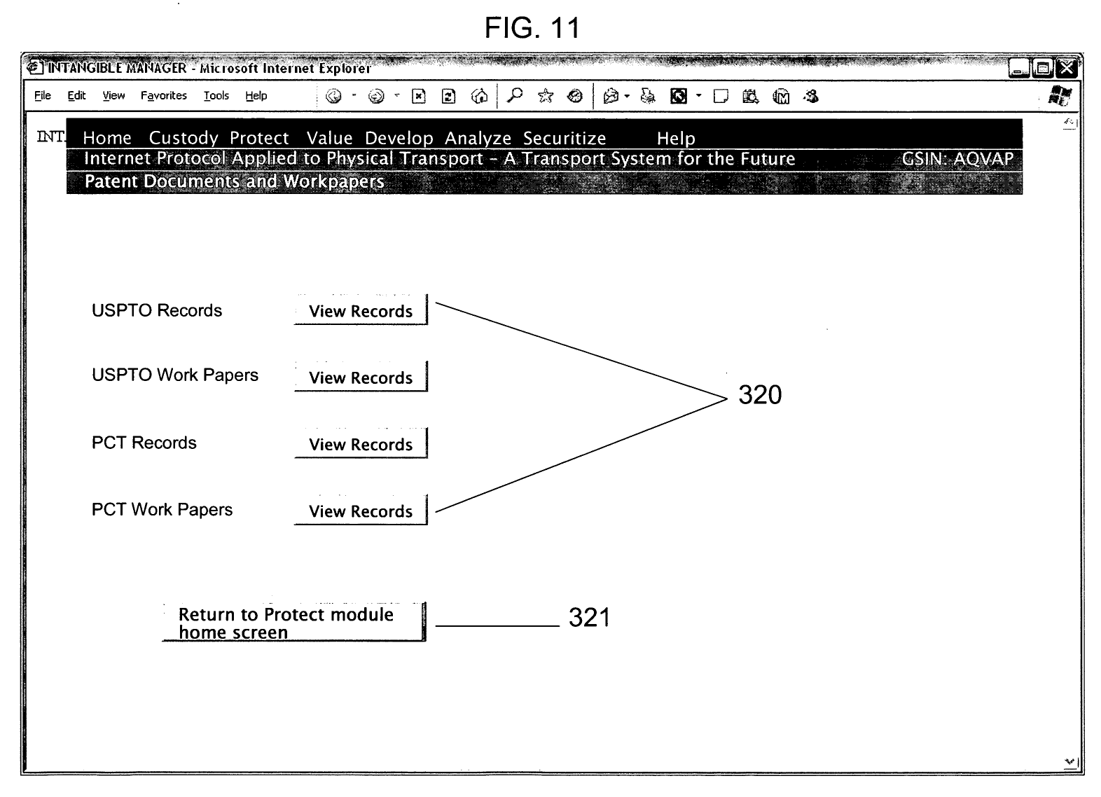

FIG. 11 shows a protect module page where the user can select various patent records related to the intangible asset. Shown in 320 are tool bars to view US patent office records or the company's records as well as international records relating to that intangible asset. The user also can return to the protect module home screen shown in FIG. 8 by selecting the tool bar in 321.

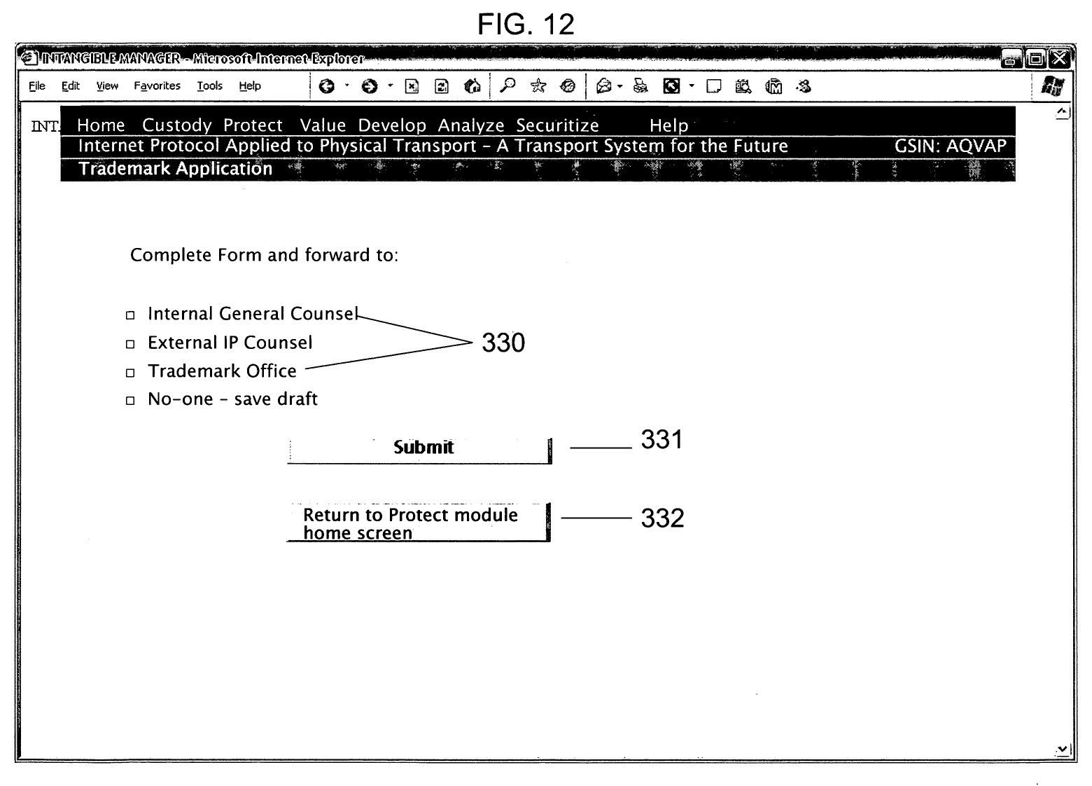

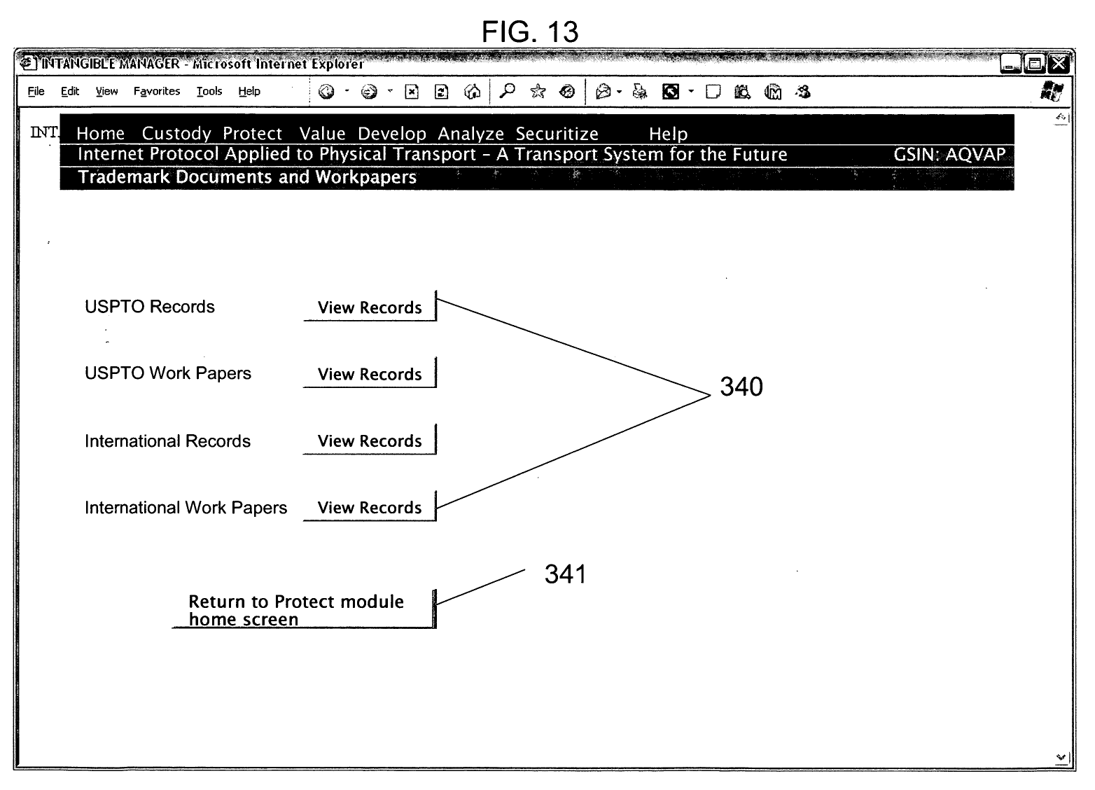

In various embodiments, once a user registers an intangible asset, the user will be directed to the web page shown in FIG. 12 of the protect module and select where the trademark application may be sent 330 (e.g., general counsel, external intellectual property counsel, directly to the trademark office or saved as a draft). The user then can send it to the intended receiver 331 or return to the protect module home screen shown in 332. If the user selects, for example, the patent or trademark work papers tool bar button (FIG. 8, 290), the user has the option of selecting and viewing various patent and trademark applications or works in progress and reviewing their records 340 of FIG. 13. The user also has the option of returning to the protect module home screen 341 of FIG. 13.

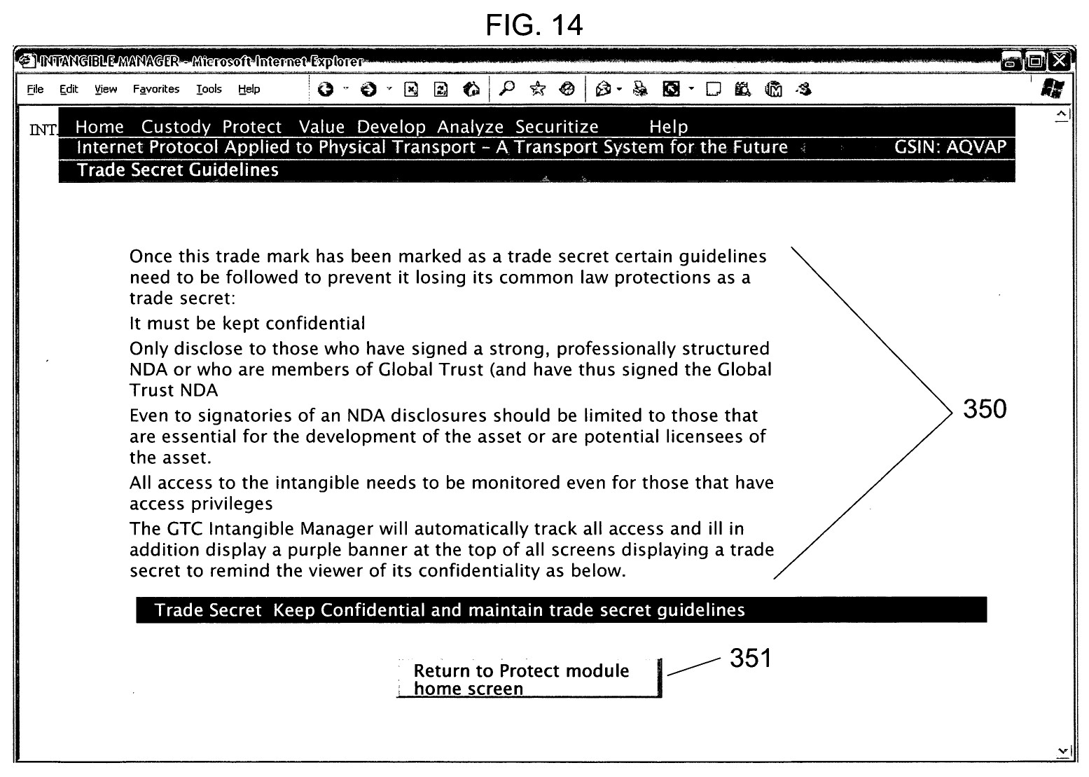

If a user selects in FIG. 8, the trade secret guidelines tool bar button indicated by 290, the user will be directed to the web page shown in FIG. 14, which describes the trade secret guidelines 350 that should be followed for the intangible asset that qualifies as a trade secret. All intangibles marked as trade secrets will be automatically marked with a bar displaying the words “trade secret keep confidential” the user also has the option of returning to the protect module screen 351.

Value Module

In various embodiments, the intangible asset management system comprises a value module. Unlike prior art electronic notebooks, the value module of the intangible asset management system, allows a value to be estimated for an intangible. In various embodiments, the value module includes calculators that automatically calculate the value of an intangible based on additional information input by the user and standard valuation algorithms (e.g., cost-based, revenue based (DCF) or Black-Scholes based valuation, etc.). Cost based valuation includes where valuation measures are based on the actual cost of creating the intangible, while revenue based measures are based on calculating the present value of existing or future revenue streams derived from either product sales or royalty income from licenses (existing and imputed). Black-Scholes valuation is based on the algorithm with the standard deviation measure being approximated to that of smack companies in the relevant industry.

Dynamic valuation allows parameters in the algorithm to be updated as new data about the asset becomes available. This allows for frequent revaluation of the intangible and facilitates the annual impairment review mandated by new accounting rules. These algorithms are approximate. GTC will build a sophisticated valuation database that uses the infrastructure of the intangible manager. The valuation database allows multiple valuations to be input for each license and each intangible within the intangible manager. These multiple values are based on subsequent iterations of value. These estimates of value are based on various metrics that operate on either licenses, intangibles, or organizational intangible value. Each of these metrics can be evaluated by measuring its effectiveness in predicting future value. This is done by estimating the element's value and aggregating them up to the organizational intangible value and adding this to the financial and physical assets to derive the estimated organization value. This is then compared with the historical value of all available organizations maintained in the database using regression. Multiple metrics are evaluated and using multivariate regression they are evaluated in terms of their predictive value with correlation values, significance and standard deviation of the metrics. All of this data is filtered by analyzing varying industries, geographies, level of capitalization and most importantly time lags. These “filtered” values are also stored in the intangible manager database. This generates the weighting coefficients for each metric. The combination of the metrics are run with the weighting coefficients to generate a more finely tuned algorithm with better predictive value. There may be several iterations of this process generating more finely tuned valuations each time.

In various embodiments, the valuation calculators provide the company with an inexpensive way to value their intangibles in real time). The system will also keep valuation histories for each intangible (e.g., earlier valuations, licensing histories, market trends, estimated future valuation, etc.) and stores multiple valuations derived through various methods metrics and/or benchmarks with each intangible and their related licenses. These are used to establish benchmarks, evaluate metrics and prepare aggregate industry statistics.

In various embodiments, the system allows for various types of valuation that a company can utilize to maintain and report assets in compliance with Financial Accounting Standards Board (FASB) and The International Accounting Standards Board (IASB) rules. In various embodiments, the value for the intangible asset, component intangible and/or intangible asset information include one or more of the values below:

Ve Estimated Value—estimated value using any methodology to value assets. Several estimates can exist for any intangible although only one, designated by the authorized party (e.g., typically the CFO is selected to be used in financial reporting);

Vs Symbiotic Value—the additional value, over and above its own intrinsic value, an intangible adds to a combination with other intangibles—this would be a positive value when a combination has symbiosis but could be negative in circumstances such as overlapping projects being combined to eliminate resource redundancy;

Va Actual Value—value based on an actual market related event such as a sale or license;

Vr Regressed Value—the value determined by estimating the value of the precursor intangibles (e.g., component intangibles) from one with an actual valuation (also known as recalculated value);

Fo Optimism Factor—moving average of the actual values divided by the estimated values for any organization, unit or individual;

Vc Corrected Value—the original estimate adjusted by multiplying with the ‘optimism factor; and

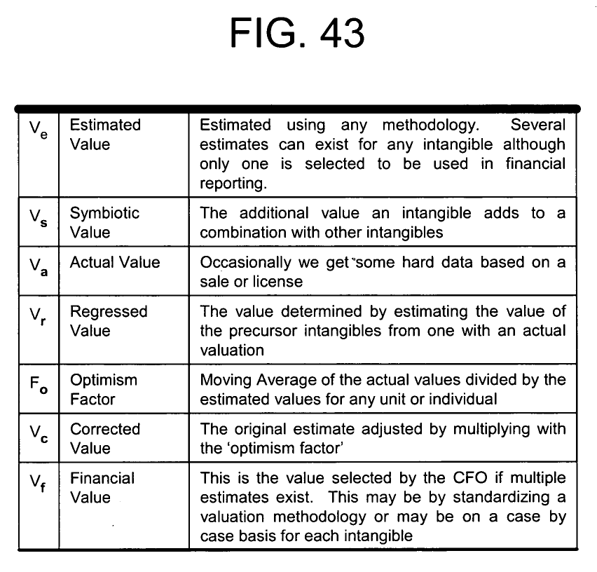

Vf Financial Value—this is the value selected by, for example, the CFO if multiple estimates exist. This may be by standardizing a valuation methodology or may be on a case-by-case basis for each intangible. These values are also shown in FIG. 43.

In various embodiments, a database of valuation benchmarks (e.g., lifetime value of a credit card subscriber values, value of a patent citation, trademark recognition values, etc.) are tracked from each valuation and aggregated across an industry providing the company or trusted third party with means, averages and standard deviations, which allow more accurate valuations and better estimate of the accuracy of the valuations. For example, one intangible may have several impacting benchmarks, this will allow for easy compliance with FASB 142 and IASB 38, which both require revaluation of intangibles to determine if there has been an impairment of their value in subsequent years.

In various embodiments, the system and methods provided automates the burdensome process of tracking variables that impact the intangible asset valuation such as discount rate (e.g., a rate that is reduced during the initial period of the loan) that is used in the DCF formula. If this has changed in a subsequent year the system can automatically recalculate the new value. The intangible asset management system, in various embodiments, allows a trusted third party to give a certified valuation of the intangible asset, component intangible, and/or intangible asset information that is stored and tracked in the database. All value related information is stored for future data mining.

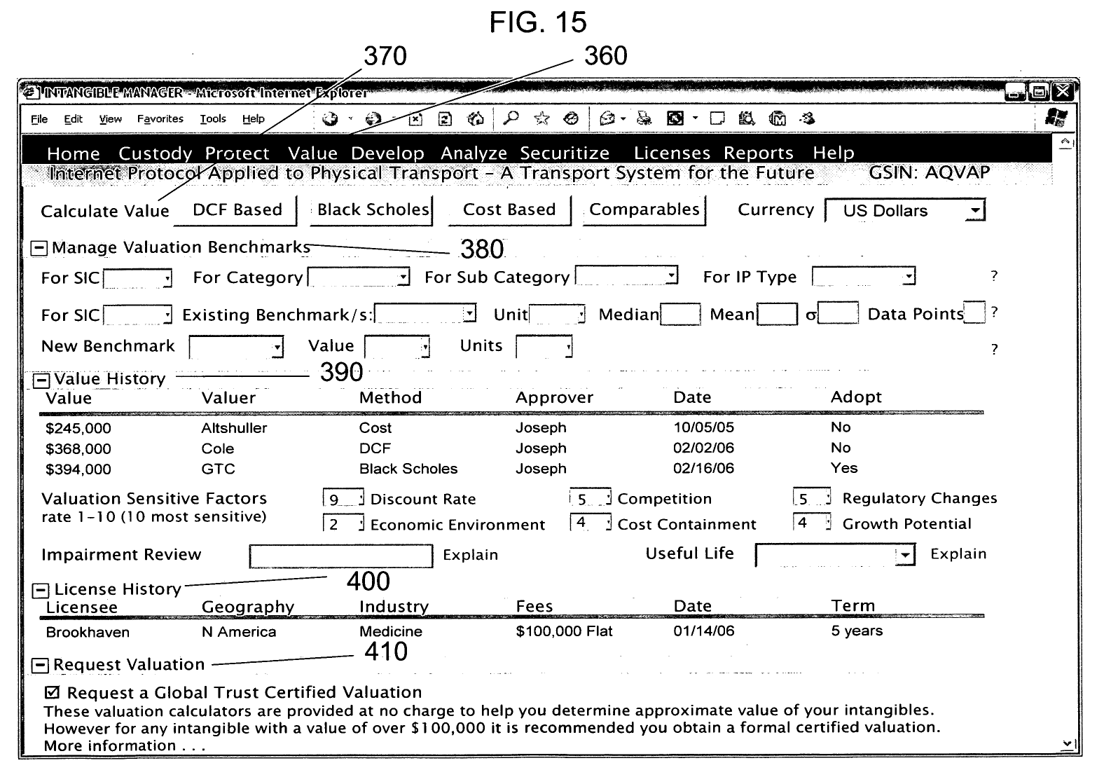

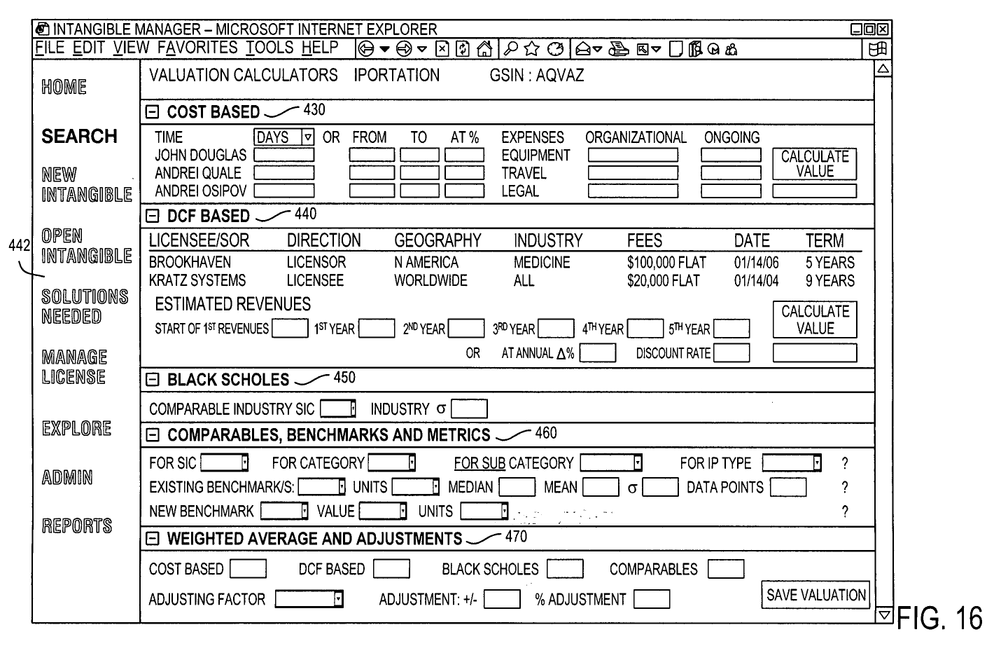

Referring to FIG. 15, it shows an embodiment of the user interface for the value module of the intangible asset management system, where the value tab is in highlighted 360 when the user is in this module. The value module user interface has fields for a user, in this example, to select a particular calculation of value for the intangible asset. At 370, the user can select one or more tool bars for the value calculator (e.g., DCF based, Black Scholes, Cost based, comparables, type of currency, etc.). The user also has fields to manage valuation benchmarks for the intangible 380, for example, categorize the company's business by most of the standard industry classifications or the type of intangible held. The user can also view how the intangible is performing and set new benchmarks. Fields and expansion bars are available to look at the value history for the intangible 390 as well as other metadata for the value (e.g., approver, date, adopt, etc.). Licensing history for the particular intangible is also available 400, where expansion bars allow the user to view metadata for the license (e.g., licensee, geographic location, industry, royalties/fees, dates and terms). This licensing information may be relevant to past, present and future valuations. The user also has the option to have the intangible asset, component intangible and/or intangible asset information valued by a trusted third party 410, where the intangible value can be certified. Once value information is automatically or manually entered into the system, the user will be directed to the value calculator screen shown in FIG. 16.

FIG. 16 is an embodiment of the user interface for the value calculator of the intangible asset management system, which has fields for a user, in this example, to insert value data for the intangible (e.g., cost based 430, DCF based 440, Black Scholes 450, comparables, benchmarks, metrics 460, weighted average and adjustments 470). The user also has the option to save the valuation with other metrics for the intangible, which will appear in the value history.

In various embodiments, the value for the intangible asset is obtained using valuation related metrics, regression testing, and/or multivariate analysis to build a database of correlations for each metrics based on capitalization, industry and geography and the system develops weighting factors to combine the metrics for a particular valuation in a weighted average. In various embodiments, as part of the valuation process a collection component is utilized to receive intangible asset information from users or websites to estimate the value of the intangible asset.

In various embodiments, the user can perform a diligence (e.g., a thorough legal and/or financial review) on the intangible and post a value relating to the intangible based on the diligence conducted. This value may be available to a second user, for example a potential buyer, based on the second user's trust score. The buyer can decide whether to buy the intangible or portfolio of intangibles or renegotiate the deal.

Develop Module

The develop module, in general, facilitates developing the intangible asset, component intangible and/or intangible asset information. Unlike inventory of physical assets, the system and methods provided include a database of intangibles, component intangible and/or intangible asset information that allows the tracking of ideas that are continually changing, improving, mutating and merging. The system and methods provided encourage a collaborative and innovative culture that every CEO strives to encourage. The user may enter version numbers to track changes and indicate the significance of the update (e.g., major revision vs. minor update).

In various embodiments, the system and methods provided facilitate this process through facilitating versioning and collaboration and keeping an audit trail so that appropriate kudos, incentive compensation, royalties, etc. find their way to those who contribute. The system and methods provided break down the silos and “not invented here” problems that plague every organization.

The systems and methods provided, in various embodiments, allow versioning or the creation of a new intangible, while keeping the same GSIN and/or custom identifier but adding post decimal version numbers. In various embodiments, collaboration is achieved by allowing addition field(s) to record suggestions or attach additional documents, to add annotations to the original innovation all changes tracked by contributor and the time of contribution (using the message digest algorithm, atomic clock and calibrated time stamp of the Custody Module).

In various embodiments, a new intangible asset is created by combining intangible assets, component intangibles, and/or intangible asset information. In various embodiments, when an intangible asset, component intangible asset or intangible asset information is combined with another intangible asset, component intangible asset, and/or intangible asset information to create a new intangible asset, then the resulting product is a compound intangible asset. In various embodiments, simple intangible assets are those intangible assets that are not compound intangible assets.

In various embodiments, the database has a default assumption for intangibles belonging to the same company or different users in the same company is that an unlimited, non-exclusive license will be automatically created for each intangible although any other form of license can be structured using the License Module. Automatic non-exclusive licensees will reduce future disputes as to unauthorized use of an intangible without consent. In addition, the system will allocate proportional contribution, which will be used in regressing values as discussed in the Value Module.

In various embodiments, the intangible asset manager system enables reports that allows an innovation index and a collaboration index to be calculated for the organization as a whole, individual departments, projects and/or individual managers. These reports may be aggregated by SIC codes and market cap, which may be utilized to provide economic indicators for the company and provide metrics added to the valuation database along with market data feeds and other data sources such as patent databases, academic databases and general search engines

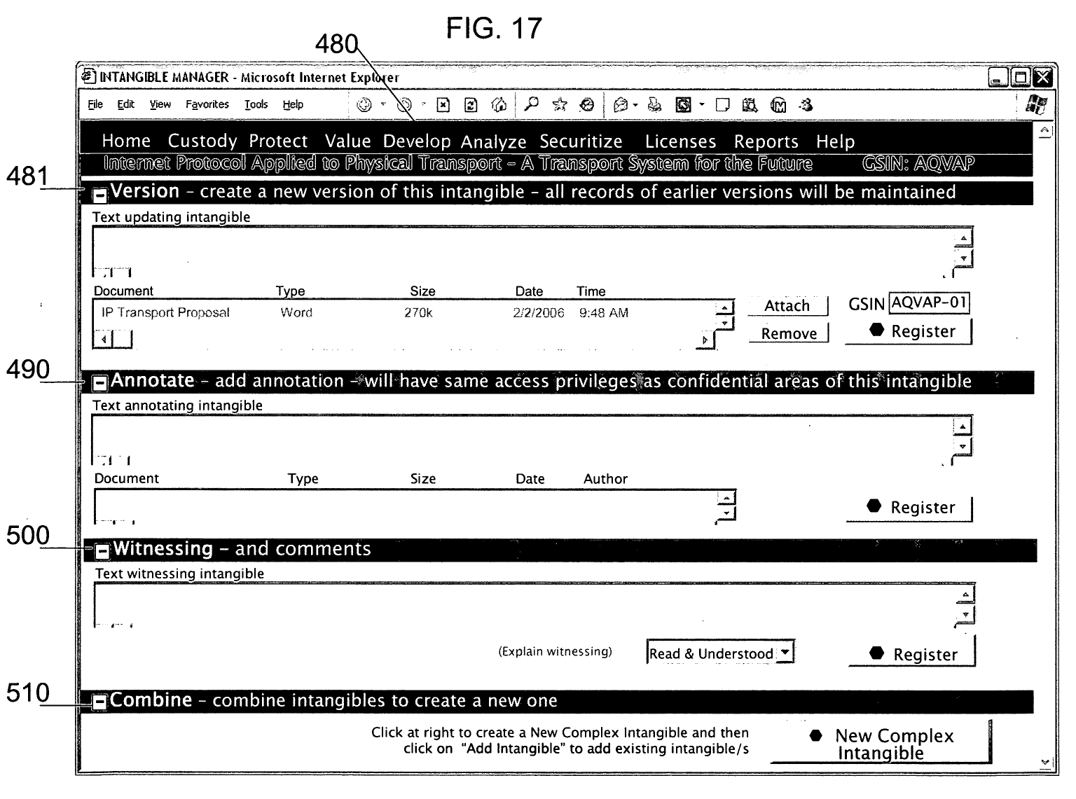

Referring to FIG. 17, it illustrates an embodiment of the user interface page for the most modules of the intangible asset management system. The tab is highlighted at 480, when the user is in the module. Most modules have fields and expansion bars for a user, such as in the disposition section of the analyze module. The new version of the intangible can be created, while the keeping an audit trail of the prior versions. The user can update or place an entry relating to the intangible by, for example, attaching documents and/or entering text relating to the intangible. The user can add any metadata relevant to the version. The user can save the entry, in which case the metadata associated with the intangible will also be saved. If Register is clicked then in addition to saving the entry, the GSIN number and/or custom identifier will have new versions allotted. Typically, the entry may improve the intangible asset, and/or intangible asset information. 490 shows an annotate expansion bar, where the user can add text annotating the intangible, which will be confidential and visible only to users with the required access level, documents can be removed and attached relating to the intangible and the annotation registered in the database. The annotation section allows a user to contribute and get the recognition for the contribution or compensation that they deserve. The entries in the develop module can be witnessed and the witness can provide comments and electronically sign the entry with the “Disclosed to and Understood by” language for the entry. This creates an incontrovertible attestation trail for the entry and can be used to establish dates of innovation, innovators and their contribution. In various embodiments, the develop module includes fields 510 for the user to combine intangible assets, component intangible and/or intangible asset information to create a new compound intangible.

For example, a new idea that is created by an inventor may be considered to be a piece of intellectual property. This idea may be a simple improvement to an existing product, or may be a revolutionary, complex system. Irrespective of how a piece of intellectual property is expressed (e.g., as a data file, document, audio file, video file, image file, digital fingerprint, etc.), it may be stored and tracked in the system (e.g. by GSIN and/or custom identifier) as a registered intangible asset. The idea may be combined with a new idea by linking to the existing registered intangible asset and combining the two ideas to create a new intangible asset and registering it. Thus, a new intangible asset is created. Accordingly, the systems and methods allow an existing registered intangible (e.g., an idea, invention disclosure, patent, patent application, trademark, trademark application, service mark, service mark application, trade secret, trade dress, copyright, assignment, license or other agreements (e.g., NDA, CDA, MTA, or collaboration agreement, etc.) to be combined with another registered or unregistered idea, invention disclosure, patent, patent application, trademark, trademark application, service mark, service mark application, trade secret, trade dress, copyright, assignment, license or other agreements (e.g., NDA, CDA, MTA, or collaboration agreement, etc.) to create a new intangible that is registered in the database and may be subsequently protected. Again, innovation and collaboration is fostered. This ability to combine intangibles provides a basis for tracking the continual evolution and combination of ideas within and between organizations as well as providing a means of creating portfolios of intangibles that can be used for technology transfer, licensing, collaterization and securitization.

In various embodiments, the develop module is configured with a tracking component to: track entries and edits among users that annotate and collaborate during the life of the intangible asset, assign new version numbers to intangible asset information that has edits or entries, and/or track changes to the modules.

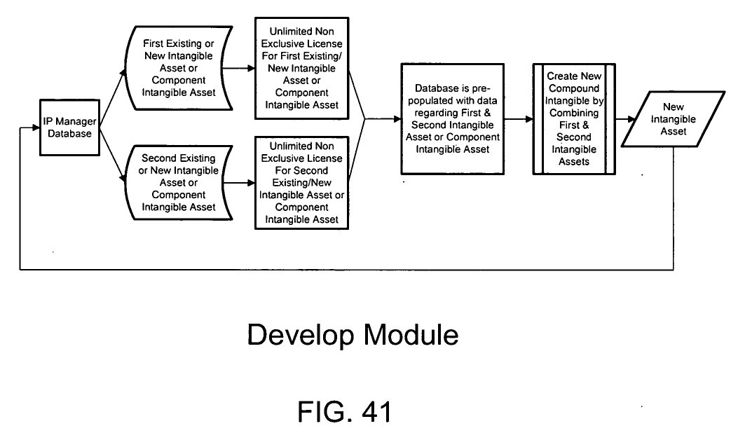

FIG. 41 is a block diagram illustrating the information flow in the database to create a new intangible asset. The database has stored and/or registered two separate intangibles, intangible asset information and/or component intangible assets. A user (the user can be the same or different inventor(s) of the two intangibles with the required security level and access to the two intangibles) views the two intangibles or information associated with the two intangibles and discovers a new intangible asset. A license of the intangible is automatically allowed and the user will have access to each intangible. Using the user interface with the database, the user selects the combine feature which automatically pre-populates data for the new intangible (e.g., log, elements, dates of invention, inventors from the current entry and the essential meta data, etc.) from the prior two intangibles, the user may populate the database manually as well. The user edits the data to record the new invention and registers it in the database. In this way, intangible assets or component intangible assets or information associated with the intangible is combined to form a new intangible asset that is then registered in the database.

Analyze Module

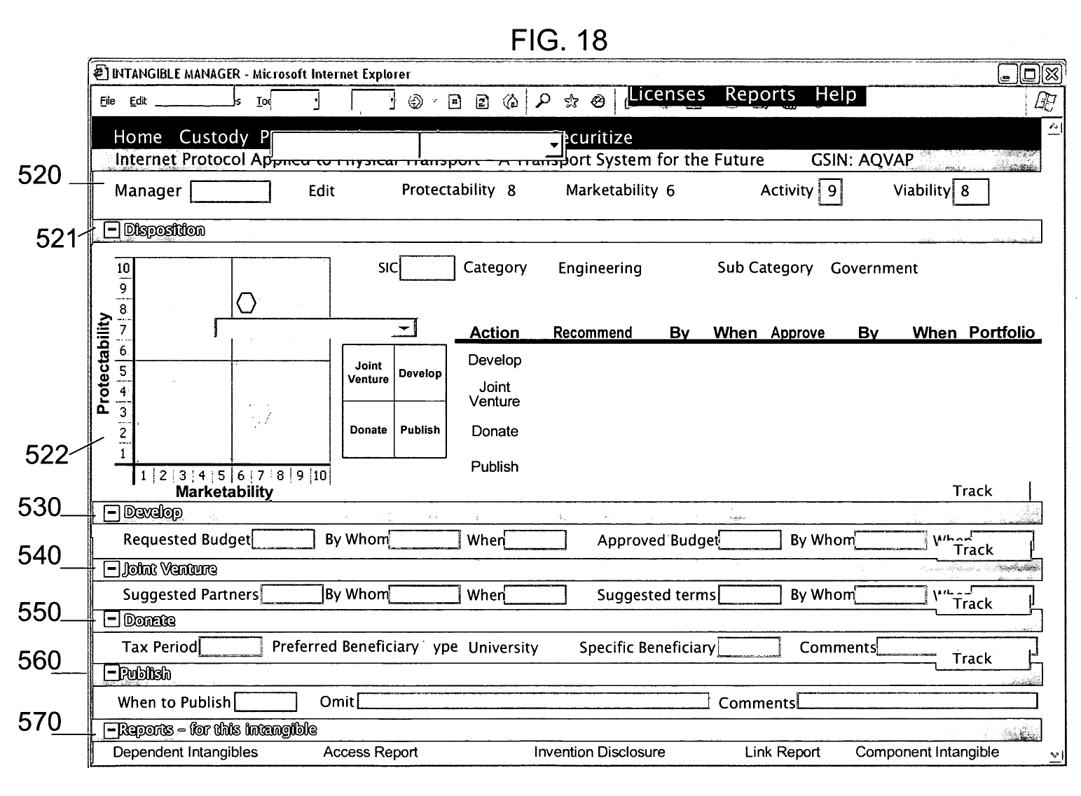

In various embodiments, the intangible asset management system comprises an analyze module (user interface page shown in FIG. 18). As the name implies, this module allows the user to analyze their intangibles. In various embodiments, the analyze module can be populated with various metrics for an intangible by different individuals, for example, the marketing group (Marketability), General Counsel (Protectability) and by the system itself (Activity) 520. These metrics assist management in deciding what to do with their intangibles and leads to “best practices” analysis and recommendations scatter gram shown in 522. The system tracks its own (the system's) recommendations as well as those of the manager responsible for the intangible and the “approver” for those actions.

In various embodiments, the system generates an activity report derived from compiling the number of user accesses to any intangible from anyone who is not one of the authors, and scoring repeat accesses by the same individual higher. The system also factors in a premium for recency (divide each access by the total time since the access) and the Innovation score of the user making the access as indicated in the formula below.

Σ=RTA*/1

### Where

A=Activity raw score
T=Time since access
R=Repeat factor (coefficient for a repeat from same user)
I=Innovation score (see below) of user making access
These raw activity scores are then ranked and the activity score is the decile the intangible is in for activity (10 is the highest).

In various embodiments, the analyze module is configured to also notify a user once a new intangible asset is entered into the centralized database that meets the user's area of interest.

Viability scores are derived from combining with empirically derived weighting coefficients of the Marketability, Protectability and Activity Scores. If any one of these is not available, a score of 5 is assumed. Innovation metrics are derived from the sum of the Viability scores, with weighting for recency (divide by time since intangible was last accessed by two or more different non-author users in a one month time period). These raw innovation scores are ranked for the group being rated (individual, business unit, company, nation) and the score is the decile in which the raw score falls in. Weighting coefficients are again determined empirically.

I_{R}=ΣallI'sV

### Where

### I_{R} is the Innovation Index Raw Score

### V is the Viability Index

The Collaboration Index is a function of the participation with other authors in the creation of new intangibles and the average number of annotations contributed to another author's intangible and the activity score of that annotation.

C_{R}=F(αnᵢ, βaᵢ)*V_{R})

### Where

### CR is the Collaboration Index Raw Score

nᵢ is the number of authors for an individual intangible
aᵢ is the number of annotations for an individual intangible
α is the weighting coefficient for nᵢ
β is the weighting coefficient for aᵢ
V_{R} is the raw Viability score for the individual intangible

All of these metrics can be refined using linear regressions to determine the historical fit to future predictions with varying weighting coefficients. Other metrics that will be researched include: Citation Index, Science Index, Litigation Index, Renewal Index and Prior Art Index. All available metrics will be regressed to test their predictive ability within various time, geographical and industry “filters”. The scores for Marketability and Protectability are used to generate a “disposition decision quadrant” shown in the FIG. 18, 521. Depending on where it falls in the quadrant, a recommendation is made by the system to the manager who may then follow the recommendation or propose another recommendation. All these decisions are tracked as is the subsequent approval. Once a decision for disposition is approved the system automatically implements it through either: Develop 530: Informing manager of approved budget for development of intangible and any other instructions or suggestions (e.g., adequate resources for developing); Joint Venture 540: Posting the intangible for joint venture or licensing, which is a way to advertise to potential partners; Publish 560: Automatically changing all security access to most open so that it is “published” as defined in patent law, which will act as prior art against others; Donate 550: Automatically transferring to a donation portfolio to be transferred to the trusted third party in the accounting period requested by the organization. Instructions may be given for further distribution of the asset to another non-profit entity but timing on this is more flexible, so as to generate tax deductions and reduce legal costs. The analyze module also gives the user the option to access reports related to the intangible asset 570.

In various embodiments, the analyze module is configured to allow entries and edits from multiple users including the general counsel, marketing group, and has options to send the edited or annotated intangible asset information for final approval by the legal department to legally protect the intangible asset.

Securitize Module

In various embodiments, the intangible asset management system comprises a securitize module. Securitization is a financial technique that pools intangible assets together and, in effect, turns them into a tradeable security. For example, the securitized module allows entities to organize their intangibles into portfolios that can then be used to generate revenue from licensing, be used as collateral for bank loans, placed in a trust fund, or to securitize the intangible portfolio as a special purpose vehicle. Typically, a special purpose vehicle is an entity constructed with a limited purpose or life (e.g., sell or license out the intangible) that would hold legal title over the intangible or portfolio and protect the assets from bankruptcy of owner. This may be a way companies can raise capital on the strength of their intangible portfolios, while simultaneously contracting to license back any potential usage they need for their own business. The securitize module combines the financing models of Asset Backed Securities (in this case Intangible Asset Backed Securities or IABS) and sale-leasebacks. In addition, individual intangibles or a portfolio of intangibles can be securitized and shares in this security offered on an exchange.

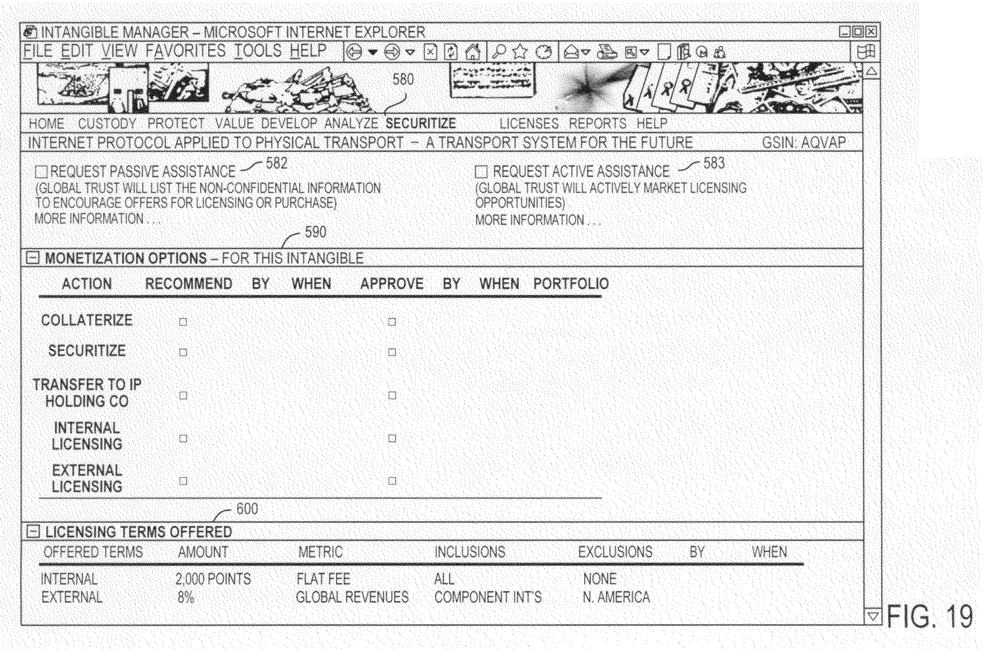

Referring to FIG. 19, an embodiment of the user interface for the securitize module of the intangible asset management system is shown (tab 580 highlighted). The securitize module has fields for a user, in this example, to request passive assistance 582 from a trustee to list non-confidential abstract associated with the intangible asset or request active assistance 583, where the trustee can add the intangible to its portfolio and actively market licensing opportunities for the intangible asset (e.g., trusted third party's licensing and technology transfer team). The system also allows access to proprietary content concerning the asset depending on the second user's trust score. The user will also be able to select monetization options 590 for the intangible or portfolio of intangibles that can be automatically approved and implemented by the trusted third party (e.g., collaterize, securitize, license the intangible, etc.).

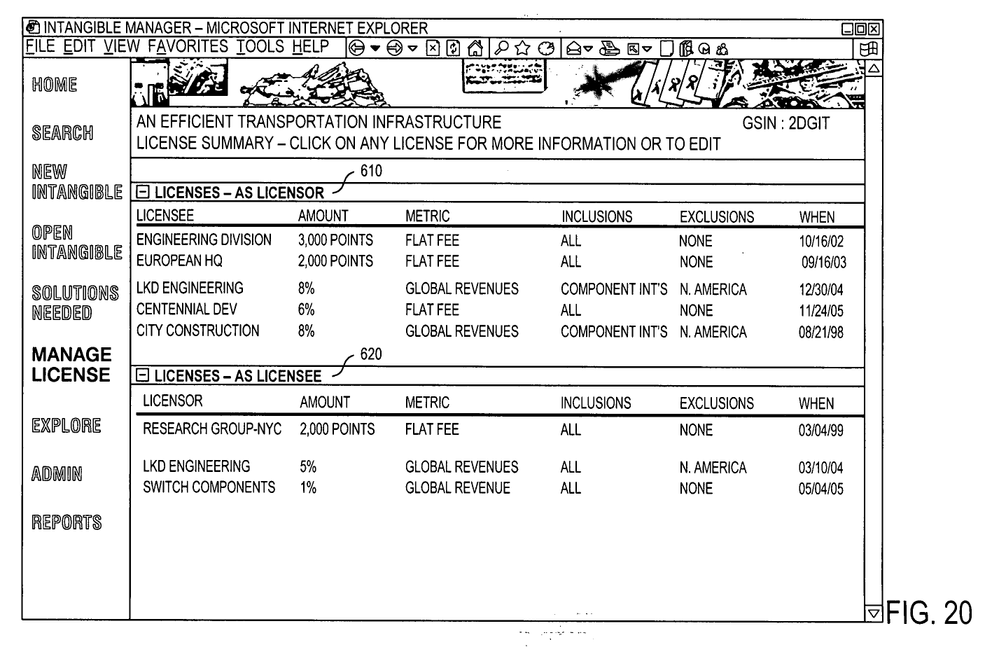

In various embodiments, the user can also select various licensing terms 600 acceptable for licensing the intangible, which the trusted third party can post for other users, possessing the authorized access level, to view and respond. When the user selects a license option, the user will be directed to the license module shown in FIG. 20.

In various embodiments, once the user is optimistic about a particular asset, the user can collaterize, securitize, place in escrow, clear title or fund the entity owning the registered asset. Thus, the systems and methods provided can expedite and maximize value for an entity in real time because the pertinent information is readily available from the database.

License Module

In various embodiments, the intangible asset management system comprises a license module. Sometimes, the value of an intangible lies in its ability to generate future revenue, which may be partially offset by its own dependence on licensing other intangibles. The license module tracks both licenses that an intangible depends on as well as licenses that it can itself generate for its own use. In addition, the license module tracks ownership (as a special instance of licensing), dependencies and potential conflicts between licenses.

In various embodiments, after leading the user through a series of questions, the license module can generate a license if one does not exist or can attach a license for the organizational archive if one does. Thus, in various embodiments, the intangible asset management systems and methods provided herein builds, tracks and manages a complex network of interrelationships (both internal to the organization and external) that model economic flows generated by the intangibles. Just as intangibles can have a variety of security levels, so do the licenses that join them. This module can determine who has access to various licensing information.

In various embodiments, the license module documents existing license and facilitates the creation of new ones. It includes all of the parameters encountered in almost all licenses and by populating this information not only allows for the creation of a license but also builds the econometric model of the relationship between an intangible or group of intangibles and the innovation it needs to license in or is able to license out. When these are populated it enables sophisticated econometric modeling. The license module comprises one or more of the following work flow: automatic generation of licenses; validation by checking counterparties in the license; the ability to create a ‘Solution Offered’

FIG. 20 is an embodiment of the user interface for the license module of the intangible asset management system, which has fields for a user, in this example, to view or post licensors 610 and licensees 620 for the intangible asset and information surrounding the license including meta data (e.g., revenues from the license, date, as well as entities that are included/excluded from the license because of, for example, industry conflicts). A prospective licensee or licensor with appropriate access levels to the database will be able to view the posted licensing information.

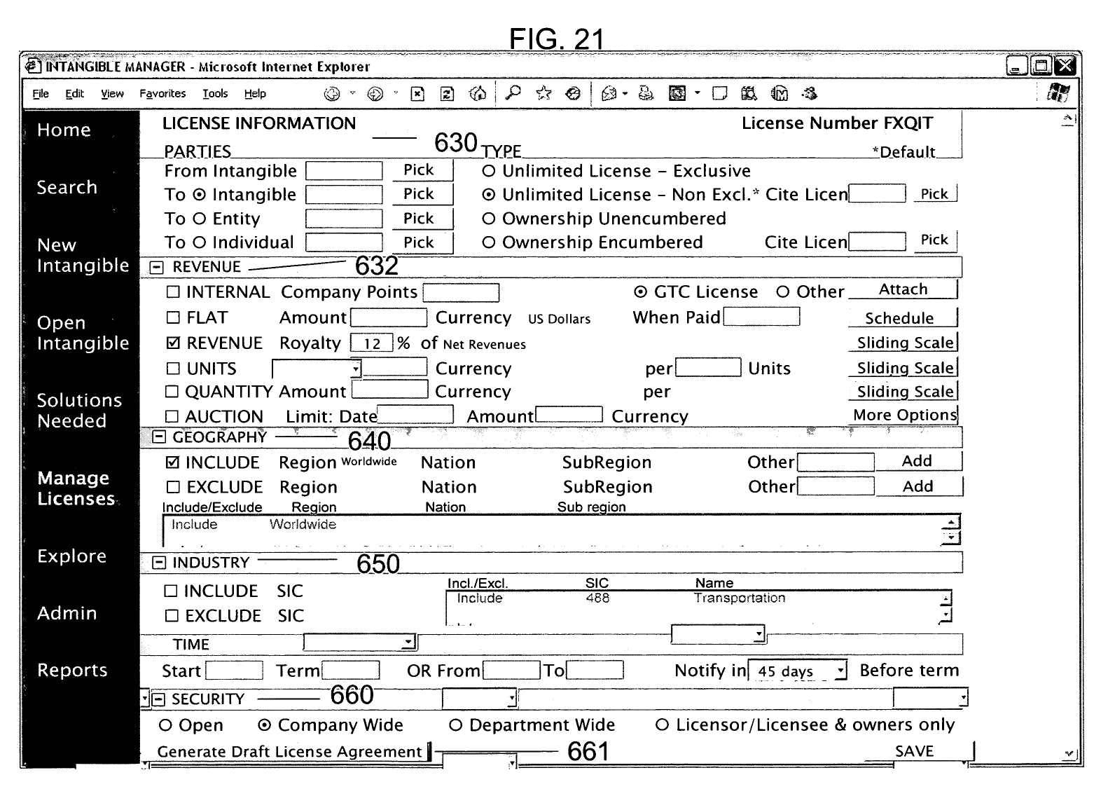

FIG. 21 is an embodiment of the user interface for the license module of the intangible asset management system, which has fields for a user, in this example, to populate, link, and/or track information about the license 630 (e.g., type of license, licenses between intangibles, entities, and/or individuals). These fields in aggregate cover many or all of the potential parameters that might occur in a license agreement and allow the user to collect the data from existing licenses so that it can be more extensively analyzed by the system. For example, for overall economic impact on the organization in various scenarios and to also store an electronic or scanned copy of the license within the system. In addition if a license does not yet exist once the fields have been populated the system can automatically generate a license based on the parameters. Variations of the license are used throughout the system—for example—to document and formalize what are often informal internal licensing arrangements. There is also a field for selecting various security levels, which grant certain users access to this information 660. Fields for the revenue associated with the license 632, the particular geography for the license 640, and the particular industry for the license 650 can also be viewed and edited. In various embodiments, there is a reports generator that allows various reports to be generated concerning the license including template licensing agreements or collaboration agreements 661. The user may also have access to solutions needed data.

Solutions Needed Module

In various embodiments, the intangible asset management system comprises a solutions needed module. Sometimes, the solutions needed module can be viewed as the combination of a special instance of an intangible (one that does not exist yet) and a license (one that does not yet have a licensee). Apart from these distinctions, it can inherit the properties of both. Corporations and governments are increasingly looking to outsource their innovation and the solutions needed module provides a convenient way they can do so in addition to a source of projects for research facilities in corporate, academic and independent research labs or for individuals to investigate. The solutions needed module allows a company to post an award for anyone who can solve a problem that the company has. The award, in various embodiments, can be looked at as a type of license in technology to the user in need of a solution. In this way, the company is outsourcing their innovation and then licensing it back in the company.

In various embodiments, the solutions needed module includes a database comprising problems needing solution (e.g., a better way to attach computer chips to the motherboard, coat a dvd, electroplate a metal, etc.). The solutions needed module identifies an intangible that does not yet exist and a license that has no licensor, but it does have a licensee. The solutions needed module, like the other modules in the database are searchable.

In various embodiments, the intangible asset management system and methods includes solutions offered intangibles stored in the database. The solutions offered intangibles are problem solvers where an intangible and licensor for that intangible exists, yet the intangible does not have a licensee. The intangible asset manager database is a conduit to bring the potential licensor and licensee together to begin the exchange of intangible assets to solve the particular problems of a user or develop intangibles to solve the problem. In various embodiments, the database is configured to allow a trusted third party to find licensors or licensees for the intangible.

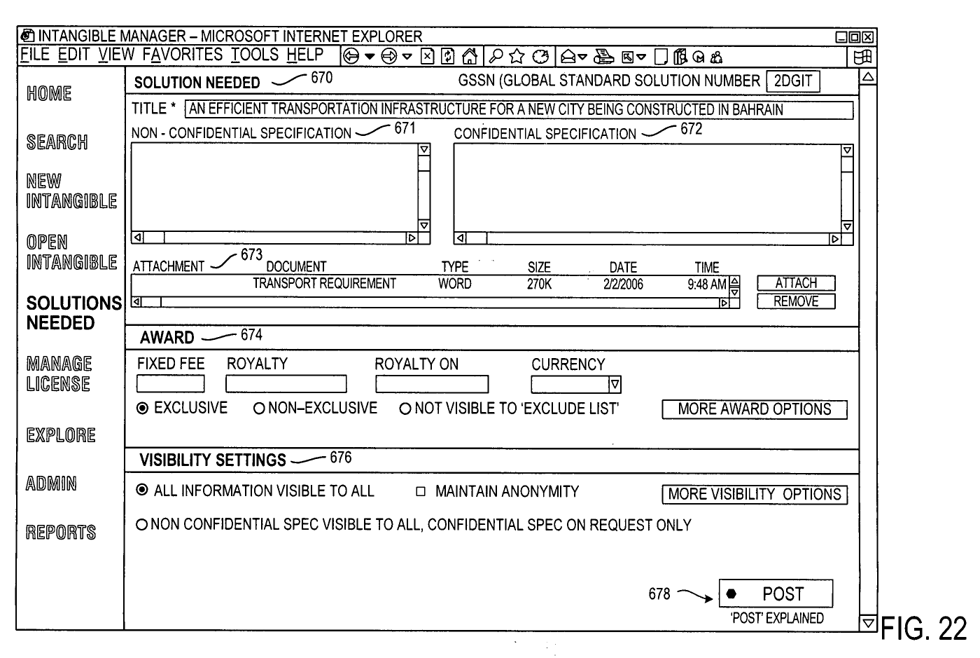

FIG. 22 is an embodiment of the user interface for the solutions needed module of the intangible asset management system. This interface displays, for example, a particular problem that a user faces and there is no existing intangible that provides a solution to the problem. The module has fields for a user, in this example, to post the problem 670 that the business needs solved and the specifications that the solutions will need to meet to qualify as an award. The user will not only be able to post associated confidential specification 672 and non-confidential description 671 concerning the problem to be solved, but the user will also have the option of attaching a copy of any related document (e.g. NDA/CDA, MTA, collaboration agreement, etc.).

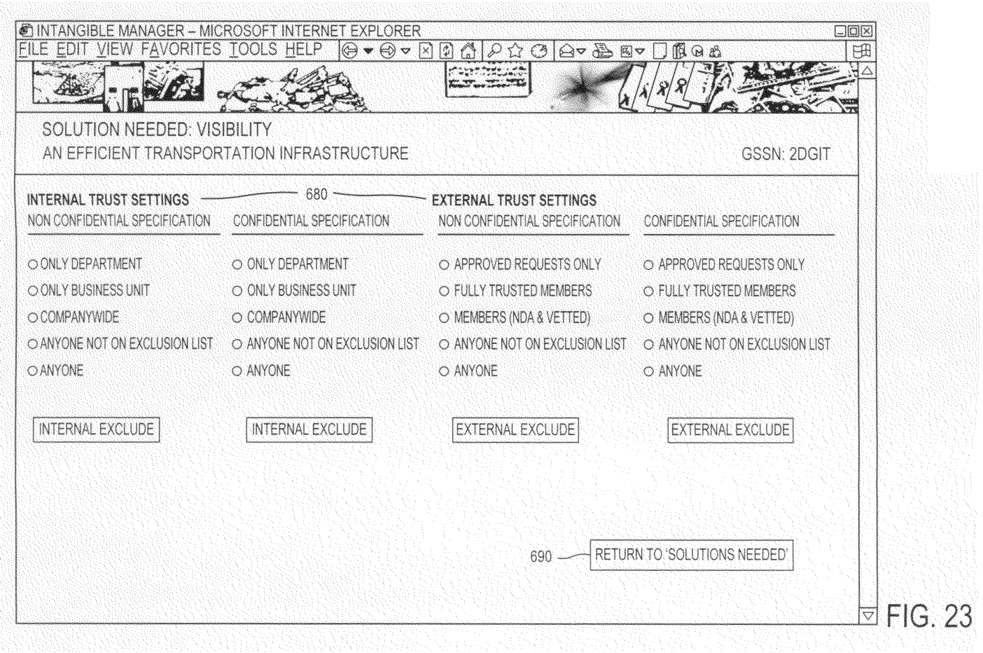

In various embodiments, the user also has an option to post an award 674 for such intangible asset that solves the problem and has the option of selecting options for confidentiality of the information and anonymity of the entity with the problem. The system also allows the user to set the visibility 676 of the solutions needed by other users and post the solution needed 678. This module fosters collaboration and allows a second user the ability to create an intangible asset, where none existed that solves the problem of another user. After entries are made, certain users will be directed to FIG. 23.

FIG. 23 is an embodiment of the user interface for the solutions needed module of the intangible asset management system, after a user populates the solutions needed entries, the user is directed to fields 680, in this example, to allot different internal and external trust settings to the standard solution identification number. For example, the user can set internal trust settings for a non-confidential description about the solutions needed so that only a particular department, business unit, company, anyone not on the exclusion list, or anyone can view it or be excluded from viewing it. The same type of setting can be set for the confidential specifications about the solutions needed, except the external setting can be set based on the approval by other users, fully trusted members, members that are vetted or have a CDA/NDA or anyone. The user also has the option of returning 690 to the solutions needed module page in FIG. 22.

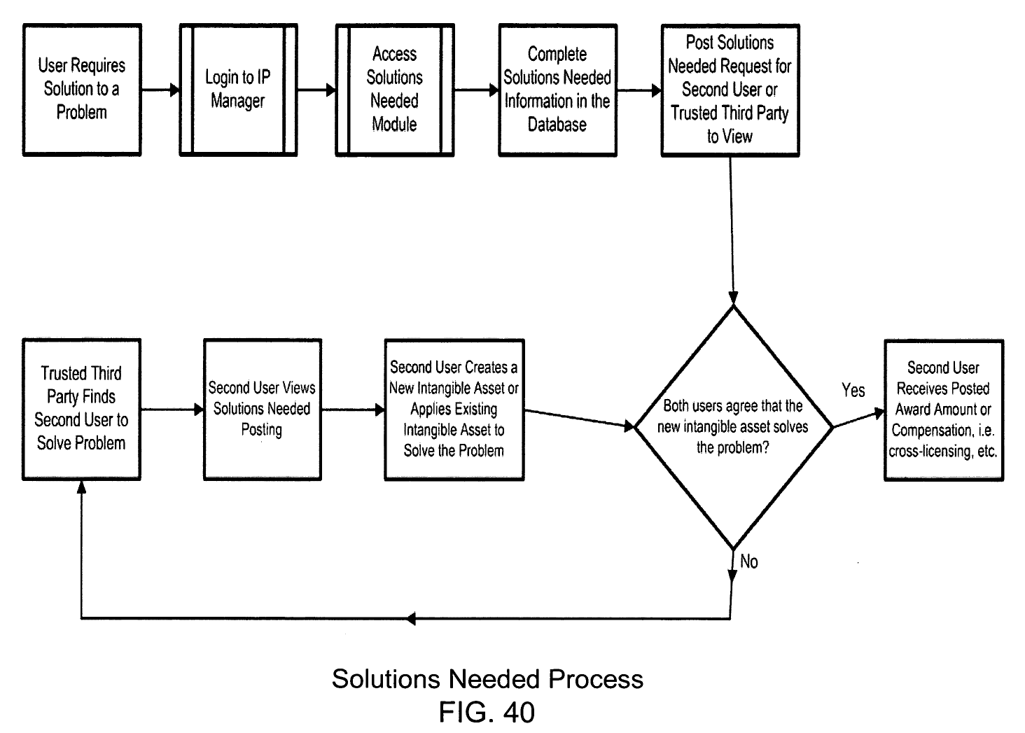

FIG. 40 shows a block diagram that illustrates an embodiment of the solutions needed module. A user requires a solution to a problem and logs into the database. If the user has the required security level, the user will gain access to the solutions needed module and populate the database with information regarding the solution needed. The user will transmit (e.g., post, e-mail, etc.) the solutions needed for a second user or a trusted third party to view. The trusted third party or the second user may offer an intangible that offers a solution, stores it in the database and transmits it to the user. The user and the second user must agree that the intangible offered, does indeed solve the problem that the user has. Is so, then the second user receives compensation from the user or the trusted third party for that intangible. The compensation may be in the form of a license to other technology or other value. In this way an exchange is created. In various embodiments, if there is no intangible that offers a solution, then the trusted third party or second user can create an intangible asset that presents a solution to the user's problem. The intangible is registered in the database and the second user is compensated for the intangible. In various embodiments, the third party may also out source the solutions needed to a second user who can offer the solution.

Search Module

The intangible asset management system comprises a search module. As the intangible asset management system database is populated, the information contained in the database will be more valuable on a daily basis. The search module will also provide valuable metadata and aggregate data that will help establish benchmarks for valuation.

Typically, the search module includes a searching component with a search engine provided (alone or in conjunction with other modules) to control the search and retrieval of intangible asset information (e.g., metadata) stored in the database based on search criteria or queries formulated by the system and/or user. A search engine may provide text-based, graphics-based, code-based, or other search/query mechanisms to produce search results to be viewed, accessed, edited, or otherwise output to be saved in the database or viewed by a user. In one embodiment, for example, the search module performs searches based on input data such as: GSIN or custom identifier, keywords; text or graphics in select fields (e.g., title, author, licensee, different segments or information fields of documents, etc.); Boolean logic characters, or other search criteria.

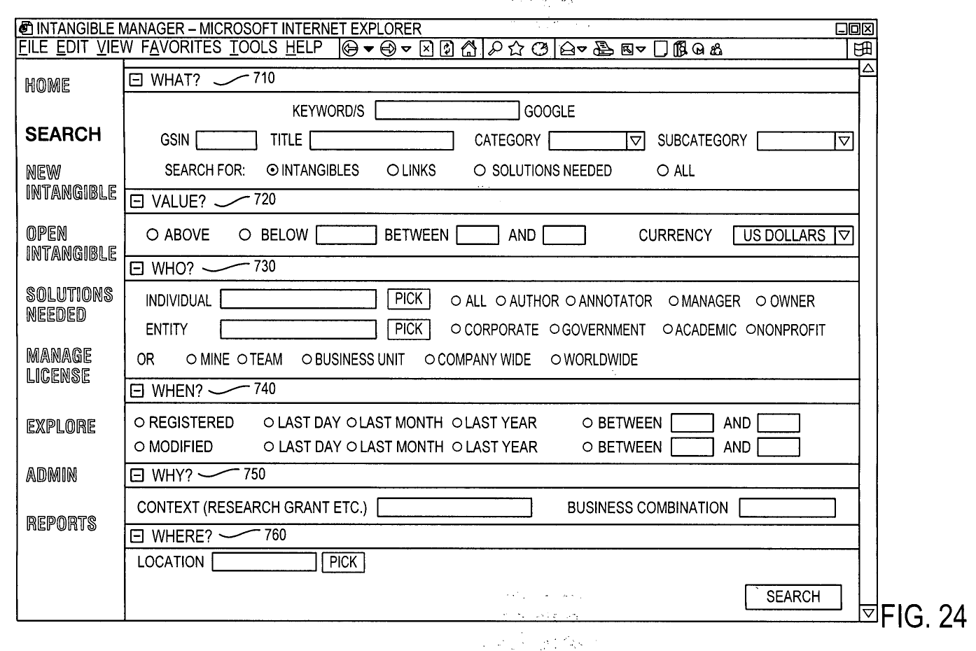

FIG. 24 is an embodiment of the user interface for the search module of the intangible asset management system, which has fields for a user, in this example, to search selected fields using parameters such as keywords of the intangible asset title, GSIN, intangible, licenses, solutions needed or all fields shown in 710. The user also has options to search by value 720 of the intangible asset or problem to be solved. The database can also be searched by the particular user 730 (e.g., individual, entity, author, annotator, manager owner, corporate, government, academic, nonprofit, team member, business unit, companywide, worldwide, etc.). In various embodiments, the user can also search the database as to when the intangible was registered and/or modified and restrict the field of search to certain dates. Searches can be conducted based on the context 750 the intangible was registered (e.g., research grant, business, target company acquired), which may be important for tax purposes as well as searches conducted by location 760 of the entity (e.g., US, EU, etc.).

In various embodiments, the search engine is programmed to permit editing or refinement of the search criteria or query to perform additional searches on different data sets or that data set produced from the initial search results. Results of the search or query are compiled for storage and/or archived, display, or other output to the user.

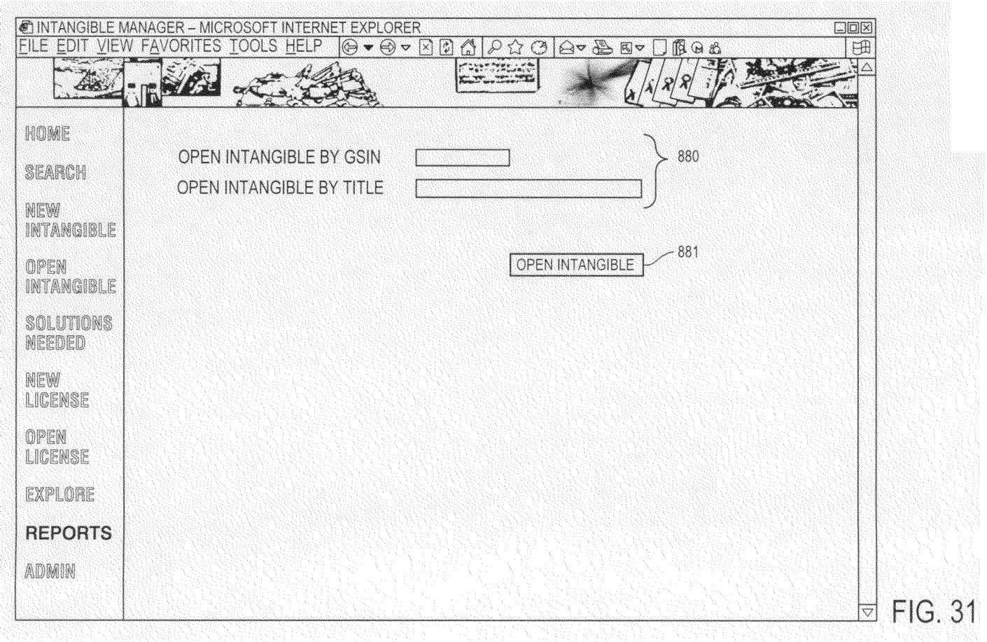

FIG. 31 is an embodiment of the user interface in the search module of the intangible asset manager where a user can open an intangible asset based on 880 the title and/or GAIN or GSIN. The results for that search can then be opened for that intangible 881. If null searches are collected, the user can use this information to potentially create a ‘map’ of the areas where there are no intangible assets—often referred to as “white space”.

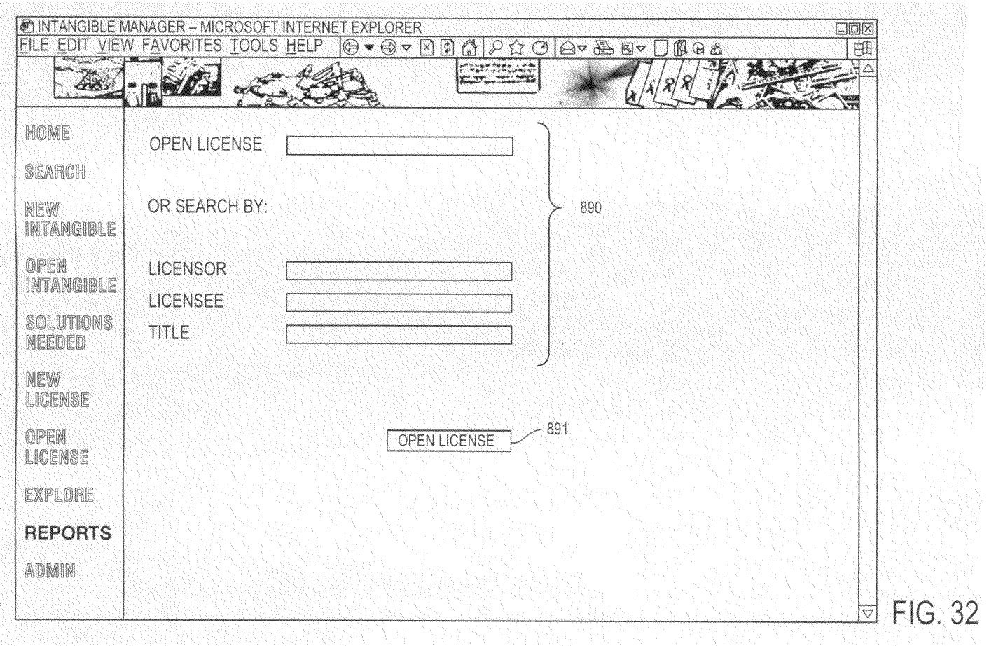

FIG. 32 is an embodiment of the user interface in the search module of the intangible asset manager where a user can open a license or search the database by licensor/licensee or title 890 and open the license 891.

In various embodiments, the server or computer makes the search results (and any available underlying documents listed) available for viewing or other output (e.g., print, e-mail, fax, etc.) by the user (or user interface). The search results may be ordered, sorted, and saved in accordance with one or more known order preferences set by a user (e.g., date, alphabetical by title, inventor, assignee, relevancy, weighted relevancy, scoring formula, etc.). In accordance with one embodiment, the resulting information (i.e., results and/or available underlying documents) may be downloaded in one or more textual/graphical formats (e.g., RTF, PDF, TIFF, etc.), or set for alternative delivery to one or more specified locations (e.g., via e-mail, fax, regular mail, courier, etc.) in any desired format (e.g., print, storage on electronic media and/or computer readable storage media such as CD-ROM, etc.). The user may view viewing the search results and underlying documents at the user interface, which allows viewing of one or more documents on the same display, as well as viewing of one or more portions or segments, summaries, or information fields of different documents (e.g., message envelope, text, author/inventor, etc.) separately or together so as to facilitate analysis of the search results. In various embodiments, all documents are OCR searchable.

The results of the search may include a list of intangibles stored locally or remotely on the database or there may be links to resources on remote storage systems accessible over an external network or there may be other links or data identifying a location or resource (on or off-line) of information (e.g., text, author/inventor, etc.) corresponding to the search criteria or query.

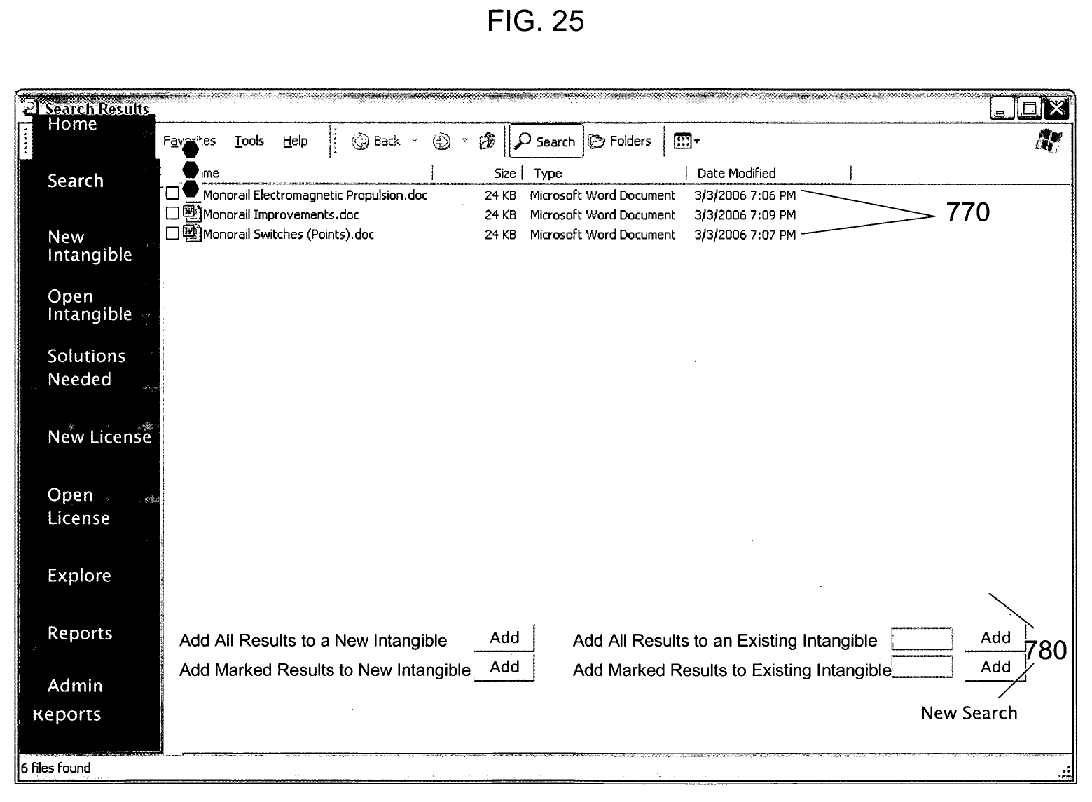

FIG. 25 is an embodiment of the user interface for the search module, which displays a typical summary list 770 (in explore type format) for selected search fields of the intangible asset manager. The summary list can be opened for more detail by clicking on the appropriate file. The search results can also be used partially or in their entirety to create or add to portfolios such as licensing, securitizing or licensing portfolios by clicking on tool bars at 780. The add bars allows a user to add the results to develop a new intangible asset or associate it with an existing intangible asset to further populate the database. If null results come up in a search, this may be an area for white space to be identified and a company can begin its R&D in this area, or a solutions needed can be posted in the database and the appropriate technology licensed in. In one embodiment, the search results are saved and cannot be deleted.

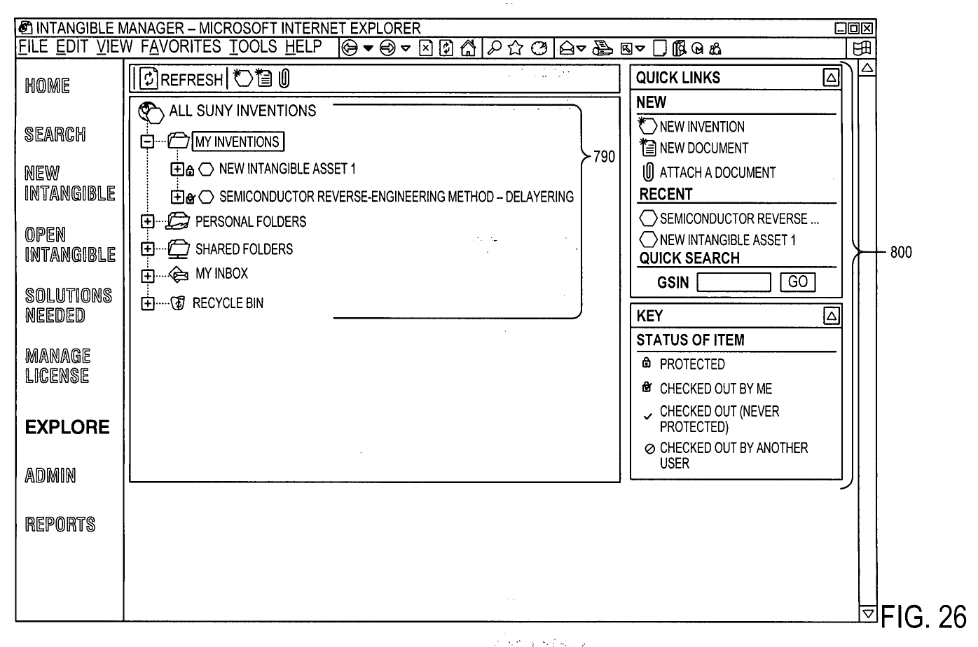

FIG. 26 is an embodiment of the user interface for the search module, which displays typical results for selected search fields of the intangible asset manager. Intangibles can be managed through an explore window 790, where the simple intangibles are shown as hexagons and the compound intangibles (those with component intangibles or combinations of intangibles) are shown as folders with hexagons inside. Shortcuts can be created so that one intangible can include several portfolios or compound intangibles. The user can organize the results according to whether the intangible assets are simple or compound and the user interface gives the option for the user to search or link to other areas of the database.

In various embodiments, the search module provides all module level search features. It allows users to locate intangibles registered within the system based on full text search of the description fields, and through the use of keywords, which can be applied to all searchable fields and used to post results. Results will only be displayed according to the access privileges of the user. Search results may be sorted, grouped or filtered by registration date, last modification date, author, manager, location, business unit, etc.

In various embodiments, the module provides four modes of operation which are:
Basic keyword/full text search: This is the simplest mode and includes a standard search term input box and a button to execute the search.
Advanced search: Advanced search mode is an enhancement over basic search in that additional search features can be selected. Additional options allow the user to specify specific intangible types, value ranges, date ranges, and presents logical AND/OR logic for multiple keywords or phrases.
Paged Results display: When a search has been executed, the results are displayed as a list which includes a small icon indicating the type, the title and summary, the asking price (if available), the date the posting was posted and/or expiration date, and the posting entity's user identification field. Result sets that exceed the maximum number of intangibles registered allowed per page will cause the module to display page forward/back navigation elements at the top and bottom of each page, along with the number of pages in the result set. We can search all modules. In various embodiments, searches can also be constrained to those intangibles that are available for license or sale. The database is configured to allow searches to be conducted (and/or displayed) by requested licensing terms where available

Reports Module

The intangible asset management system, in various embodiments, can have a reports module (alone or in conjunction with other modules) in generating reports concerning the intangible asset, a component intangible, a portfolio of intangible assets and/or intangible asset information. Reports module, for example, may be programmed to allow users to create and store templates or other forms (e.g., CDA, NDAs, research data templates, etc.), which can be populated during report generation. Reports may then be generated manually or automatically from selected data sets (e.g., Custom identifier, GSIN, inventor, user, licensee, licensor, intangible asset portfolio, etc.), or from contents of one or more workspace folders.

In various embodiments, the reports module includes a reports generator capable of creating and storing multiple reports. Reports will be defined using reporting tool libraries, which streamline creation and execution such as Microsoft SQL reporting services or Data Dynamics. The reports module typically will have three modes for an authorized user to generate reports:
Stored report list: This will be the default mode displayed to the authorized user. It will display a list of pre-defined or “Canned” reports, along with any reports that the current user may have defined and saved.
Report generator: Available to authorized users only, this mode will allow the user to define, test, and save reports for individual use, or for use by users which will be defined by the system administrator.
Report Display: This mode will display a generated report to the user. Reports will be printable, and will be formatted according to the system's UI constraints.

In various embodiments, the reports module allows a non-technical user without HTML knowledge to attach, delete, export and modify documents in formats such as Microsoft Word, Word Perfect, Power point, Excel, Access and/or Portable Document Format or other formats that the user wants or needs.

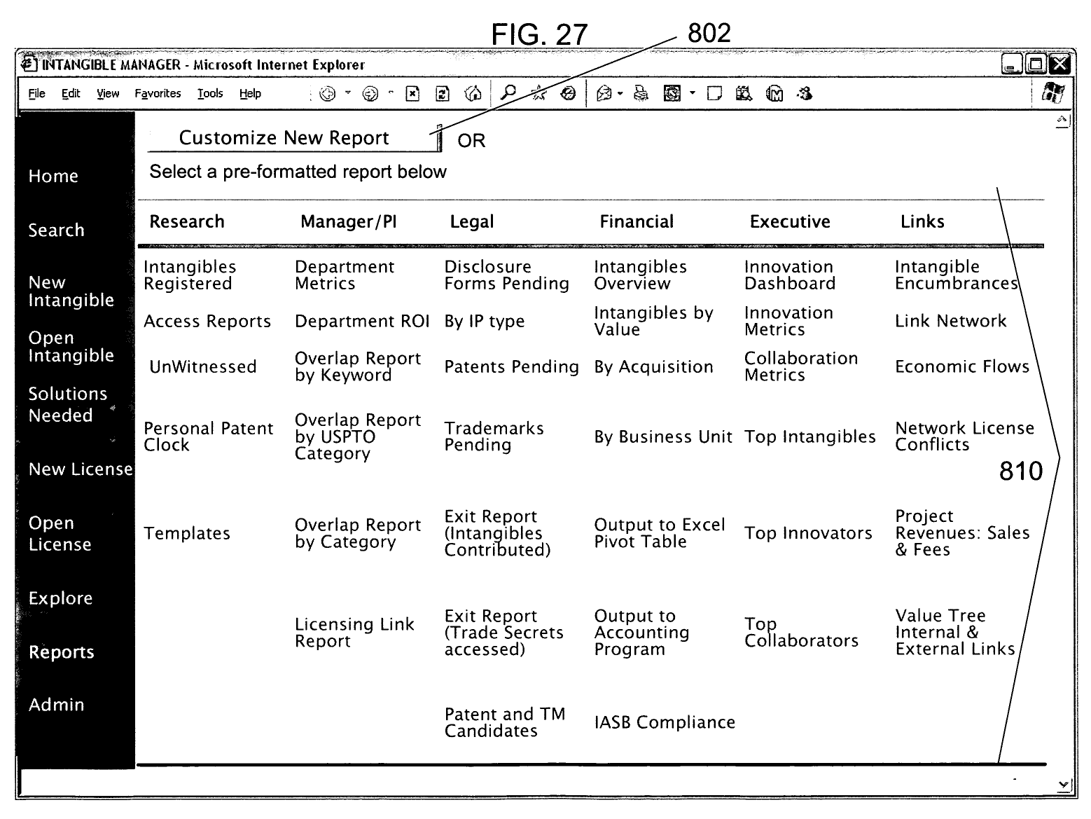

FIG. 27 is an embodiment of the user interface for the reports module, which allows a user to select types of reports (customize new reports 802) or prepare preformatted reports 810 based on the business unit or division selected.

In various embodiments, the reports generator can focus on the intangibles as well as the links/licenses between them. In particular, the reports generator looks at the economic flows that both are generated by an intangible and, in addition, are also needed by an intangible (in terms of licenses for component intangibles that it is dependent on). This allows for much more sophisticated financial analysis and planning as well as being better able to determine the true return on investment of a project, department or individual.

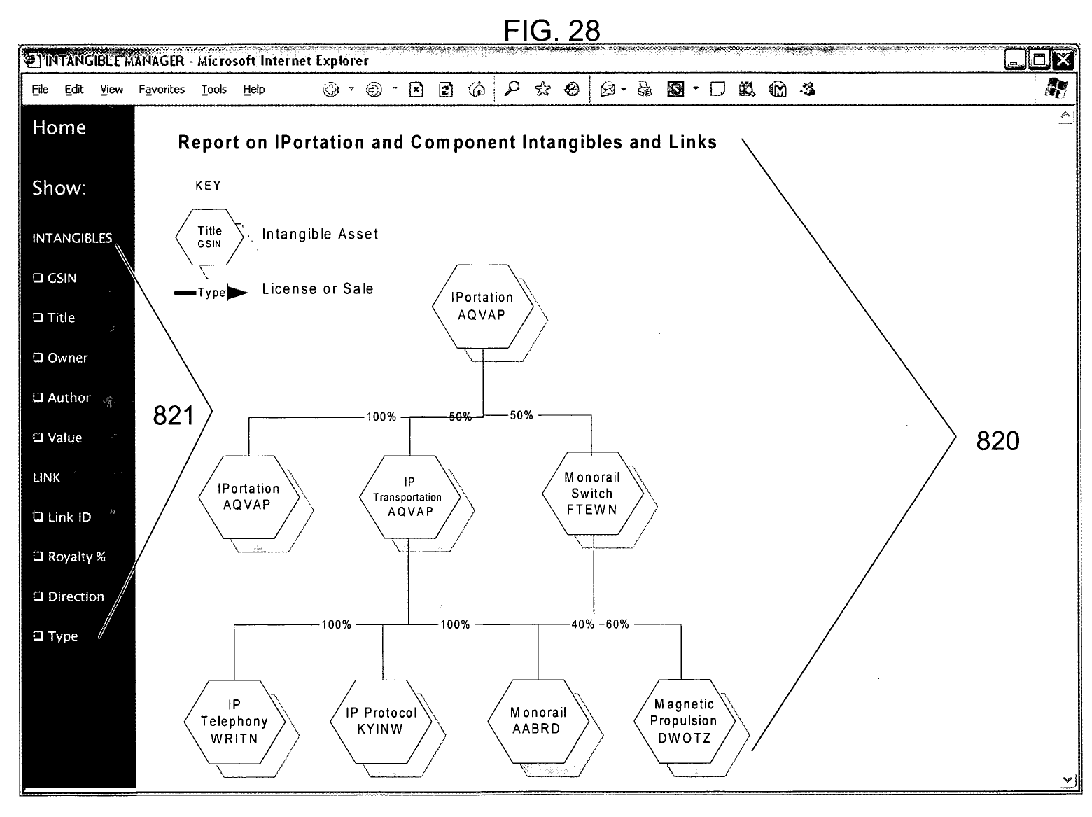

If a user selects a licensing report from page in FIG. 27, the user will be direct to the report page shown in FIG. 28. This figure is an embodiment of a license flow chart report generated by the system, which describes the percentage licensing/sales licenses associated with a particular intangible asset or component intangible 820. On the left hand side 821, the user can select what information is displayed on the report. It is intended to generate these reports by using the interapplication facility of Biztalk to extract the necessary information from the database and transfer it to a program that can graphically portray the data in flow diagrams (e.g., Visio, PowerPoint, Excel, etc.) and the licenses between the intangibles.

The reports generator can also generate reports that are useful to the CEO. For example, CEO's are concerned about how to increase the levels of innovation and collaboration in their organizations. But before they increase these, they must first be able to measure them. The intangible asset management system can prepare reports with metrics on innovation and collaboration for the whole organization or for individual business units within the organization. They can determine who is really adding value to the organization and who is just writing memos and having meetings.

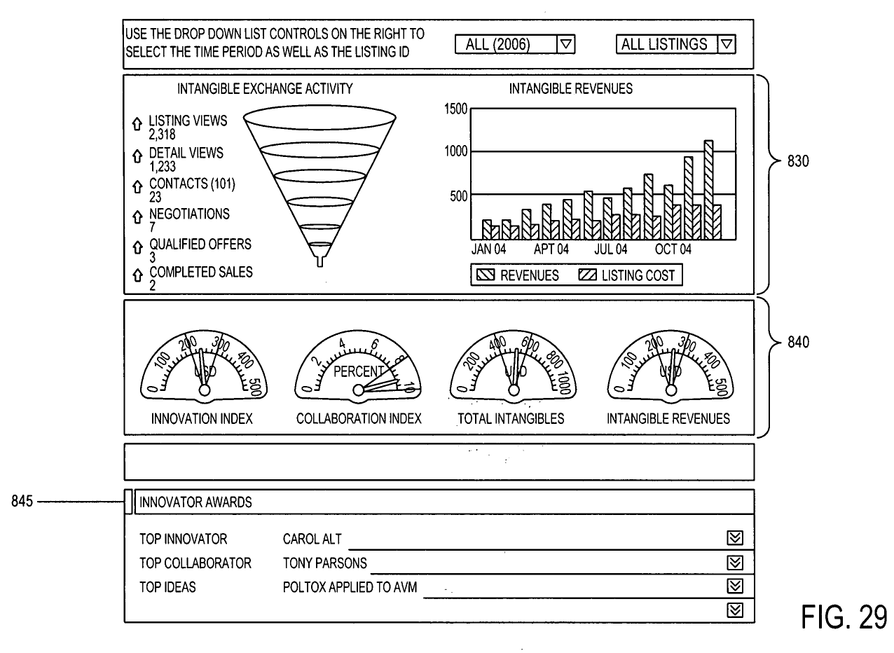

If a CEO selects an executive report (innovation dashboard) from the web page in FIG. 27, the search module will gather data based on the query as to innovation within the company and the user will be direct to the report page shown in FIG. 29, which is an embodiment of a typical CEO's report generated for the company by the reports module. Shown graphically in a dashboard are economic flows for the intangibles, e.g., what proportion of the value or revenue is generated from the intangible asset 830, what are the major related intangible metric 840 (e.g., innovative and collaborative index, total intangibles and intangible revenues), who are the most contributors and what are the most important ideas contributed to the company 845. The CEO can also request specialized reports from GTC that will compare the CEO's company with others in the same industry or geography for performance on intangible measures. The CEO can use the innovation and collaboration metrics to establish award programs and to link incentive compensation to the behavior that he wants to incent-innovation and collaboration.

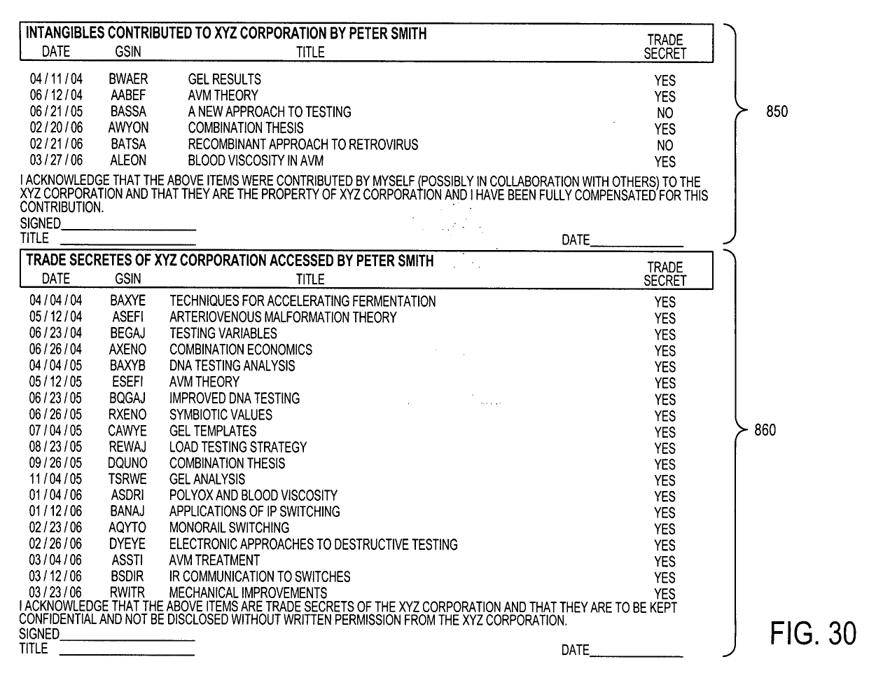

The intangible management system and methods can also generate exit reports that the CEO, GC, Human Resources, Patent counsel, etc. can use during exit interviews when employees are leaving the company. In the reports module interface, the user selects the exit reports for the individual employee, the search module will gather data based on the query as to all the intangibles that the employee had access to and the reports module will generate an exit report, an example is shown in FIG. 30, which details the intangibles the employee created while employed. The report will have a notice for the employee to acknowledge that the intangibles are the property of the company and will provide a signature line and date for the employee to sign 850. The report will also indicate the trade secrets that the employee accessed while employed and the report will provide a notice that the employee acknowledges that they are confidential to the company and provides a signature line and date for the employee to sign 860. The exit reports can be generated for the employee to sign before receiving the severance package. In this way, the system reduces disputes as to what was invented while employed and what is company property.

Intangible Exchange Module and Value Funds

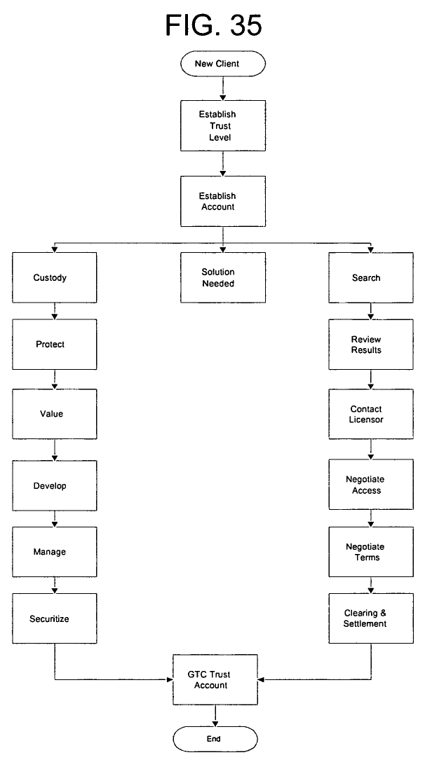

In various embodiments, the intangible asset management system database comprises an intangible exchange module, which allows a new client to establish an account to acquire or exchange intangible assets of any kind including trade secrets. FIG. 35 illustrates a flow diagram showing the pathway for establishing a new client account for accessing the intangible asset management system. The new client first establishes a trust level before access to the database is granted or the trust level increased by the trusted third party. This trust level can be granted from signing CDA/NDA or other agreements to abide by certain rules. Permission can also be granted on a case-by-case basis through workflow built into the intangible asset management system. Other ways to have the appropriate trust levels to access the database include, for example, placing funds in a bond or escrow, joining a particular industrial organization (e.g., a consortium) or society, etc. The new client, depending on the trust level, will be able to search the database modules, review results, contact licensors, negotiate access terms, and clear and settle accounts using the database.

In various embodiments, the intangible exchange management system utilizes BizTalk to efficiently and effectively integrate systems, employees, and trading partners. It can be fully integrated with Microsoft Visio, and can provide a robust platform through which server-to-server communications, long transactions, and data transformation can be automated using virtually any communication protocol.

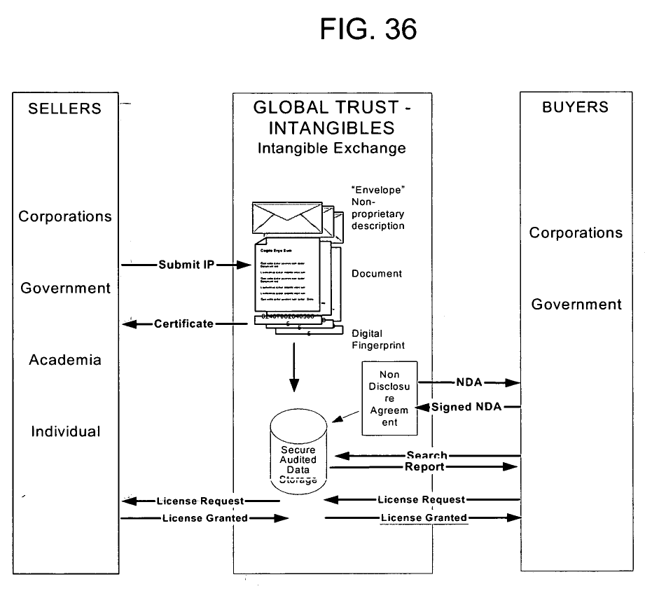

In various embodiments, the intangible asset exchange module allows the user to register the intangible asset or a solution-needed component in the centralized database. FIG. 36 illustrates the flow of the intangible exchange, where a trusted third party Global Trust Company) maintains the intangible asset exchange. Sellers (e.g., corporations, government, academia, individuals are granted access to the database and submit the intangible. The submission on the database can be information about the IP (intellectual property), which can have a non-proprietary description associated with it and a message digest. This information is stored on the database and a potential buyer (e.g., corporation, government) can access the database based on their trust level or sign an NDA/CDA to get access. The buyer can search the database to determine what IP they are looking to acquire or license in or out. The transactions and contemplated transactions are captured on the database. For example, companies derive value from managing their innovation through the innovation simply through identifying, valuing, prioritizing and developing their innovation and encouraging better collaboration between business units and departments within their organization (one board member found many projects all attempting to do the same thing within the organization—almost all of them unaware of the others). However with the simple click of a mouse the walls between their organization and others can partially come down and all the companies originally using the tool to manage their innovation internally can become part of a trusted global community that, within a trusted environment and with carefully calibrated trust levels for differing parts of each intangible, enables them to take advantage of the global pool of innovation either by out licensing some of their intellectual property or by in licensing technology they need instead of going to the expense of developing it from scratch internally. This allows the organizations to actually practice the often stated ideal of “Open Innovation”. The exchange works because: the intangibles have been identified, documented and often valued (sometimes by an independent third party) and the information is stored in the database. Further, there is an audit trail of all activity, a common code of conduct agreed to by all participants (users) of the database and the participation of ‘market makers’ who increase liquidity by providing a bridge between sellers and eventual buyers for intangibles that while showing promise do not have an immediate market.

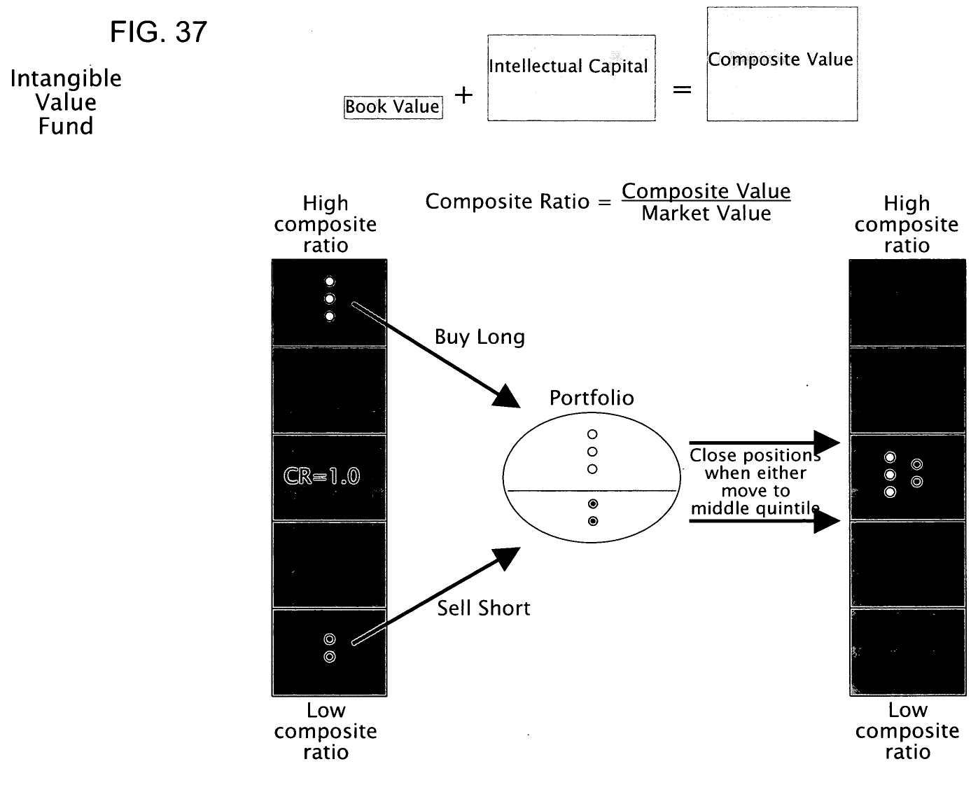

FIG. 37 is an embodiment illustrating the intangible asset value fund, where intangible assets or portfolios of intangible assets saved in the database can be sold when a certain composite ratio is reached. The composite value is the book value of the intangible plus the intellectual capital and can be divided by the current market value to obtain a composite ratio. When the composite ratio is high for the intangible asset or portfolio of assets investors can use this information to further invest in the company. Likewise, when the composite ratio is low, then investors can reduce their risk in the company. For example, when the composite ratio is low for a portfolio of assets, investors can take a short position in the company. This allows profiles for investors to invest in the company based on the company's intangible asset portfolio.

The value matrix of the intangible asset value fund describes a sophisticated and unique system through which the trusted third party (e.g., GTC) will track both aggregate values and component values of intangibles belonging to organizations of all kinds. The value matrix involves several new ideas: (i) the concept of dynamic valuation (where factors in a valuation that may change over time are tracked over time enabling a near real time update of value) (ii) the concept of iterative valuation in which we maintain a full database of values for all the intangible components and use multiple metrics to determine values—as many values can be derived from multiple factors including other intangibles within the organization and various true up routines that adjust as new data comes in (this embodies the concept of iterative valuation in which values are continually updated as better estimates are available thus enabling better valuations of other intangibles within the organization); and (iii) the concept of testing against the market this is possible as with the intangible manager system where we are able to aggregate the values of all the component intangibles for an organization and add it to the value of an organization's physical and financial assets and then compare this estimated total value with actual market values (where available) but with various lags.

In various embodiments, through running multivariate regressions through years of data the value of each metric starts to emerge from the noise and we can measure each metrics usefulness (in various circumstances—e.g., geography and industry) in terms of its correlation, statistical significance and predictive value. With this we are able to determine the weighting coefficient for all of the component metrics and then run all of the metrics with the appropriate weighting coefficients to generate a very accurate estimate for the value of individual intangibles and total organizational value. These can then be used in two funds: (1) the intangible value fund that acts as a value fund but instead of comparing the book value to market value, it compares total value that includes the accurate valuation of all of the intangibles. Plus the financial and physical assets. This total estimated value is ratioed to the actual market value with the time lag that is found through regression against actual market value to provide the best predictive value (the ‘value ratio’). The fund buys those companies in the highest quintile of ratios of estimated total value to market value (the amount of these positions is weighted with the strength of the ratio). The fund also sells short those companies in the bottom quintile of the value ratios (again weighted by the lowest ratios). This generates a market neutral fund that according to our research will significantly outperform the market indices. It should be noted that this effort is not based on patent maintenance (we use it as one of the many metrics but certainly not as the whole basis of a valuation system as some early efforts in this field have done).

In various embodiments, the intangible asset fund also uses the valuation matrix referred to above but does so in a different manner. Instead of investing in the companies that own the intangibles it invests directly in the intangible assets themselves typically by taking an option on license rights (often limited to the particular geography or industry that our metrics indicate particularly undervalue the license) to an intangible that the valuation matrix has determined to be undervalued. Once the option to license is available, an entities' technology transfer department can attempt to secure licenses using the database. When the option is due to expire, the entities' technology transfer department can either exercise or not exercise the option to license the intangible asset themselves based on the progress made by the technology transfer department. Both of these funds will have traditional fund mechanisms in place such as ‘stop loss’ protections.

In various embodiments, the intangible asset management system employs a Freedom to Operate Funds. This fund is similar to the intangible asset fund in that it will invest primarily in intangible assets but the investment goal is not just to generate a return on the investment but also to ensure continued freedom to operate for the major investors in the fund. The funds will be organized by industry and the investors will primarily be major industry participants who will each make recommendations of intellectual property that they consider to be critical for their ongoing operations. The fund will then secure license rights from which certain essential rights will be granted back to the major fund participants. The licenses will also be used to generate revenues from non-fund participants. In this way the fund also provides protection against patent ‘trolls’ in that they provide industry wide negotiating leverage rather than allowing companies to be “picked of” individually by the patent troll.

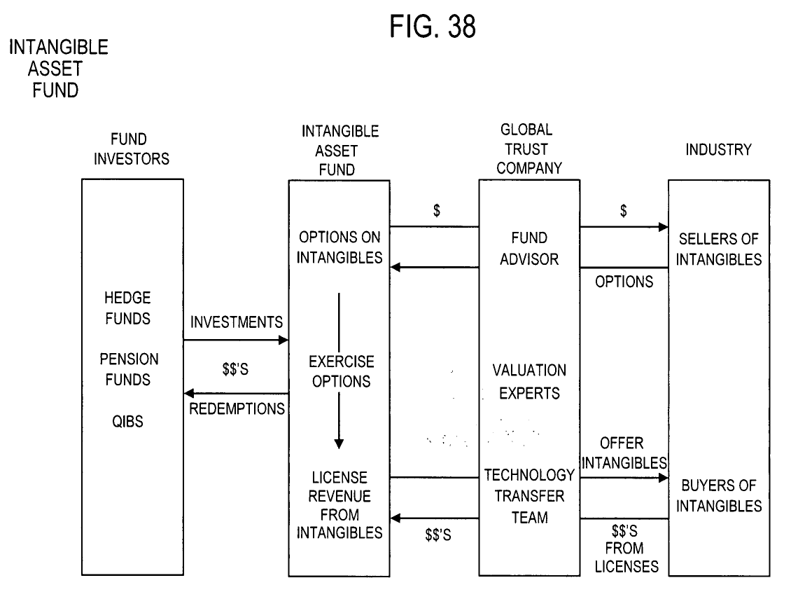

FIG. 38 is an embodiment illustrating the intangible asset fund, where intangible assets or portfolio of intangible assets can be used for investors to trade, invest, sell and/or hold in trust for particular buyers (e.g., industrial buyers). This fund is similar to the Intangible Value Fund but instead of investing in the companies that own the intangibles it invests directly in the intangible assets themselves typically by taking an option on license rights (often limited to the particular geography or industry that our metrics indicate particularly undervalue the license) to an intangible that the valuation matrix has determined to be undervalued. Once we have the option, the technology transfer department attempts to secure licenses and when the option is due to expire one can either exercise or one does not exercise the option based on the progress made by the technology transfer department.

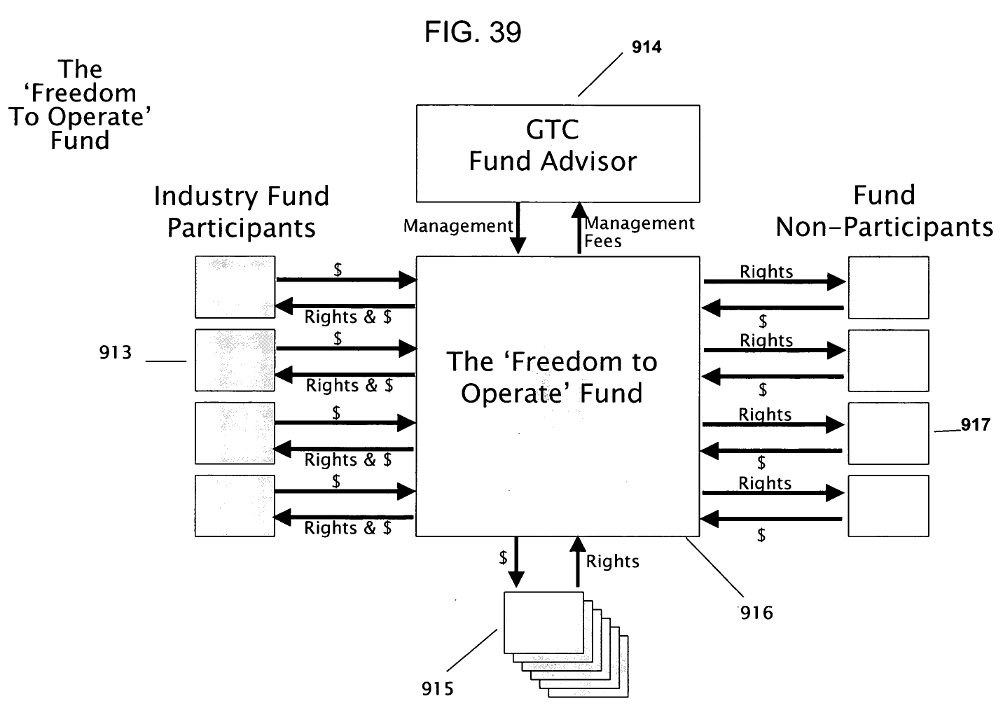

FIG. 39 is an embodiment illustrating how the intangible asset management system can be used to create a freedom to operate (FTO) fund, where various industries can participate in the fund 913 by allowing their respective intangible assets 915 to be sold or licensed to non-participants 917 or other participants. A trusted third party may also manage the FTO fund 914. The intangible information is kept on a central database 916.). This fund is similar to the Intangible Asset Fund in that it will invest primarily in intangible assets but the investment goal is not just to generate a return on the investment but also to ensure continued freedom to operate for the major investors in the fund. The funds will be organized by industry and the investors will primarily be major industry participants who will each make recommendations of intellectual property that they consider to be critical for their ongoing operations. The fund will then secure license rights from which certain essential rights will be granted back to the major fund participants. The licenses will also be used to generate revenues from non fund participants. In this way the fund also provides protection against “patent trolls” in that they provide industry wide negotiating leverage rather than allowing companies to be “picked off” individually.

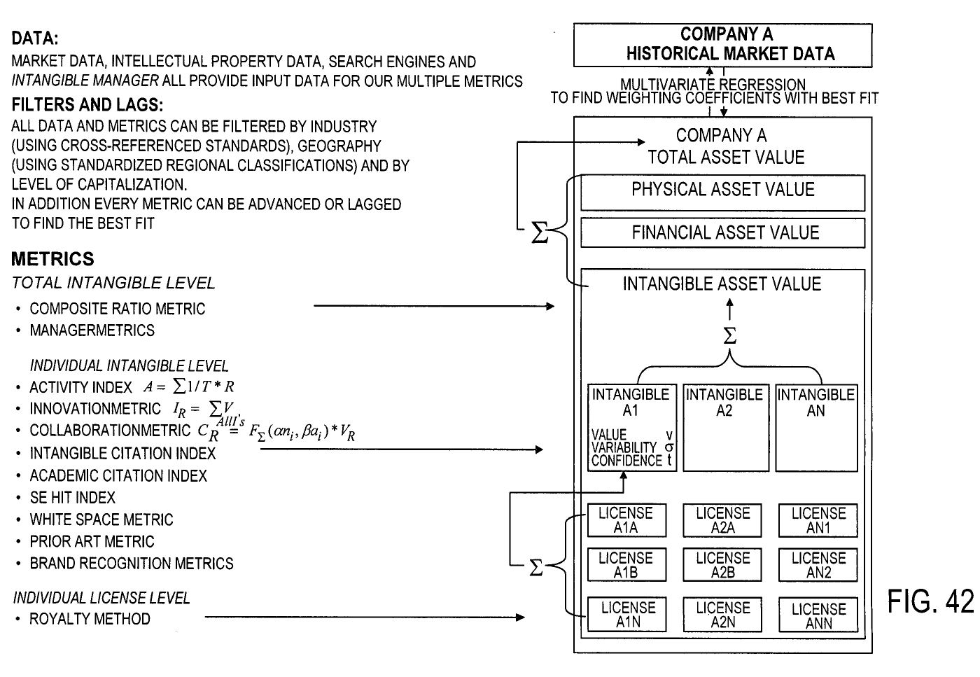

FIG. 42 illustrates an embodiment of the data metrics that the intangible asset systems utilizes to value one or more intangible assets. The database is configured to obtain data from various sources (e.g., market data, IP data, metrics from composite ratios, activity indexes, innovative metrics, collaboration metrics, intangible and academic citation indexes, SE hit indexes, white space, prior art metrics and brand recognition metrics and licensing information, etc.). All this information is used to value the intangible asset and compare it to tangible assets such as physical assets and financial assets to value the company.

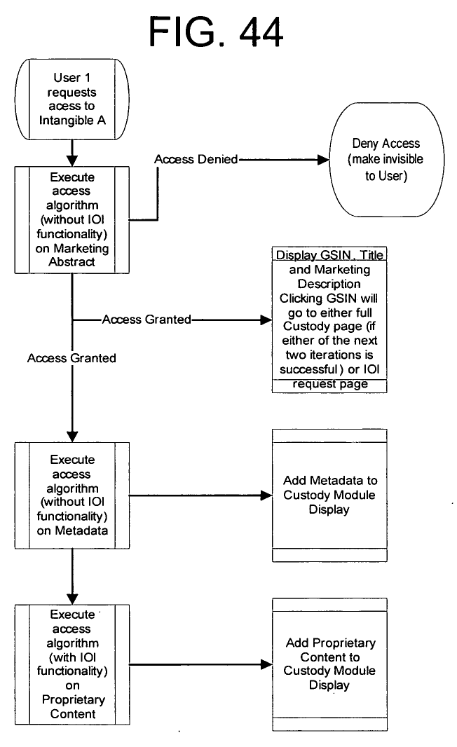

FIGS. 44-47 are block diagrams illustrating how the system and methods have a layered security to allow selective users access to selective intangible asset information. In FIG. 44, the user requests access to the intangible. If access is denied to the user, the information will not be visible to the user. If the user executes the appropriate algorithm, and the database receives the appropriate algorithm, the user will access the marketing abstract as well as the marketing description for the intangible. Likewise, if the user executes the appropriate algorithm, the user will gain access to the metadata for the intangible asset as well as be able to edit the metadata in the Custody Module. If the user executes the appropriate algorithm, the user will gain access to the proprietary content in the Custody Module and the user can edit the proprietary content.

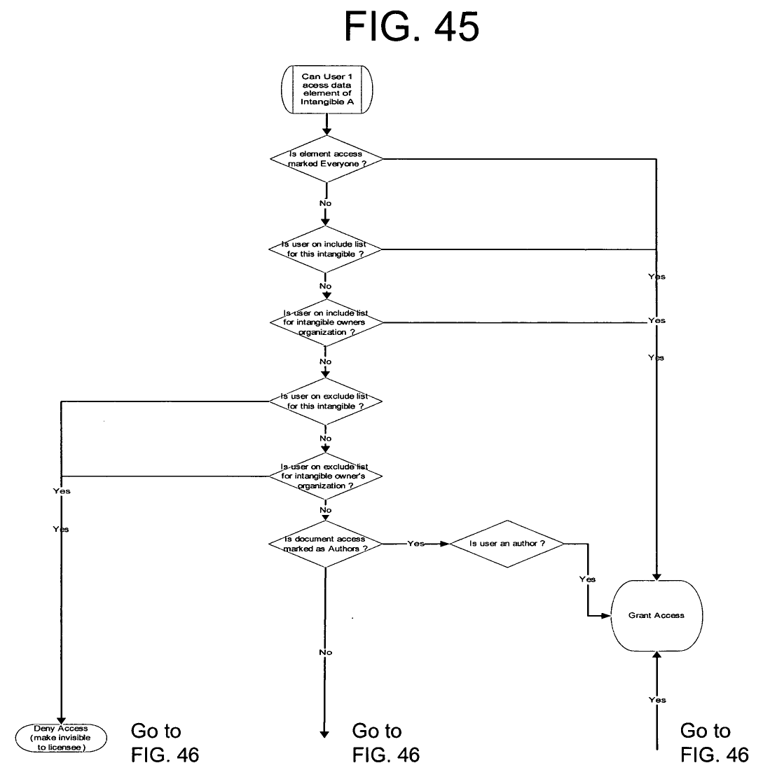

FIG. 45 is a block diagram illustrating how certain intangible asset information is able to be viewed by selective users on the include list of distribution or the exclude list. Users on the exclude list will not be able to view the intangible asset information on their display, while authors of the intangible will be granted access to the intangible and can view and edit it on their display.

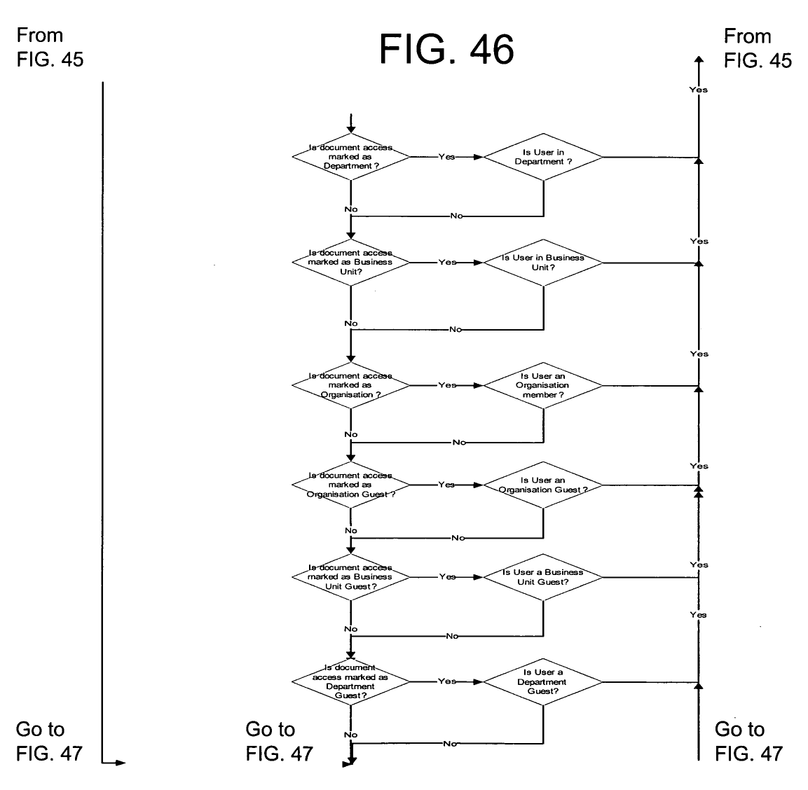

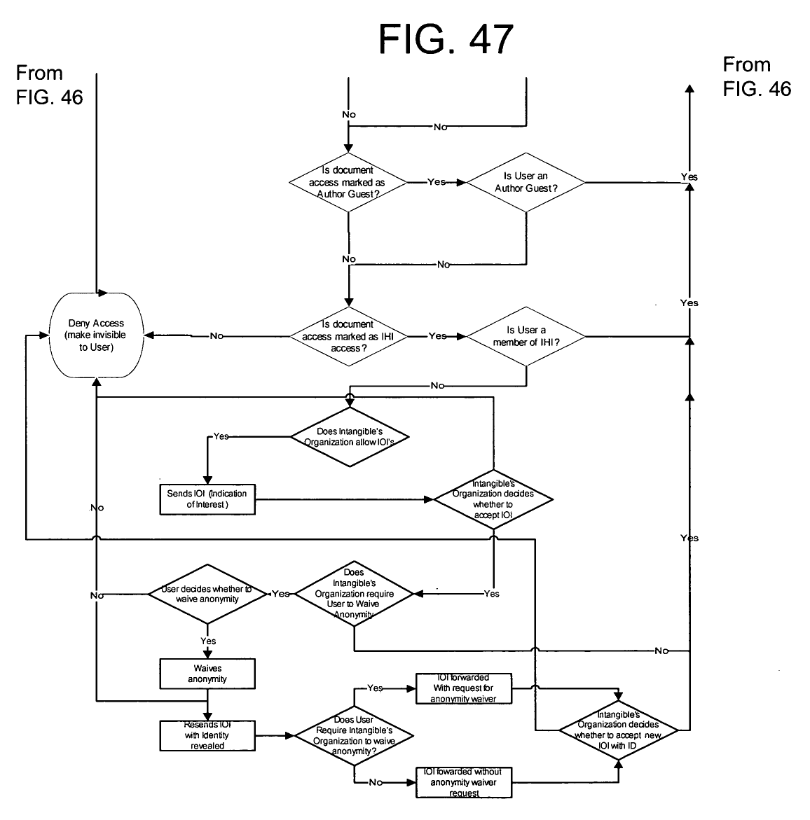

FIG. 46 is a block diagram illustrating how users can have a layered security level as a guest for the company, business unit, department, or organization. The user will be allowed selective access to various modules. For example, if the user is a consultant, the database can be set to allow the user consultant access to the modules in a particular area that the consultant was hired for (e.g., clinical development on the new small molecule for heart disease, etc.) FIG. 47 is a block diagram illustrating how a user that has an indication of interest (IOI) will access various portions of the database.

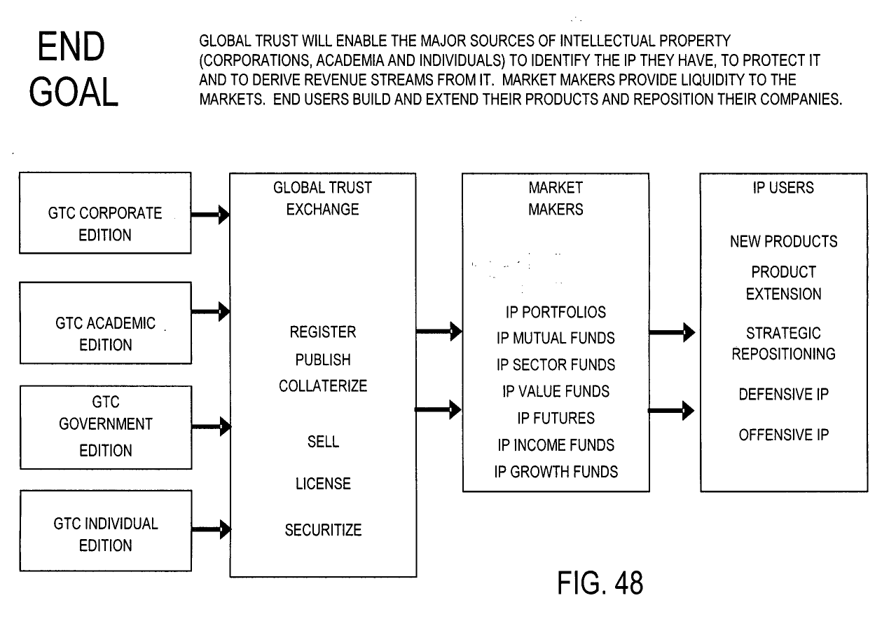

FIG. 48 illustrates the intangible asset exchange facilitated by the intangible asset management systems and methods. The major sources of intangible assets (e.g., government, academia, corporations, individuals) are registered in the database, the database is controlled by the trusted third party and the intangible asset exchange begins. The intangible may be valued and exchange by the market makers as IP mutual funds, sector funds, value funds, future, income and growth funds. The IP may also be used to develop new products, extend other product lines, to reposition companies, and for offensive and defensive use in licensing or litigation.

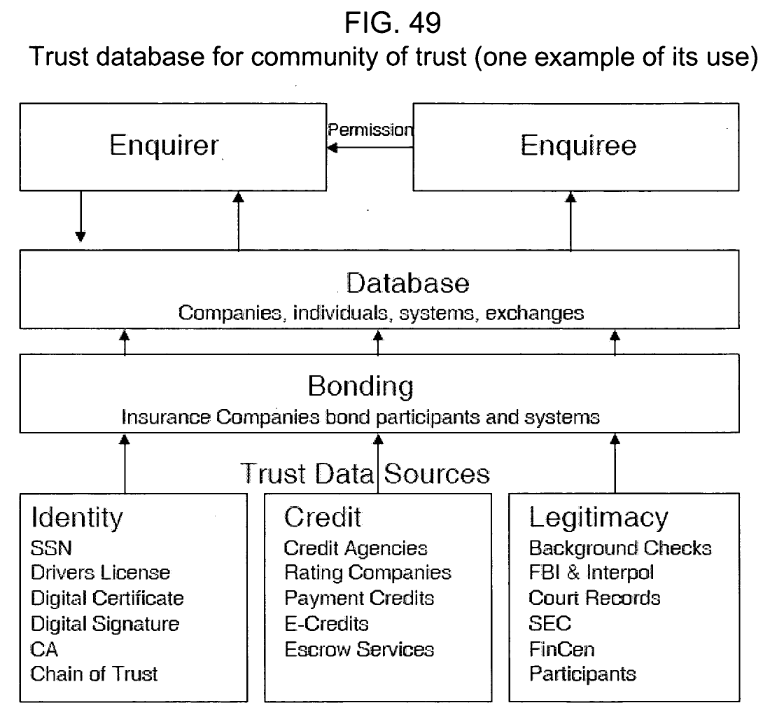

FIG. 49 illustrates an embodiment of the information flow in a trust database, where a community of trust is established in the database, where enquirer and equiree can assess different levels of the database provided they have permission or authorization. For example, electronic commerce where we do not know one of the parties involved in the transaction requires a trusted third party to be involved to establish trust. Using the database, a level of trust can be assigned to the party by bringing in an insurance carrier to bond a participant to a certain financial level having satisfied themselves that the identity is the actual identity of the participant (e.g., SSN, Driver's license, digital certificate, digital signature, chain of trust, certificate authorities, etc.) that their credit is sound (credit agencies, rating companies, payment credits, E-credits, escrow services, etc.) and that they have no criminal or other indications (legitimacy e.g., background checks, FBI, Interpol, court records, SEC, Financial Crimes Intelligence Center-FinCen, based on past experience by other participants, etc.) that would lead one to question their trustworthiness. The database allows the infrastructure to allow any participant to establish a level of trust once with a trusted third party that maintains a database of this trust information so that no matter who the participant is wanting to do business with there is a quickly confirmable (with the participants permission) level of trust that can be used by the counterparty to determine if they wish to go ahead with the transaction. This can also be used by regulators and creates an umbrella of trust under which everyone doing business can be confident of the level of trustworthiness of their counterparty. This effectively shifts the onus from regulators and enforcers who find wrongdoing after it has occurred to the participants who need to convince their insurer ahead of any transaction that they are trusted participants in global commerce.

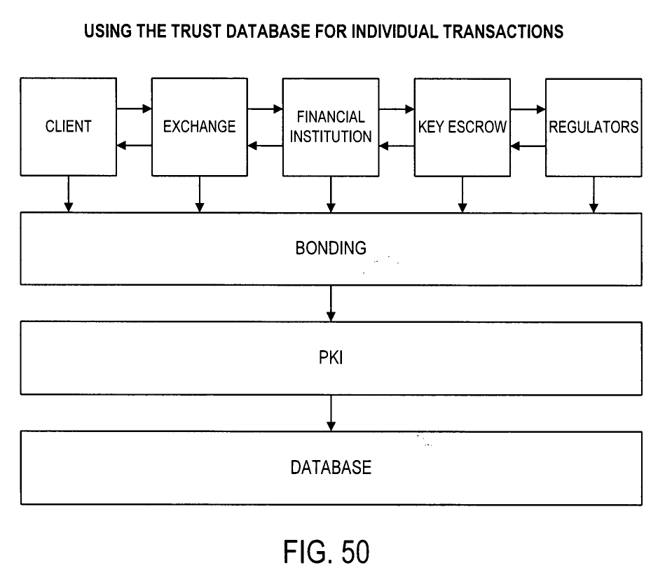

FIG. 50 illustrates one embodiment of the information flow into the trust database, where the information is being used for individual transactions (e.g., bonding) using a highly secure access system (e.g., PKI). A PKI (public key infrastructure) enables users of a basically unsecured public network such as the Internet to securely and privately exchange data and money through the use of a public and a private cryptographic key pair that is obtained and shared through a trusted authority. The public key infrastructure provides for a digital certificate that can identify an individual or an organization and directory services that can store and, when necessary, revoke the certificates.

In various embodiments, the trust database can be used in an individual transaction as shown in the diagram. A participant contemplating a transaction can ensure that all of the counterparties are bonded at least to the level of the transaction. For instance a participant wanting to view a confidential trade secret with a view to licensing it can reassure their counterparty that they can be trusted and will honor the non disclosure agreement (and if they do not the insurer has to cover the loss). Similarly the licensee can satisfy themselves as to the integrity of the licensor. Although this infrastructure is ideal for trade in intellectual property it also applies for trade in tangible assets as well.

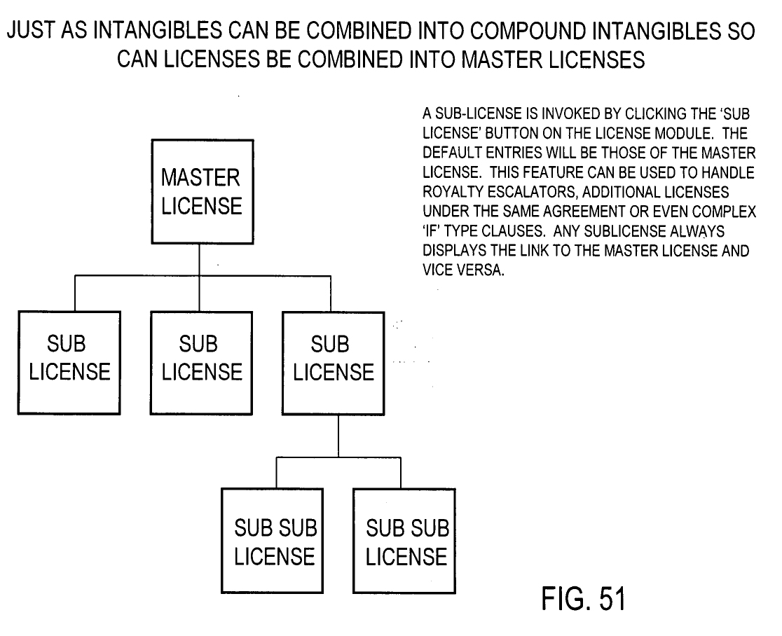

FIG. 51 illustrates one embodiment, where a sublicense (e.g., a component intangible or whole intangible) can be combined with another sublicense (e.g., a component intangible or whole intangible) and combine it to form a new intangible or compound intangible (e.g., a master license). For example, a sublicense can be viewed as a component intangible, which can be combined with other sublicenses to form a new intangible of compound intangible (e.g., such as the master license). Alternatively, a master license can be carved up (field of use restrictions, products only, processes only, etc.) into sublicenses or component intangibles and combined with other sublicenses by hitting the combine button in the solutions module to create a totally new intangible asset.

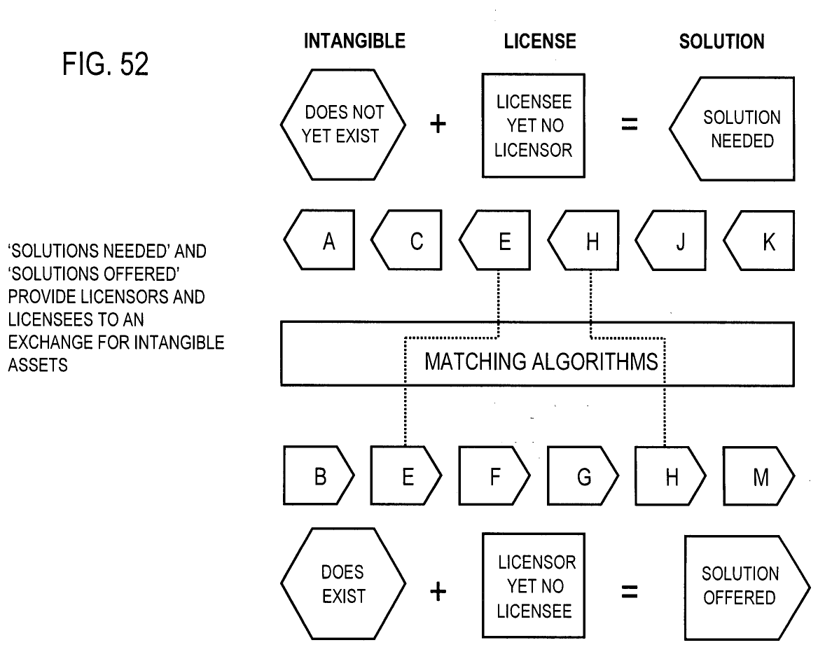

FIG. 52 illustrates one embodiment of the solutions needed and/or solutions offered module. Bottom of the diagram is solution offered, while the top is solution needed. Solutions needed and solutions offered provide licensors and licensees to an exchange for intangible assets stored in the database. For example, the ‘solution needed’ is used by entities wishing to in-license (e.g., outsource) innovation and the ‘solution offered’ is used by an entity wanting to out-license innovation. Of course usually an entity is doing both and although this service is intended mainly for transactions with external organizations many organizations are so large that they have difficulty matching innovation needs and resources internally and this system can be used to ‘trade’ intellectual property within an organization as well as between organizations. All these options are available using the database, which is configured to use algorithms to match a licensee with a licensor.

In FIG. 52, the system creates liquidity in what has historically been an illiquid marketplace by allowing the offering of Solutions Needed and Solutions Offered (sellers and buyers respectively) and the system will automatically via a routine look for matches based on categories, industries, geographies or keywords. The system will automatically contact each party and initiate the potential communication through the workflow described in a Security Algorithm.

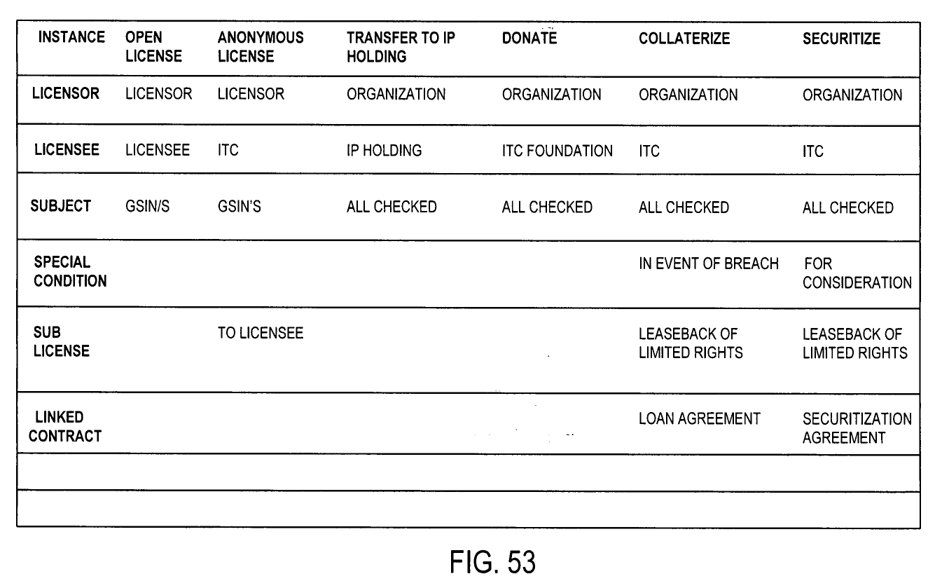

FIG. 53 illustrates one embodiment in table format of the options the database can provide in the license module for intangible assets. There can be an open license granted, an anonymous license, or the intangible assets can be transferred to a holding company, or donated, or collaterized or securitized using the options and information available on the database.

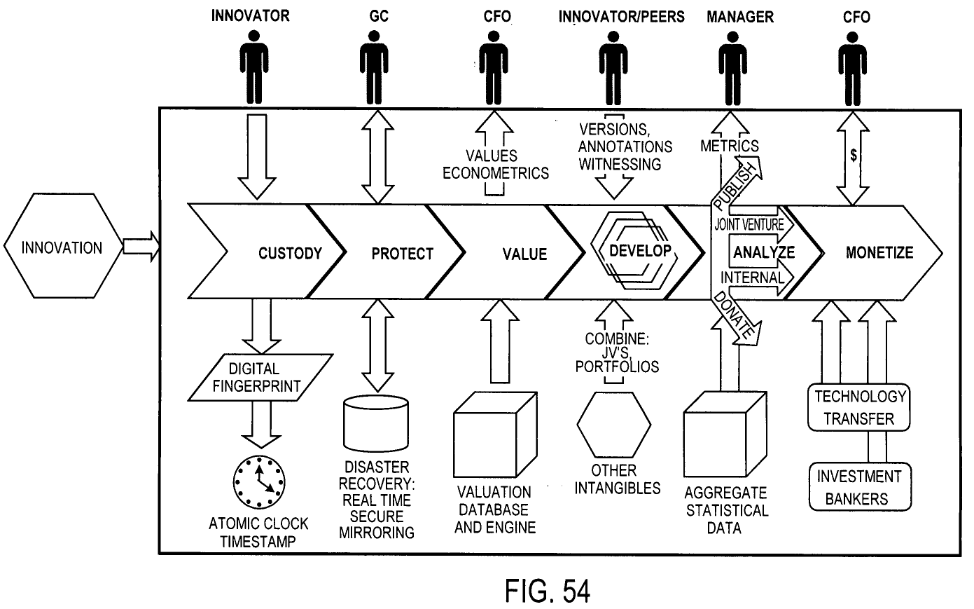

FIG. 54 illustrates one embodiment of the intangible asset management system and the information flow of the asset(s) in the custody, protect, value, develop, analyze and monetize modules. The modules can be visited by one or more users in any order. FIG. 54 illustrates the way the user interacts with the system and the way the system automates much of the workflow associated with the system and its usage as multiple users in various roles interact with the intangible at various stages of its lifecycle. The users can be for example, innovators, general counsel, CFO, the innovator's peers, managers, etc. with various levels of access to the database. The modules are arranged in a typical chronological order but can be visited in any sequence or order. For instance the valuation module would typically be used after an intangible has been registered and protected but it can and often is revisited at later stages in the intangible's lifecycle.

The custody module in FIG. 54 allows the user to register an intangible in a way that clearly establishes that they registered it and when, with an attestation trail that is irrefutable. There is a digital fingerprint or message digest associated with the intangible and a time date stamp calibrated with the atomic clock. In various embodiments, the attestation trail complies with 21 CFR Part 11—the record retention regulations that apply particularly to the pharmaceutical industry. It also stores the intangible in a secure repository and the essential metadata associated with it. The workflow associated with the custody module may comprise one or more of the following:
The creation of the message digest for both the intangible and its associated metadata;
The combination of the two digests into one digest;
The time stamping of each digest with a clock calibrated and validated by an independent trusted third party;
The storage of a ‘snapshot’ that records each intangible number for each client and the time so that the database could if necessary be rebuilt for that moment in time;
The aggregation of all the intangibles for an organization into a ‘Organization Digest’ so that the integrity of all of the organization's data is verifiable;
Confirming Identity of user

The protect module in FIG. 54 allows the user to protect the intangible both in terms of setting the security levels for the Discretionary Access Controls but also in terms of initiating the workflow processes related to the formal legal protection if appropriate. There is a mirroring database in case of disaster so that the intangible asset(s) can be recovered. The workflow associated with the protect module may comprise one or more of the following:
Enabling a negotiated access to any part of the intangible (if appropriate access has been given to the user)
Enabling single or double anonymity for access
Maintaining ‘Include’ and ‘Exclude’ access lists
Automatic filing with copyright library
Automatic filing of provisional patent
Automatic filing of trademark or service mark
Automatic generation of Invention Disclosure Form
Evaluating potential patents for general counsel using proprietary metrics and algorithms related to usage, recency of usage, by whom, repetition of usage, citations in other patents, academic literature, etc.
Tracking progress for each intangible asset

The value module in FIG. 54 allows the user to use basic calculators to estimate value (econometrics) by various methods described herein, it also tracks the history of each valuation (if desired there is no enforced audit trail) and provides various benchmarks and metrics that can be used in the valuation process. The workflow in the value module may comprise one or more of the following:
A system generated valuation and can display relevant metrics and benchmarks for one or more intangible assets
Tracks aggregate valuation information that can be used in providing econometric reports
Aggregates valuation information so the organization can comply with Securities and Exchange Commission, International Accounting Standards Board and Financial Accounting Standards Board regulations
Track changing components of the valuation calculation so as to provide for easier impairment testing a year later and even provide a ‘dynamic’ valuation that is updated as various component parameters change

The develop module in FIG. 54 allows for the fact that intangibles are continually evolving, changing, mutating and combining. It facilitates this development process without losing the attestation trail of earlier versions. It allows for new versions by the authors and annotations by non-authors and witnessing in the lab environment of one or more intangible assets. Workflow components of the develop module may comprise one or more of the following:
Creating message digest for each additional version
Creating a digest and audit trail for each annotation
Notifying other authors of new versions of the intangible by any author and of any annotation by any non-author
Tracking the combination of any intangibles, creating a new “compound intangible” and tracking where available the relative economic contribution of each as well as the new value (which may not be a simple combination but may have a positive or negative “symbiotic value”) and automatically creating a license to describe and track the economic contribution of each component
Building a history for versions and annotations to the intangible asset

The analyze module in FIG. 54 allows management to make an active decision on each intangible asset (or each intangible over a certain minimum value). It is based on best practices (often aggregate statistical data for the intangible) and is facilitated by the system first making a recommendation for best disposition of the intangible. The system can have default settings to assist in disposition of the asset(s). The workflow for the analyze module may comprise one or more of the following:
Creating the metrics for the system to advise the most appropriate disposition;
Tracking workflow for the internal develop disposition (e.g., requesting a budget needed from the manager and getting approval from appropriate user (often CFO)
Joint venture: getting suggested potential partner suggestions from the manager and sending a message either with a known sender or with anonymously.
Publish: automatically changing access rights at the time selected for publication
Donate: creating a license document to transfer the asset to a non-profit that will qualify for tax deductible treatment and effecting this transaction in the time frame requested by the decision maker
Arranging for the decision to be queued for reconsideration at requested time

The monetize module in FIG. 54 allows the owner of the intangible to use the intangible to generate cash either by incorporating it into a product or licensing it (either as a Solution Offered) or using it as collateral for debt based financing or by transferring it (through an automatically generated license) to a special purpose vehicle for securitization (usually certain rights needed by the owning organization are granted back to the organization).

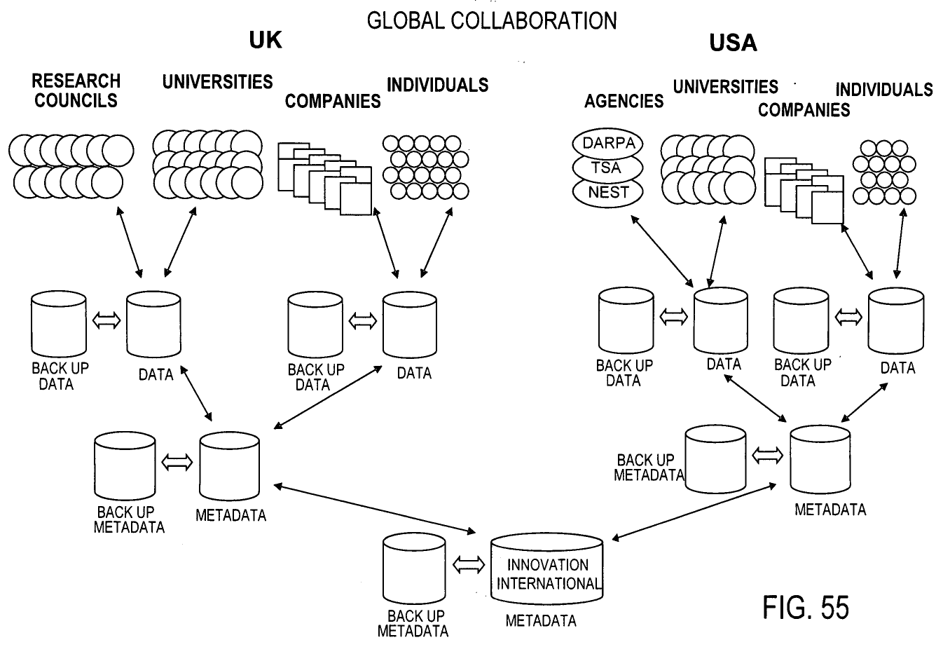

FIG. 55 illustrates one embodiment of the intangible asset management system where the database controlled by a trusted third party is used for global collaboration and information exchange of intangible assets between agencies, research counsels, universities, companies, and individuals. The system benefits the user even if they are using it entirely within their organization but they can benefit further if they participate in the broader ‘Community of Trust’ that facilitates ‘Open Innovation’ and creates a secure, yet more open marketplace that facilitates the in-licensing, out-licensing and cross licensing of intangible or intellectual assets or innovation. The system uses a multi-tier architecture to allow users to either store all of their intangible information on the trusted third party's database (e.g., server) or to store the confidential data on the users local servers and replicate metadata to the trusted third party's database (e.g., server) that provide the user with benefits related to the ‘Community of Trust’. The metadata that may be replicated may comprise one or more of the following: the intangible message digest; the timestamp; the message digest for the entire organization's database; the snapshot of which intangibles (SIN number only if preferred) are registered at any certain times; certain valuation data (for use in econometric reports); or marketing abstracts (if the user has the required security level).

It will be apparent to those skilled in the art that various modifications and variations can be made to various embodiments described herein without departing from the spirit or scope of the teachings herein. Thus, it is intended that various embodiments cover other modifications and variations of various embodiments within the scope of the present teachings.

What is claimed is:

1. A computer based intangible asset management system for storing, managing, disseminating and sharing intangible asset information of an entity among users, the system comprising: a user interface that displays options for a user to enter, view, and edit some or all of the intangible asset information from one or more modules; a database coupled to the user interface for storing the intangible asset information and a processor coupled to the user interface and the database, the processor to: receive intangible asset information from the user; process and organize the intangible asset information into at least one custody module, protect module, value module, develop module, securitize module, analyze module, and/or license module; store the intangible asset information in the database by module; update the database with any new intangible asset information received from the user; and provide the updated intangible asset information in response to an inquiry from a user.

2. A computer based intangible asset management system according to claim 1, wherein the entity is one or more individuals, businesses and/or organizations.

3. A computer based intangible asset management system according to claim 1, wherein the intangible asset is intellectual property and is managed over all or part the lifecycle of the intangible asset by different users.

4. A computer based intangible asset management system according to claim 1, wherein the network administrator is a trusted third party user.

5. A computer based intangible asset management system according to claim 1, wherein the database is configured to be protected from access by unauthorized users.

6. A computer based intangible asset management system according to claim 1, wherein intangible asset information comprises initial, essential, and non-changing metadata for each intangible asset, which is processed with a message digest algorithm to provide an attestation trail for each intangible asset.

7. A computer based intangible asset management system according to claim 6, further comprising processing a first message digest with a second message digest to produce a third message digest for the intangible asset; aggregating the first, second and third message digests to form a ultimate message digest that provides an attestation trail for the centralized database; and sending the ultimate message digest to the user, trusted third party, entity, and/or newspaper.

8. A network based intangible asset management system for storing, managing, disseminating and sharing intangible asset information of an entity among users, the system comprising: a user system having an interface that displays options for a user to enter, view, and edit some or all of the intangible asset information from one or more modules;
a centralized database for storing the intangible asset information;
a server system configured to be coupled to the user system and the centralized database, the server system further configured to: receive intangible asset information from the user; process and organize the intangible asset information into at least one custody module, protect module, value module, develop module, securitize module, license module and/or analyze module; store the intangible asset information in the centralized database by module; update the centralized database with any new intangible asset information received from the user system; and
provide the updated intangible asset information in response to an inquiry from a second user.

9. A network system according to claim 8, wherein the second user has an interface that displays options for the second user to enter, view, and edit some or all of the intangible asset information of the entity.

10. A network system according to claim 8, wherein the entity is one or more individuals and/or businesses.

11. A network system according to claim 8, wherein the intangible asset is intellectual property and is managed over the lifecycle of the intangible asset by different users.

12. A network system according to claim 8, wherein the network administrator is a trusted third party user.

13. A network system according to claim 8, wherein the centralized database is configured to be protected from access by unauthorized users or only users associated with a community of trust.

14. A network system according to claim 8, wherein the intangible asset information comprises initial, essential, and non-changing metadata for each intangible asset, which is processed with a time stamped message digest algorithm to provide an attestation trail for each intangible asset.

15. A network system according to claim 14, further comprising processing a first message digest with a second message digest to produce a third message digest for the intangible asset; aggregating the first, second and third message digests to form a ultimate message digest that provides an attestation trail for the centralized database; and sending the ultimate message digest to the user, trusted third party, entity, and/or newspaper, the centralized database is configured with a hashing algorithm to provide a digital fingerprint for the centralized database or the at least one module, which is then sent to the user, trusted third party, entity, and/or newspaper.

16. A network system according to claim 15, wherein the centralized database comprises a pool of intangible assets from one or more entities and the trusted third party controls access by users to various user levels of the module based on the user's trust score.

17. A network system according to claim 16, wherein the trust score involves a user placing funds in a bond or escrow before access to various user levels of the module is granted.

18. A network system according to claim 8, wherein the user system is further configured with a sending component to send an inquiry to the server system so that the server system can process and download the requested intangible asset information to the user system.

19. A network system according to claim 8, wherein the custody module is configured to uniquely identify the intangible asset using at least one of: a message digest to provide an attestation trail, electronic date and time stamp calibrated with the atomic clock, and a custom identifier.

20. A network system according to claim 19, wherein the custody module sends an ultimate message digest for the entire system to a newspaper for publication each day.

21. A network system according to claim 19, wherein the user interface is configured to allow documents to be saved in a repository of the centralized database and the custody module is configured with a sweeping algorithm to identify new documents saved in the centralized database.

22. A network system according to claim 21, wherein the sweeping algorithm prevents saving of duplicate documents and corrects any corrupted documents from mirrored back ups

23. A network system according to claim 19, wherein the intangible asset is one or more patents and/or trademarks and the centralized database is configured with a search engine to search public patent and trademark databases and collection component to collect the patents and/or trademarks and associate them with one or more entities and/or relevant ratings.

24. A network system according to claim 19, wherein the custody module provides the intangible asset with a unique worldwide identification number or a custom identifier allows the user to select their own unique identifier.

25. A network system according to claim 19, wherein the custody module provides the second user with access to a non confidential abstract of the intangible asset comprising a general description of the intangible asset.

26. A network system according to claim 8, wherein the data within the protect module is configured with a message digest to authenticate the intangible asset information sent to the second user.

27. A network system according to claim 8, wherein the protect module is configured to protect all of the intangible asset information of the entity.

28. A network system according to claim 8, wherein the protect module is configured to transfer ownership and other rights of an intangible asset to a second user which is an intellectual property holding company.

29. A network system according to claim 8, wherein the protect module is configured to allow a user to encrypt data related to one or more intangible assets and store a digital certificate required to access the data on a server hosted in one or more of the same or different jurisdictions.

30. A network system according to claim 8, wherein the protect module is configured to generate one or more non-disclosure or confidential disclosure agreement pertaining to the intangible asset for one or more users and/or archive one or more non-disclosure or confidential disclosure agreements.

31. A network system according to claim 8, wherein the protect module is configured to generate and send the user an alert to notify the user of an upcoming deadline for the intangible asset or license.

32. A network system according to claim 13, wherein the protect module is configured to calculate a trust score for the user and grant or deny access to various levels of intangible asset information contained in the centralized database based on the user's trust score.

33. A network system according to claim 33, wherein the user's trust score can be increased by electronically placing funds in a bond or escrow before access to various user levels of the intangible asset information is granted.

34. A network system according to claim 8, wherein the value module is configured so that the user can place a value on the intangible asset.

35. A network system according to claim 8, wherein the value module is configured to calculate a value for the intangible asset based on fair market value, estimated values, dynamic value, symbiotic value, regression of values, optimism factors, and/or metrics of the entity.

36. A network system according to claim 34, wherein the value is for one or more intangible assets and is obtained using valuation related metrics, regression testing, and/or multivariate analysis to build a database of correlations for each metrics based on capitalization, industry and geography and develop weighting factors to combine the metrics for a particular valuation in a weighted average.

37. A network system according to claim 8, wherein the value module is configured with a collection component to receive intangible asset information from users or websites to estimate the value of the intangible asset.

38. A network system according to claim 8, wherein the develop module is configured with a tracking component to: track entries and edits among users that annotate and collaborate during the life of the intangible asset, assign new version numbers to intangible asset information that has edits or entries, and/or track changes to the value module.

39. A network system according to claim 8, wherein the develop module is configured to calculate an innovation and/or collaborative index for the intangible asset for an individual, department, project or organization.

40. A network system according to claim 38, wherein the tracking component identifies which user predominantly contributed to the intangible asset information and allows the user or a second user to combine intangible asset information to create a new intangible asset.

41. A network system according to claim 38, wherein the tracking component has options for the user to place entries that seek intangibles that could solve a problem, which the user seeks a solution and the entries are made available to one or more second users.

42. A network system according to claim 38, wherein the tracking component has options for the user to place entries that seek intangibles that could solve a problem.

43. A network system according to claim 8, wherein the analyze module is configured to allow entries and edits from multiple users including the general counsel, marketing group, and has options to send the edited intangible asset towards various dispositions and to forward the relevant information for final approval by an authorized user from management.

44. A network system according to claim 8, wherein the analyze module is configured to recommend to the user that the intangible asset be developed, the subject of a joint venture, donated, or published and allow the user to accept the recommendation and approval by an authorized user from management.

45. A network system according to claim 8, wherein the analyze module is configured to allow edits from multiple users including the general counsel, marketing group, and sends an inquiry for approval by management to legally protect the intangible asset.

46. A network system according to claim 8, wherein the analyze module is configured to calculate an activity and viability that is sent to the user.

47. A network system according to claim 8, wherein the analyze module is configured to notify a user once a new intangible asset is entered into the centralized database that meets the user's area of interest.

48. A network system according to claim 8, wherein the securitize module is configured to allow a user to post the one or more intangible assets for at least one of: security for a loan, as a tradable security, licensing, transfer of the intangible asset to a special purpose vehicle, and a trust.

49. A network system according to claim 8, wherein the one or more modules of the centralized database comprises a license module coupled to at least one of: the custody module, protect module, value module, develop module, securitize module, and analyze module that is accessible by one or more organizations, or individual users to allow the user to license or assign the intangible asset to interested users, generate a license or assignment agreement for the intangible asset between interested users, and/or alert the user that a license exists and/or has expired for the intangible asset.

50. A network system according to claim 8, wherein the one or more modules of the centralized database further comprises a reports module coupled to at least one of: the custody module, protect module, value module, develop module, securitize module, and analyze module, which allows the user to generate and store reports relating to the intangible asset.

51. A network system according to claim 50, wherein the reports module allows a non-technical user without HTML knowledge to attach, delete, export and modify documents in formats such as Microsoft Word, Word Perfect, Power point, Excel, Access and/or Portable Document Format.

52. A network system according to claim 50, wherein the reports module is configured to generate an exit report for an employee.

53. A network system according to claim 48, wherein the reports generated include estimated value, viability, activity, innovation and/or collaborative index for the intangible asset.

54. A network system according to claim 8, wherein the one or more modules of the centralized database comprises a search module to allow searching and collecting intangible asset information and saving the collected information to create a new intangible asset portfolio or add an existing one.

55. A network system according to claim 54, wherein the search module includes an editing component to add intangible assets to or from saved intangible asset portfolios.

56. A network system according to claim 8, wherein the one or more modules of the centralized database comprises an intangible asset exchange module coupled to allow the user to register the intangible asset or a solution needed component in the centralized database.

57. A network system according to claim 54, wherein at least one user is granted access to the registered intangible asset or solutions needed component in order to exchange information and/or funds relating to the registered intangible asset or solutions needed component.

58. A network system according to claim 54, wherein the user is granted access to the registered intangible asset or solutions needed component based on a trust score, and/or membership to a particular industrial organization.

59. A network system according to claim 54, wherein the user is a competitor that is denied access to the registered intangible asset or solutions needed component.

60. A network system according to claim 54, wherein the users include memberships that can perform a diligence on the registered intangible asset and post a value on the intangible asset based on the diligence conducted that is accessible to a second user based on the second user's trust score.

61. A network system according to claim 54, wherein the user can collaterize, securitize, place in escrow, clear title or fund the entity owning the registered asset.

62. A network system according to claim 8, wherein the server system is further configured with: a collection component for collecting the intangible asset information from users and saving the collected information in the centralized database; a tracking component for tracking the intangible asset information on an on-going basis; a displaying component for displaying the intangible asset information; a receiving component for receiving an inquiry from a second user regarding the intangible asset; and an accessing component for accessing the centralized database and causing the retrieved intangible asset information to be displayed on the second users system, wherein the intangible asset information includes data relating areas of interest from an anonymous user.

63. A network system according to claim 8, wherein the network is one of a wide area network, a local area network, an intranet and the Internet.

64. A method for facilitating automated exchange of one or more intangible assets online between buyer and seller, the method comprising the steps: registering electronically buyer information for the one or more intangible assets with a trusted third party; registering electronically seller information for the one or more intangible assets with the trusted third party; offering the intangible asset for sale; negotiating terms for the sale of the one or more intangible assets; having the trusted third party calculate electronically the buyer's trust score and seller's trust score which is dependent upon the seller's trading history and the seller's financial standing for the purchase of the one or more intangible assets; contracting for a sale of the specified one or more intangible assets, which includes monies, amount of credit, amount of escrow and amount of bond to be deposited with the trusted third party that is dependent upon the buyer's trust and seller's trust score; transferring buyer and/or seller funds and/or escrow and/or bond to the trusted third party; delivering the one or more intangible assets to the buyer; and having the trusted third party pay the seller the contractually agreed upon amount if the buyer determines that the delivered one or more intangible assets comply with the contract.

65. A method for trading one or more intangible assets over a network, comprising: receiving seller information from a first user over the network, the seller information relating to the one or more intangible assets offered for sale on behalf of the seller, at least some of the seller information comprising due diligence information, the due diligence information fulfilling at least a portion of a request for due diligence on the one or more intangible assets; storing the seller information about the one or more intangible assets in a centralized database; making the due diligence information available over the network to a second user on behalf of a potential buyer of the one or more intangible assets; storing in the centralized database data of whether a potential buyer has obtained the due diligence information; and storing in the centralized database a bid for the one or more intangible assets from the second user only if the second user has obtained the due diligence information, wherein the bid is data comprising at least an amount offered to purchase the one or more intangible assets.

66. A method for trading one or more intangible assets over a network according to claim 65, wherein the first and second users are different trusted third parties.

67. A computer readable storage medium storing instructions that, when executed by a computer, cause the computer to display options for a user to enter, view, and edit some or all of intangible asset information and manage, disseminate and share intangible asset information of an entity among users by accessing a database coupled to a user interface, the database for storing the intangible asset information and a processor coupled to the user interface and the database, the processor to: receive intangible asset information from the user; process and organize the intangible asset information into at least one custody module, protect module, value module, develop module, securitize module, and/or analyze module; store the intangible asset information in the database by module; update the database with any new intangible asset information received from the user; and provide the updated intangible asset information in response to an inquiry from a user.

68. A computer based intangible asset management system according to claim 1, wherein the database is configured to at least: (i) exclude certain users from some or all data of the one or more modules; (ii) include selected users to access some or all data of the one or more modules; and/or (iii) allow one user to access the some or all of the data of the one or modules anonymously.
